(19) United States
(12) Patent Application Publication
(10) Pub. No.: US 2010/0257967 A1
(43) Pub. Date: Oct. 14, 2010

(54) DOUBLE CLUTCH TRANSMISSION

(75) Inventors: Wolfgang RIEGER, Friedrichshafen (DE); Matthias REISCH, Ravensburg (DE); Juergen WAFZIG, Eriskirch (DE); Gerhard GUMPOLTSBERGER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/759,020

(22) Filed: Apr. 13, 2010

(30) Foreign Application Priority Data
Apr. 14, 2009 (DE) 10 2009 002 349.6

(51) Int. Cl. F16H 3/08

(52) U.S. Cl. 74/331

(57) ABSTRACT

A double clutch transmission with two clutches with input sides connected to a drive shaft and output sides each respectively connected to one of two transmission input shafts arranged coaxially with each other. At least two countershafts on which toothed idler gearwheels are rotatably supported. There are toothed fixed gearwheels arranged on the two transmission input shafts in a rotationally fixed manner. At least one first shift element is provided for connecting two idler toothed gears in a rotationally fixed manner whereby at least several power-shift forward gears at least one reverse gear are capable of being implemented. There are a maximum of seven gear planes so that at least one winding path gear is shifted with a disengaged first output coupling device that is allocated to the first power take-off gear.

This application claims priority from German patent application serial no. 10 2009 002 349.6 filed Apr. 14, 2009.

### FIELD OF THE INVENTION

This patent deals with a double clutch transmission.

### BACKGROUND OF THE INVENTION

The printed publication DE 103 05 241 A1 has already dealt with a 6-gear or 7-gear double clutch transmission. The double clutch transmission includes two clutches, which are connected on the input sides with the drive shaft and on the respective output sides with one of the two transmission input shafts. The two transmission input shafts are placed coaxially to one another. Moreover, two countershafts are placed with their axes parallel to the two transmission input shafts, whose idler gears engage with the fixed gears of the transmission input shafts. Over and above this, the coupling devices can slide axially, but are rotationally locked to the countershaft so that the respective toothed gearwheels can be shifted. The respective transmission ratio selected is transferred, via the power take-off gear, to a differential. A number of gear planes are necessary to implement the desired transmission ratio steps in the double clutch transmission considered, so that considerable space is required for its installation.

Moreover, a spur-gear multi-speed transmission has been introduced in the printed publication DE 38 22 330 A1. The spur-gear multi-speed transmission includes a double clutch that can be shifted under load, and has one part connected to a drive shaft, and another part connected to a hollow drive shaft that is rotatably supported by the drive shaft. The drive shaft can be coupled with the hollow drive shaft via a shift element for specific transmission ratios.

The printed publication, DE 10 2004 001 961 A1, talks of a power-shift transmission with two clutches, which are assigned respectively to one subtransmission. The transmission input shafts of both subtransmissions are arranged coaxially to one another and are engaged, via the fixed gears, with the idler gears of the countershafts assigned. The respective idler gears of the countershaft can be connected in a rotationally fixed manner with the corresponding countershaft using the shift elements assigned. This printed publication deals with an eight-gear transmission, in which one extra shift element is provided to couple both the transmission input shafts to implement an additional transmission ratio step. In fact, even the seven-gear transmission requires at least six gear planes in both the subtransmissions with this embodiment in order to realize the transmission ratio steps. This leads to an undesirable increase in the construction length in the axial direction, owing to which there are serious limitations when it comes to installing it in a vehicle.

Moreover, the printed publication, DE 10 2005 028 532 A1, talks of another power-shift transmission, which includes two input shafts and only one countershaft. For example, an eight-gear transmission in this embodiment needs more than seven gear planes in order to realize the transmission ratio steps, particularly even the reverse gear transmission ratios. This leads to an undesirable increase in the construction length in the axial direction.

### SUMMARY OF THE INVENTION

This disclosure concerns itself with the task of proposing a double clutch transmission of the type described initially, in which multiple power-shift transmission ratio steps can be realized cost-effectively and with the minimum use of components requiring a low amount of space for installation.

In accordance with these, a double clutch transmission that is optimized with respect to the space required for installation is proposed with two clutches, whose input sides are connected with one drive shaft, and whose output sides are connected respectively with one of two transmission input shafts that are placed coaxially to one another. The double clutch transmission includes at least two countershafts or similar, on which the toothed gear wheels formed as idler gears are rotatably supported, whereby toothed gear wheels, formed as fixed gears, are connected on both the transmission input shafts in a rotationally fixed manner, such that these engage with at least some of the idler gears. In addition, multiple coupling devices are provided for connecting one idler gear in a rotationally fixed manner with one countershaft. The inventive double clutch transmission has one power take-off gear or constant pinion respectively on each of the countershafts, which is engaged respectively with the teeth of one drive shaft, in order to connect the corresponding countershaft with the output drive, whereby multiple power-shift gears can be designed.

According to the inventive double clutch transmission a maximum of seven gear planes with at least seven power-shift gears can be realized without requiring too much construction space. For example, the maximum of seven gear planes can be formed by at least one dual gear plane, whereby, in each dual gear plane, one idler gear of the first and second countershafts are assigned to one fixed gear of one of the transmission input shafts respectively, and at least one idler gear can be used for at least two gears, so that at least one winding path gear can be shifted with one of the open coupling devices that has been assigned to one of the power take-off gears.

It is also possible that, apart from the dual gear planes, single gear planes can be used, whereby for each single gear plane, one idler gear of the countershaft is assigned to a fixed gear of the transmission input shaft. Other configurations are also possible.

Owing to the possibility of multiple usages of the idler gears, the maximum number of transmission ratios can be realized with the double clutch transmission proposed with the least number of gear planes, whereby, it is preferable that the first seven forward gears can be power-shifted using a sequential design.

In order to optimize the graduation or stepping in the inventive double clutch transmission one dual gear plane can be replaced by two single gear planes, by replacing one idler gear with two idler gears. You can achieve particularly harmonic and progressive gear stepping by doing so. It is also possible to replace two single gear planes with one dual gear plane.

The double clutch transmission proposed can be designed preferably as an 8-gear transmission with at least seven power shiftable gear steps. Owing to its compact design when compared to other known types of transmission arrangements, the inventive double clutch transmission is particularly suitable for transverse construction at the front of a vehicle. However, other forms of installation are also possible depending on the type of and construction space availability in the vehicle under consideration.

In the case of the double clutch transmission proposed, the first and/or eighth forward gear can be a winding path gear. In addition, one reverse gear and/or other gears, such as, creeper gears or overdrive gears can also be designed as winding path gears and, possibly, can also be designed to be power shiftable. For example, the first power shiftable forward gear and/or the highest gear can be a winding path gear. Apart from the coupling device as the winding path gear shift element on one of the constant pinions, other shift elements, too, can be arranged on the first and/or second countershaft to realize other winding path gears. Thus, in this manner, at least one of the two constant pinions is connected with the countershaft assigned so that it can be shifted. Four to seven gear planes can be realized preferably with the double clutch transmission system proposed.

It is possible, in a beneficial manner, to have preferably an additional power shiftable overdrive gear to the seventh forward gear, as an alternative power shiftable eighth forward gear, as a result of which the vehicle can save fuel.

Depending on the embodiment, the first and the second countershaft, for instance, can be assigned three or four shiftable idler gears, which engage respectively with the fixed gears of the transmission input shafts assigned.

If the last or second-last gear increment is designed to be higher than that of the respective previous gear, a particularly large output torque or drive power can be provided with a downshift initiated by the driver.

In the inventive double clutch transmission, the advantage is that a maximum of five shifting points are required on one countershaft. Overall, however, eight shifting points on both the countershafts are adequate to realize the gear steps proposed. Nonetheless, it is possible to have other shifting points.

In accordance with the invention it can be foreseen that an idler gear of the second subtransmission is connected to an idler gear of the first subtransmission across at least one additional shifting element on the first and/or second countershaft, so that at least one winding path gear can be shifted with the help of the shifting element.

Thus, in the inventive double clutch transmission, with the coupling device disengaged at one of the power take-off gears and via the minimum of one shifting elementk, winding path gears can be realized, with which the toothed gear wheels of both subtransmissions are coupled, in order to realize flow of power from both subtransmissions. The shifting element used respectively serves to couple two idler gears and, as a result, brings the transmission input shafts into play with one another.

The arrangement of the shifting elements to couple two specific idler gears can be varied in the double clutch transmission, so that the shifting elements do not have to necessarily be placed between the idler gears that need to be coupled. Accordingly, you can conceive other placement positions of the respective shift element, in order to optimize the linking of an actuator system.

In accordance with one possible embodiment of the double clutch transmission, it can be foreseen that there are only four gear planes provided, whereby, the first and the second gear planes are dual gear planes and/or single gear planes and include two fixed gears on the second transmission input shaft of the second subtransmission, and whereby the third and the fourth gear planes are dual gear planes and/or single gear planes, which include two fixed gears on the first transmission input shaft of the first subtransmission.

In the context of another embodiment of the patent, it can also be foreseen that with the double clutch transmission proposed, five gear planes are provided, whereby the first and the second gear planes include two fixed gears on the second transmission input shaft of the second subtransmission, and the third, fourth and fifth gear planes are dual gear planes and/or single gear planes and can include three fixed gears on the first transmission input shaft of the first subtransmission.

Over and above this, it can be foreseen, in yet another embodiment, that six gear planes are provided, whereby the first and the second gear planes are dual gear planes and include two fixed gears on the second transmission input shaft of the second subtransmission, and the third, fourth, fifth and sixth gear planes are dual gear planes and/or single gear planes, which include four fixed gears on the first transmission shaft of the first subtransmission.

Finally, in accordance with the next advanced stage of the invetion, it can be foreseen, that seven gear planes are provided, whereby the first gear designed as a dual gear plane, and the second and the third gear planes designed as single gear planes include three fixed gears on the second transmission input shaft of the second subtransmission, whereby the fourth, fifth, sixth and seventh gear planes are single gear planes respectively, which include four fixed gears on the first transmission input shaft of the first subtransmission.

In order to provide the required speed reversal for the implementation of reverse gears in the inventive double clutch transmission, you can use, for example, at least one intermediate gear or equivalent, which is arranged on an intermediate shaft. It is also possible that one of the idler gears of one countershaft serves as the intermediate shaft for at least one reverse gear. There is no additional intermediate shaft required for the reverse gear transmission ratio, since one of the idler gears engages with one fixed gear and with another shift-enabled idler gear of the other countershaft. In this manner, the intermediate gear required is placed as a shift-enabled idler gear on one countershaft and serves to realize at least another forward gear. The intermediate gear can also be designed as a stepped gear, regardless of whether it is placed on the countershaft or on another intermediate shaft. It is also possible that the intermediate gear is not placed on a countershaft that is already available, but is instead provided on another separate shaft, e.g. a third countershaft.

In order to achieve the desired ratio steps, it can be foreseen in the inventive double clutch transmission, that at least one dual-acting coupling device is placed on each countershaft or its equivalent. The coupling devices foreseen can respectively connect one idler gear assigned to them with the countershaft in a rotationally fixed manner, either in the active or engaged condition depending on the direction of operation. In addition, a single-acting coupling device can be placed on at least one of the countershafts or equivalent. Hydraulic, electric, pneumatic or mechanically operated clutches or even form locking claw clutches, as well as any type of synchronization device can be used as the coupling device, which serve to connect one idler gear with one countershaft in a rotationally fixed manner. It is possible to substitute one dual-acting coupling device with two single-acting coupling devices or vice versa.

It is conceivable that the placement options of the toothed gear wheels specified can be varied, and even the number of the toothed gear wheels and the number of coupling devices can be modified in order to realize additional power-shiftable or non-power shiftable gears, and to achieve a reduction in the construction space as well as components used in the double clutch transmission proposed. In particular, fixed gears of double gear planes can be split in two fixed gears for two single gear planes. Step changes can be improved as a result of doing so. Moreover, it is possible to exchange the countershafts. The subtransmissions can also be exchanged, i.e. reflected around a vertical axis. In the process, the hollow shaft and solid shafts are exchanged. As a result of this it is possible, for example, to place the smallest gear on the solid shaft in order to further optimize utilization of the construction space. Moreover, adjacent gear planes can be swapped to optimize bending of a shaft and/or to optimize the connection of a shift actuating system. In addition, the respective position of placement of the coupling device on the gear plane can be varied. Furthermore, even the actuation direction of the coupling devices can be modified.

The gear numbers used here have been defined as desired. It is also possible to include a crawler gear and/or an overdrive gear in order to improve the terrain handling characteristics or the acceleration response of a vehicle. Moreover, a first gear can be omitted in order to optimize the totality of the step changes in a better manner. The numbering of the gears with such measures then varies accordingly in a meaningful way.

Regardless of the respective embodiments of the double clutch transmission, the drive shaft and the output shaft can be placed preferably so that they are not coaxial to one another, which helps to realize an arrangement that particularly conserves construction space. The shafts placed spatially behind one another can also be slightly displaced with respect to one another. With this arrangement, it possible to realize a direct gear with transmission ratio of one with the engaging teeth, and can be placed in a beneficial way relatively easily on the sixth to the ninth gear. It is also possible to conceive other arrangement options of the drive shaft and the output shaft.

It is preferable to provide the proposed double clutch transmission with an integrated output stage. The output stage can consist of a fixed gear on the output shaft, which engages with a first output gear designed as a shiftable constant pinion of the first countershaft as well as with a second output gear designed as a shiftable or non-shiftable constant pinion of the second countershaft. Thus, in this manner, at least one of the output gears is formed as a shiftable gear. To shift the output gear, for example, a coupling device can be assigned to at least one output gear, which releases the connection between the countershaft assigned to it and the power take-off gear, when it is in the disengaged condition, in order to shift winding path gears.

The lower forward gears and the reverse gears can be shifted with the help of a start-up clutch or a shifting clutch in a beneficial manner, in order to concentrate higher loads on this clutch, and thus be able to design the second clutch so that it demands less construction space and is more cost-effective. In particular, the gear planes in the double clutch transmission can be arranged in such a manner that the vehicle can be driven via both the inner transmission input shaft and the outer transmission shaft and, thus, via the more suitable clutch, which is also enabled with a double clutch that is designed concentrically and radially nested. For this purpose, the gear planes can be positioned with lateral symmetry or swapped correspondingly.

Regardless of the respective variant of the embodiment, the gear planes foreseen for the double clutch transmission can be swapped, for example.

### BRIEF DESCRIPTION OF THE DRAWINGS

The following sections enumerate the present patent design on the basis of the drawings furnished. The illustrations include:

FIG. 1A schematic view of a 1^{st} variant of the embodiment of an eight-gear double clutch transmission according to the invention;

FIG. 2 A shift diagram of the 1^{st} variant of the embodiment as per FIG. 1;

FIG. 3 A schematic view of a 2^{nd} variant of the embodiment of an eight-gear double clutch transmission according to the invention;

FIG. 4 A shift diagram of the 2^{nd} variant of the embodiment as per FIG. 3;

FIG. 5 A schematic view of a 3^{rd} variant of the embodiment of an eight-gear double clutch transmission according to the invention;

FIG. 6 A shift diagram of the 3^{rd} variant of the embodiment as per FIG. 5;

FIG. 7 A schematic view of a 4^{th} variant of the embodiment of an eight-gear double clutch transmission according to the invention;

FIG. 8 A shift diagram of the 4^{th} variant of the embodiment as per FIG. 7;

FIG. 9 A schematic view of a 5^{th} variant of the embodiment of an eight-gear double clutch transmission according to the invention;

FIG. 10 A shift diagram of the 5^{th} variant of the embodiment as per FIG. 9;

FIG. 11 A schematic view of a 6^{th} variant of the embodiment of an eight-gear double clutch transmission according to the invention;

FIG. 12 A shift diagram of the 6^{th} variant of the embodiment as per FIG. 11;

FIG. 13 A schematic view of a 7^{th} variant of the embodiment of an eight-gear double clutch transmission according to the invention;

FIG. 14 A shift diagram of the 7^{th} variant of the embodiment as per FIG. 13;

FIG. 15 A schematic view of an 8^{th} variant of the embodiment of an eight-gear double clutch transmission according to the invention;

FIG. 16 A shift diagram of the 8^{th} variant of the embodiment as per FIG. 15;

FIG. 17 A schematic view of a 9^{th} variant of the embodiment of an eight-gear double clutch transmission according to the invention;

FIG. 18 A shift diagram of the 9^{th} variant of the embodiment as per FIG. 17;

FIG. 19 A schematic view of a 10^{th} variant of the embodiment of an eight-gear double clutch transmission according to the invention;

FIG. 20 A shift diagram of the 10^{th} variant of the embodiment as per FIG. 19;

FIG. 21 A schematic view of an 11^{th} variant of the embodiment of an eight-gear double clutch transmission according to the invention;

FIG. 22 A shift diagram of the 11^{th} variant of the embodiment as per FIG. 21;

FIG. 23 A schematic view of a 12^{th} variant of the embodiment of an eight-gear double clutch transmission according to the invention;

FIG. 24 A shift diagram of the 12^{th} variant of the embodiment as per FIG. 23;

FIG. 25 A schematic view of a 13^{th} variant of the embodiment of an eight-gear double clutch transmission according to the invention;

FIG. 26 A shift diagram of the 13^{th} variant of the embodiment as per FIG. 25;

FIG. 27 A schematic view of a 14^{th} variant of the embodiment of an eight-gear double clutch transmission according to the invention;

FIG. 28 A shift diagram of the 14^{th} variant of the embodiment as per FIG. 27;

FIG. 29 A schematic view of a 15^{th} variant of the embodiment of an eight-gear double clutch transmission according to the invention;

FIG. 30 A shift diagram of the 15^{th} variant of the embodiment as per FIG. 29;

FIG. 31 A schematic view of a 16^{th} variant of the embodiment of an eight-gear double clutch transmission according to the invention;

FIG. 32 A shift diagram of the 16^{th} variant of the embodiment as per FIG. 31;

FIG. 33 A schematic view of a 17^{th} variant of the embodiment of an eight-gear double clutch transmission according to the invention;

FIG. 34 A shift diagram of the 17^{th} variant of the embodiment as per FIG. 33;

FIG. 35 A schematic view of an 18^{th} variant of the embodiment of an eight-gear double clutch transmission according to the invention;

FIG. 36 A shift diagram of the 18^{th} variant of the embodiment as per FIG. 35;

### DETAILED DESCRIPTION OF THE PREFERRED EMBODIMENTS

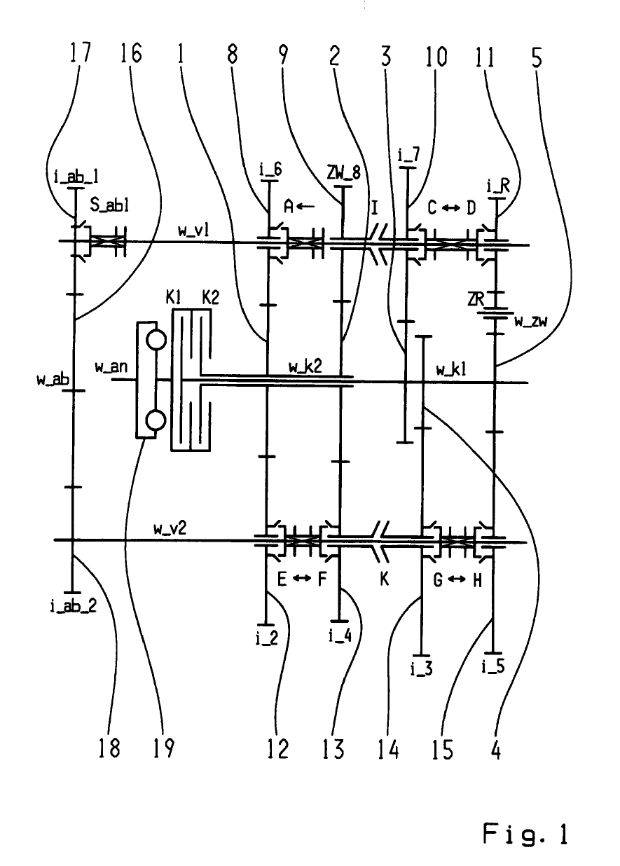

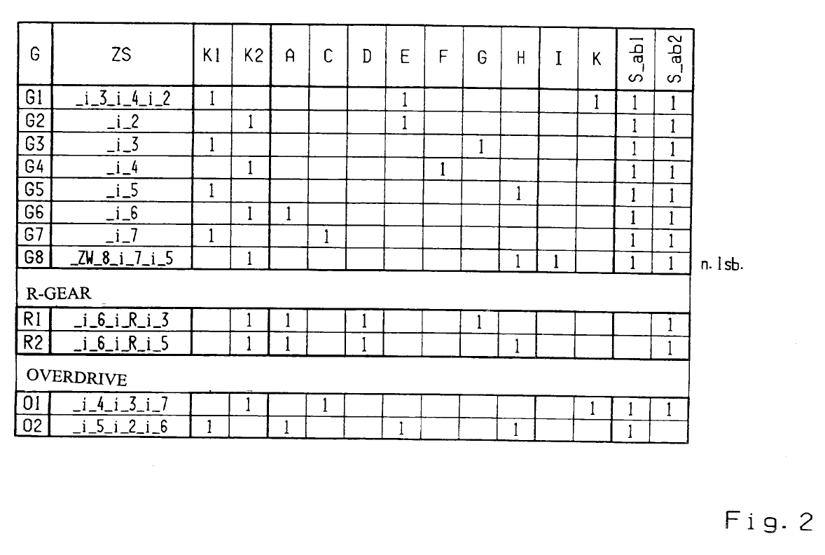

One possible variant of the embodiment of an eight-gear double clutch transmission is illustrated in the FIGS. 1, 3, 5, 7, 9, 11, 13, 15, 17, 19, 21, 23, 25, 27, 29, 31, 33 and 35 respectively. The respective shift diagrams for the different variants of the embodiment are given in a tabular manner in the FIGS. 2, 4, 6, 8, 10, 12, 14, 16, 18, 20, 22, 24, 26, 28, 30, 32, 34 and 36 respectively.

The eight-gear double clutch transmission includes two clutches, K1, K2, whose input sides are connected with a drive shaft, w_an, and whose output sides are connected respectively with one of two transmission input shafts, w_k1, w_k2 that are placed coaxially to one another. In addition, a torsion vibration damper 19 can be placed on the drive shaft, w_an. Furthermore, two countershafts, w_v1, w_v2 have been provided; on which toothed gearwheels have been mounted so that they can rotate as idler gears 8, 9, 10, 11, 12, 13, 14, 15. Toothed gearwheels are placed in a rotationally fixed manner as fixed gears 1, 2, 3, 4, 5, 6, 7 on both the transmission input shafts, w_k1, w_k2, such that they engage with at least some of the idler gears 8, 9, 10, 11, 12, 13, 14, 15.

In order to connect the idler gears 8, 9, 10, 11, 12, 13, 14, 15 with the respective countershaft, w_v1, w_v2, multiple coupling devices, A, B, C, D, E, F, G, H have been provided on the countershafts w_v1, w_v2. In addition, one constant pinion output gear 17, 18 has been placed on each of the countershafts, w_v1, w_v2, with the output gears being coupled respectively with gearing of one fixed gear 16 of an output shaft w_ab by way of a corresponding output stage i_ab_1, i_ab_2 that assigned to the output gears 17, 18.

Apart from the coupling devices A, B, C, D, E, F, G, H, which, in the active condition, realize a rotationally fixed connection between one toothed gearwheel and the countershaft assigned w_v1, w_v2 a winding path gear coupling device S_ab1 of the output stage i_ab1 is assigned to the first countershaft w_v1. When the coupling device S_ab1 is disengaged, the rotationally fixed connection between the output gear 17, and the first countershaft w_v1 can be released. It is possible, that additionally, another winding path gear coupling device S_ab2 is assigned to the second countershaft w_v2 of the output stage i_ab2 or to the output gear 18. In the double clutch transmission, at least one winding path gear shift element I, K can be provided for rotationally fixed connection of two toothed gearwheels of one of the countershafts w_v1, w_v2 so that at least one winding path gear can be realized with the help of the active shift elements I, K.

In accordance with the patent, there are maximum seven gear planes, 8-1, 8-12, 9-2, 9-13, 3-13, 10-3, 4-14, 10-4, 10-14, 11-4, 5-14, 11-5, 11-6, 5-15, 6-15, 11-15 foreseen, whereby, for each variant of the embodiment at least one dual gear plane, 8-12, 9-13, 10-14, 11-15 is provided, so that the winding path gears can be shifted when the coupling device S_ab1 is disengaged, and via at least one of the active shift elements I, K. A claw or equivalent can be used as the shift element I, K respectively for connecting two gears.

The shift element K if provided, is placed on the second countershaft w_v2 to connect the idler gear 13 with the idler gear 14 when the shift element K is engaged. The shift element I if provided, is placed on the first countershaft w_v1 to connect the idler gear 9 with the idler gear 10 when the shift element I is engaged.

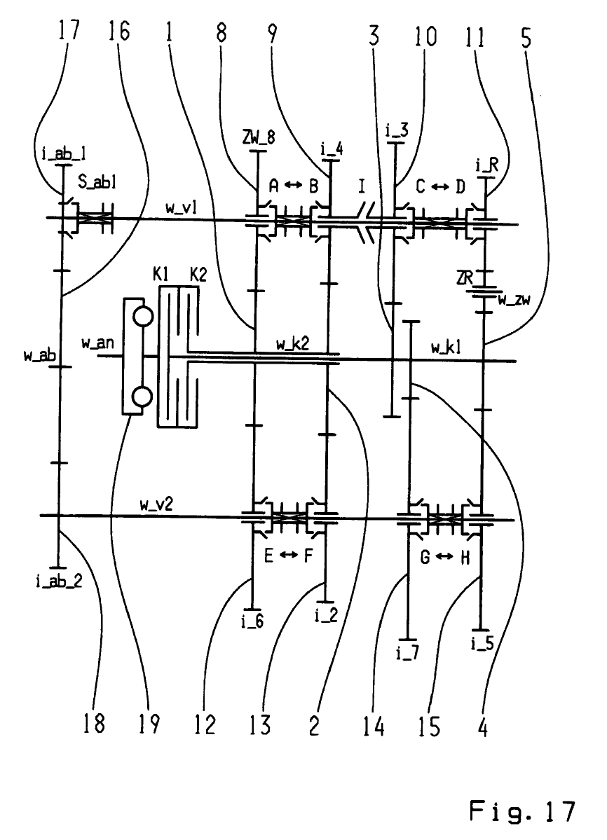

In the case of the first and ninth variants of the embodiment in accordance with the FIGS. 1 and 17, with the first gear plane 8-12 being a dual gear plane, the fixed gear 1 of the second transmission input shaft w_k2 engages with both the idler gear 12 of the second countershaft w_v2 and with the idler gear 8 of the first countershaft w_v1. In the second gear plane 9-13, which is a dual gear plane, the fixed gear 2 of the second transmission input shaft w_k2 engages with both the idler gear 9 of the first countershaft w_v1 and with the idler gear 13 of the second countershaft w_v2. In the case of the third gear plane 10-3 as a single gear plane, the fixed gear 3 of the first transmission input shaft engages with the idler gear 10 of the first countershaft w_v1. In the case of the fourth gear plane 4-14 designed as a single gear plane, the fixed gear 4 of the first transmission input shaft w_k1 engages with the idler gear 14 of the second countershaft w_v2. Finally, in the case of the fifth gear plane 11-15, which is a dual gear plane, the fixed gear 5 of the first transmission input shaft w_k1 engages with both the idler gear 15 of the second countershaft w_v2 and an intermediate gear ZR on an intermediate shaft w_zw for reversal of rotation with reverse gear transmission ratios. The intermediate gear ZR in turn, engages with the idler gear 11 of the first countershaft w_v1.

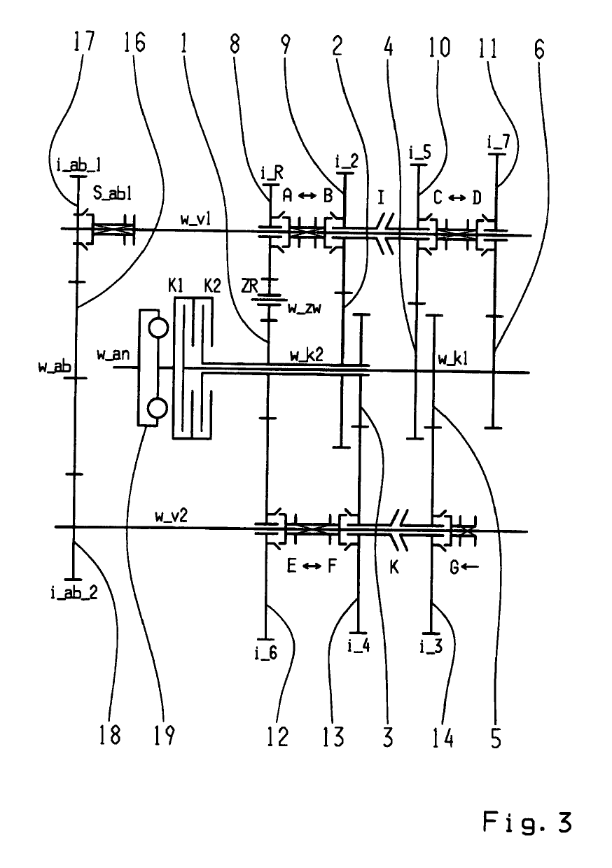

In accordance with the 2^{nd}, 15^{th} and 17^{th} variants of the embodiment as illustrated in the FIGS. 3, 29 and 33, the fixed gear 1 of the second transmission input shaft w_k1 in the first gear plane 8-12 which is a dual gear plane, engages with both the idler gear 12 of the second countershaft w_v2 and with the intermediate gear ZR on the intermediate shaft w_zw for reversal of rotation for reverse gear transmission ratios, whereby the intermediate gear ZR engages with the idler gear 8 of the first countershaft w_v1. It is only in the case of the seventeenth variant of the embodiment that the fixed gear 1 engages directly with the idler gear 8 of the first countershaft w_v1. In the second gear plane 9-2, which is a single gear plane, the fixed gear 2 of the second transmission input shaft w_k2 is engaged with the idler gear 9 of the first countershaft w_v1. In the case of the third gear plane 3-13, which is a single gear plane, the fixed gear 3 of the second transmission input shaft engages with the idler gear 13 of the second countershaft w_v2. In the fourth gear plane 10-4 in the case of the 2^{nd} and 15^{th} variant of the embodiment, the fixed gear 4 of the first transmission input shaft w_k1 engages with the idler gear 10 of the first countershaft w_v1. In the 17^{th} variant of the embodiment, in the fourth gear plane 10-14, which is a dual gear plane, the fixed gear 4 engages with both the idler gear 14 of the second countershaft w_v2 and the intermediate gear ZR on the intermediate shaft w_zw whereby the intermediate gear ZR engages with the idler gear 10 of the first countershaft w_v1. Furthermore, in the 17^{th} variant of the embodiment, in the fifth gear plane 11-5, which is a single gear plane, the fixed gear 5 of the first transmission input shaft w_k1 engages with the idler gear 11 of the first countershaft w_v1. In the case of the sixth gear plane 6-15 designed as a single gear plane, the fixed gear 6 of the first transmission input shaft w_k1 engages with the idler gear 15 of the second countershaft w_v2.

In contrast, in the fifth gear plane 5-14 which is a single gear plane in the case of the second and 15^{th} variant of the embodiment, the fixed gear 5 of the first transmission input shaft w_k1 engages with the idler gear 14 of the second countershaft w_v2. In the case of the sixth gear plane 11-6 as a single gear plane, the fixed gear 6 of the first transmission input shaft w_k1 engages with the idler gear 11 of the first countershaft w_v1. In addition, in the case of the 15^{th} variant of the embodiment, in the seventh gear plane 7-15, which is a single gear plane, the fixed gear 7 of the first transmission input shaft w_k1 engages with the idler gear 15 of the second countershaft w_v2.

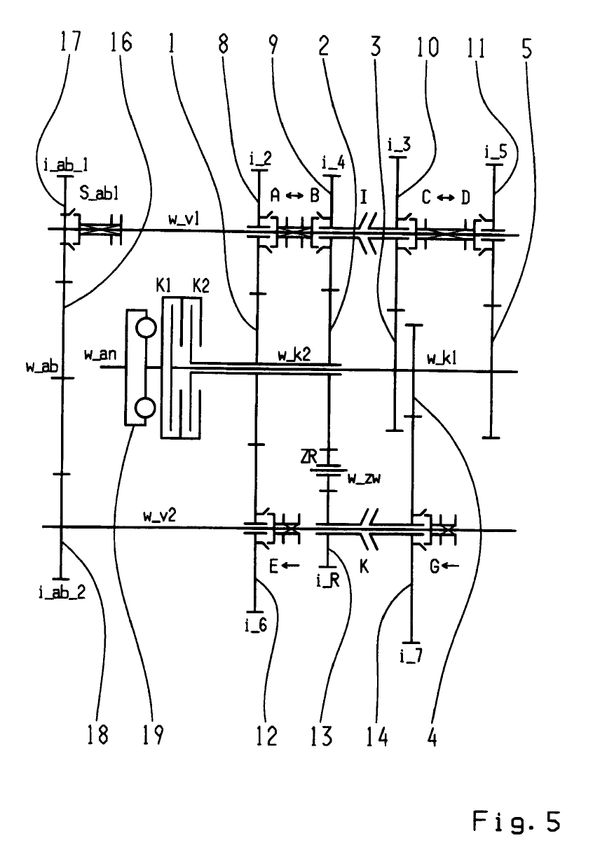

In the third, fifth, 11^{th} and 18^{th} variants of the embodiment, as illustrated in the FIGS. 5, 9, 21 and 35, in the first gear plane 8-12, which is a dual gear plane, the fixed gear 1 of the second transmission input shaft w_k2 engages with both the idler gear 8 of the first countershaft w_v1 and the idler gear 12 of the second countershaft w_v2. In the second gear plane 9-13 which is a dual gear plane, the fixed gear 2 of the second transmission input shaft w_k2 engages with both the idler gear 9 of the first countershaft w_v1 and with the intermediate gear ZR for reversal of rotation for the reverse gear transmission ratios, whereby the intermediate gear ZR in turn, engages with the idler gear 13 of the second countershaft w_v2. In the case of the 5^{th} and 18^{th} variants of the embodiment, in the third gear plane 10-14, which is a dual gear plane, the fixed gear 3 of the first transmission input shaft w_k1 engages with both the idler gear 10 of the first countershaft w_v1 and the idler gear 14 of the second countershaft w_v2. In the case of the fourth gear plane 11-4 as a single gear plane, the fixed gear 4 of the first transmission input shaft w_k1 engages with the idler gear 11 of the first countershaft w_v1. In addition, in the case of the 18^{th} variant of the embodiment, in the fifth gear plane 5-15, which is a single gear plane, the fixed gear 5 of the first transmission input shaft w_k1 engages with the idler gear 15 of the second countershaft w_v2. In the 3^{rd} and 11^{th} variants of the embodiment, in the third gear plane 10-3, which is a single gear plane, the fixed gear 3 of the first transmission input shaft w_k1 engages with the idler gear 10 of the first countershaft w_v1. In the case of the fourth gear plane 4-14 designed as a single gear plane, the fixed gear 4 engages with the idler gear 14 of the second countershaft w_v2. In the 3^{rd} variant of the embodiment, in the fifth gear plane 11-5, which is a single gear plane, the fixed gear 5 of the first transmission input shaft w_k1 engages with the idler gear 11 of the first countershaft w_v1. In the case of the 11^{th} variant of the embodiment, in the fifth gear plane 11-15, which is a dual gear plane, the fixed gear 5 of the first transmission input shaft w_k1 engages with both the idler gear 11 of the first countershaft w_v1 and the idler gear 15 of the second countershaft w_v2.

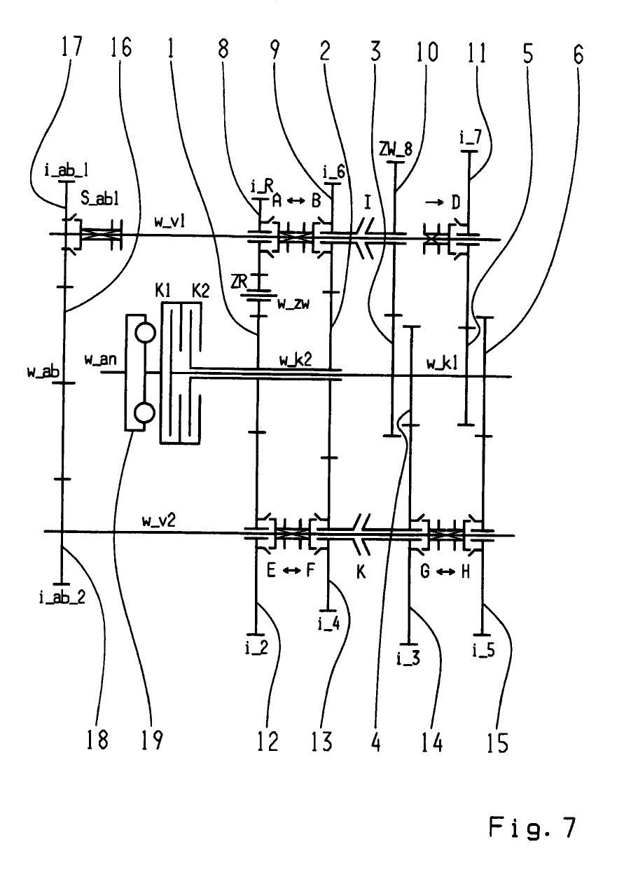

In accordance with the 4^{th}, 7^{th}, 12^{th} and 16^{th} variants of the embodiment as illustrated in the FIGS. 7, 13, 23 and 31, the fixed gear 1 of the second transmission input shaft w_k1 in the first gear plane 8-12, which is a dual gear plane, engages with both the idler gear 12 of the second countershaft w_v2 and with the intermediate gear ZR for reversal of rotation for reverse gear transmission ratios, whereby the intermediate gear ZR engages with the idler gear 8 of the first countershaft w_v1. In the second gear plane 9-13 as a dual gear plane, the fixed gear 2 of the second transmission input shaft w_k2 engages with both the idler gear 9 of the first countershaft w_v1 and the idler gear 13 of the second countershaft w_v2. In the fourth and seventh variants of the embodiment, in the third gear plane, which is a single gear plane, the fixed gear 3 of the first transmission input shaft w_k1 engages with the idler gear 10 of the first countershaft w_v1. In the case of the fourth gear plane 4-14 as a single gear plane, the fixed gear 4 of the first transmission input shaft w_k1 engages with the idler gear 14 of the second countershaft w_v2. In the case of the seventh variant of the embodiment, in the fifth gear plane 11-15, which is a dual gear plane, the fixed gear 5 of the first transmission input shaft w_k1 engages with both the idler gear 11 of the first countershaft w_v1 and the idler gear 15 of the second countershaft w_v2. In the 4^{th} variant of the embodiment, in the fifth gear plane 11-5, which is a single gear plane, the fixed gear 5 of the first transmission input shaft w_k1 engages with the idler gear 11 of the first countershaft w_v1. In the case of the sixth gear plane 6-15 designed as a single gear plane, the fixed gear 6 of the first transmission input shaft w_k1 engages with the idler gear 15 of the second countershaft w_v2. In the case of the 12^{th} variant of the embodiment, in the third gear plane 10-14, which is a dual gear plane, the fixed gear 3 of the first transmission input shaft w_k1 engages with both the idler gear 10 of the first countershaft w_v1 and the idler gear 14 of the second countershaft w_v2. In the case of the fourth gear plane 11-4, as a single gear plane, the fixed gear 4 of the first transmission input shaft w_k1 engages with the idler gear 11 of the first countershaft w_v1. In the case of the fifth gear plane 5-15 as a single gear plane, the fixed gear 5 of the first transmission input shaft w_k1 engages with the idler gear 15 of the second countershaft w_v2. In the 16^{th} variant of the embodiment, in the third gear plane 4-14, which is a single gear plane, the fixed gear 4 of the first transmission input shaft w_k1 engages with the idler gear 14 of the second countershaft w_v2. In the case of the fourth gear plane 11-5 designed as a single gear plane, the fixed gear 5 of the first transmission input shaft w_k1 engages with the idler gear 11 of the first countershaft w_v1. Finally, In the case of the fifth gear plane 6-15 designed as a single gear plane, the fixed gear 6 of the first transmission input shaft w_k1 engages with the idler gear 15 of the second countershaft w_v2.

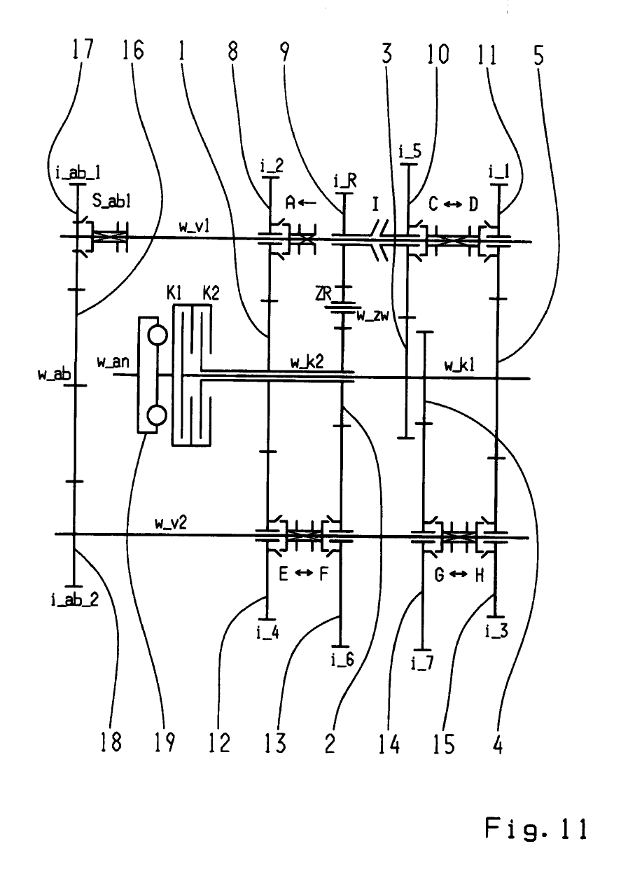

In the 6^{th}, 10^{th} and 13^{th} variants of the embodiment, as illustrated in the FIGS. 11, 19 and 25, in the first gear plane 8-12, which is a double gear plane, the fixed gear 1 of the second transmission input shaft w_k1 engages with both the idler gear 8 of the first countershaft w_v1 and the idler gear 12 of the second countershaft w_v2. In the second gear plane 9-13 which is a dual gear plane, the fixed gear 2 engages with both the idler gear 13 of the second countershaft w_v2 and with the intermediate gear ZR for reversal of rotation for the reverse gear transmission rations, whereby the intermediate gear ZR engages with the idler gear 9 of the first countershaft w_v1. In the sixth variant of the embodiment, in the third gear plane 10-3, which is a single gear plane, the fixed gear 3 of the first transmission input shaft w_k1 engages with the idler gear 10 of the first countershaft w_v1. In the case of the fourth gear plane 4-14 as a single gear plane, the fixed gear 4 of the first transmission input shaft w_k1 engages with the idler gear 14 of the second countershaft w_v2. In the fifth gear plane 11-15, which is a dual gear plane, the fixed gear 5 of the first transmission input shaft w_k1 engages with both the idler gear 11 of the first countershaft w_v1 and the idler gear 15 of the second countershaft w_v2. In the case of the 10^{th} and 13^{th} variants of the embodiment, in the third gear plane 10-14, which is a dual gear plane, the fixed gear 3 of the first transmission input shaft w_k1 engages with both the idler gear 10 of the first countershaft w_v1 and the idler gear 14 of the second countershaft w_v2. In the 10^{th} variant of the embodiment, in the fourth gear plane 11-4, which is a single gear plane, the fixed gear 4 of the first transmission input shaft w_k1 engages with the idler gear 11 of the first countershaft w_v1 whereby, in the fifth gear plane 5-15, which is a single gear plane, the fixed gear 5 of the first transmission input shaft w_k1 engages with the idler gear 15 of the second countershaft w_v2. In the case of the 13^{th} variant of the embodiment, in the fourth gear plane 11-15, which is a dual gear plane, the fixed gear 4 of the first transmission input shaft w_k1 engages with both the idler gear 11 of the first countershaft w_v1 and the idler gear 15 of the second countershaft w_v2.

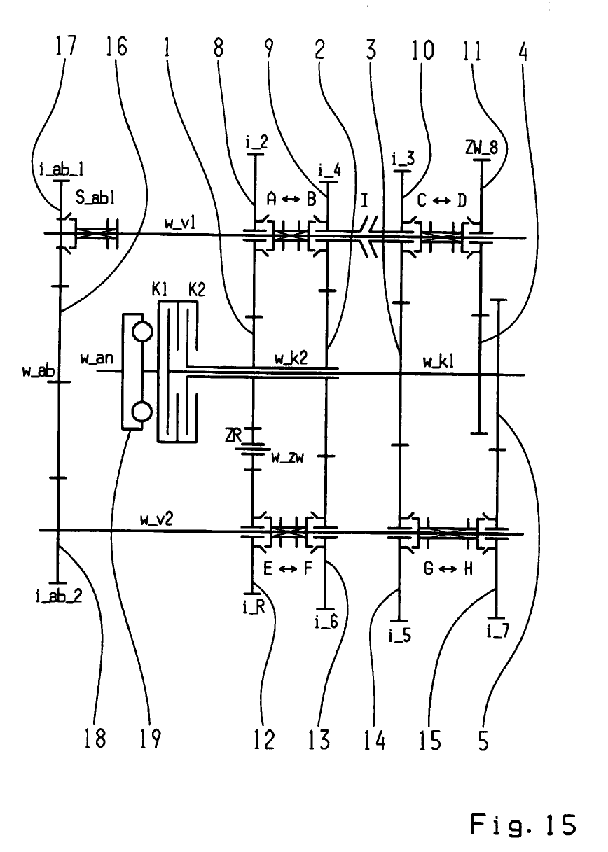

In the case of the 8^{th} variant of the embodiment as illustrated in FIG. 15, in the first gear plane 8-12, which is a dual gear plane, the fixed gear 1 of the second transmission input shaft w_k2 engages with the idler gear 8 of the first countershaft w_v1 and with the intermediate gear ZR for reversal of rotation for the reverse gear transmission ratios, whereby the intermediate gear ZR engages with the idler gear 12 of the second countershaft w_v2. In the second gear plane 9-13 designed as a dual gear plane, the fixed gear 2 of the second transmission input shaft w_k2 engages with both the idler gear 9 of the first countershaft w_v1 and the idler gear 13 of the second countershaft w_v2. In the third gear plane 10-14, which is a dual gear plane, the fixed gear 3 of the first transmission input shaft w_k1 engages with both the idler gear 10 of the first countershaft w_v1 and the idler gear 14 of the second countershaft w_v2. In the fourth gear plane 11-4, which is a single gear plane, the fixed gear 4 of the first transmission input shaft w_k1 engages with the idler gear 11 of the first countershaft w_v1. In the case of the fifth gear plane 5-15 designed as a single gear plane, the fixed gear 5 of the first transmission input shaft w_k1 engages with the idler gear 15 of the second countershaft w_v2.

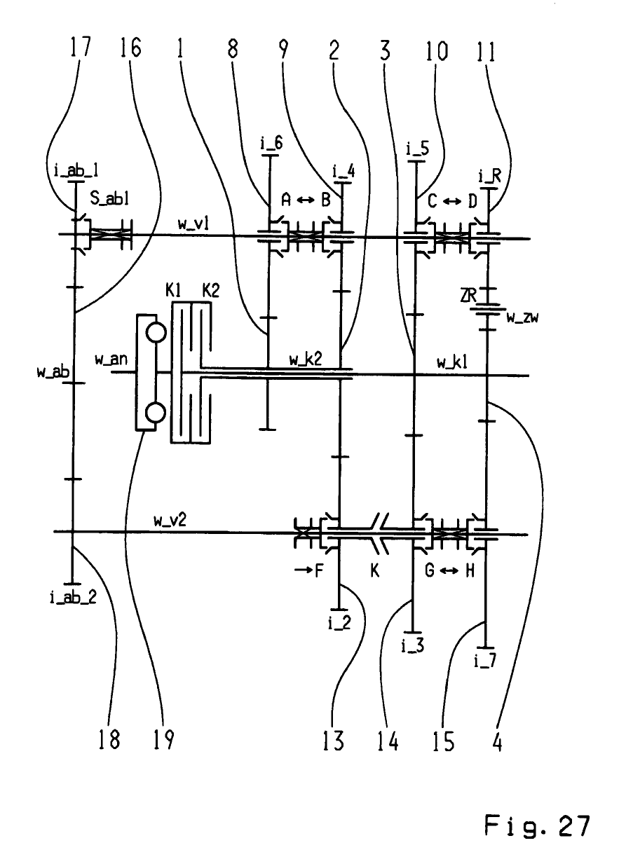

In the 14^{th} variant of the embodiment as illustrated in FIG. 27, in the first gear plane 8-1, which is a single gear plane, the fixed gear 1 of the second transmission input shaft w_k2 engages with the idler gear 8 of the first countershaft w_v1. In the second gear plane 9-13 designed as a dual gear plane the fixed gear 2 of the second transmission input shaft w_k2 engages with both the idler gear 9 of the first countershaft w_v1 and the idler gear 13 of the second countershaft w_v2. In the third gear plane 10-14 designed as a dual gear plane, the fixed gear 3 of the first transmission input shaft w_k1 engages with both the idler gear 10 of the first countershaft w_v1 and the idler gear 14 of the second countershaft w_v2. Finally, the fixed gear 4 of the first transmission input shaft w_k1 in the fourth gear plane 11-15, which is a dual gear plane, engages with both the idler gear 15 of the second countershaft w_v2 and the intermediate gear ZR for reversal of rotation for the reverse gear transmission ratios, whereby the intermediate gear ZR engages with the idler gear 11 of the first countershaft w_v1.

In the case of the 2^{nd}, 3^{rd} and 5^{th} as well as 7^{th} to 15^{th} and the 17^{th} and 18^{th} variants of the embodiment as illustrated in the FIGS. 3, 5 and 9, as well as 13 to 30 and 33 to 36, there are two dual-acting coupling devices A-B and C-D provided respectively on the first countershaft w_v1 whereby the coupling devices A-B and C-D are arranged in such a manner that the engaged coupling device A connects the idler gear 8, the engaged coupling device B connects the idler gear 9, the engaged coupling device C connects the idler gear 10 and the engaged coupling device D connects the idler gear 11 respectively and rigidly with the countershaft w_v1

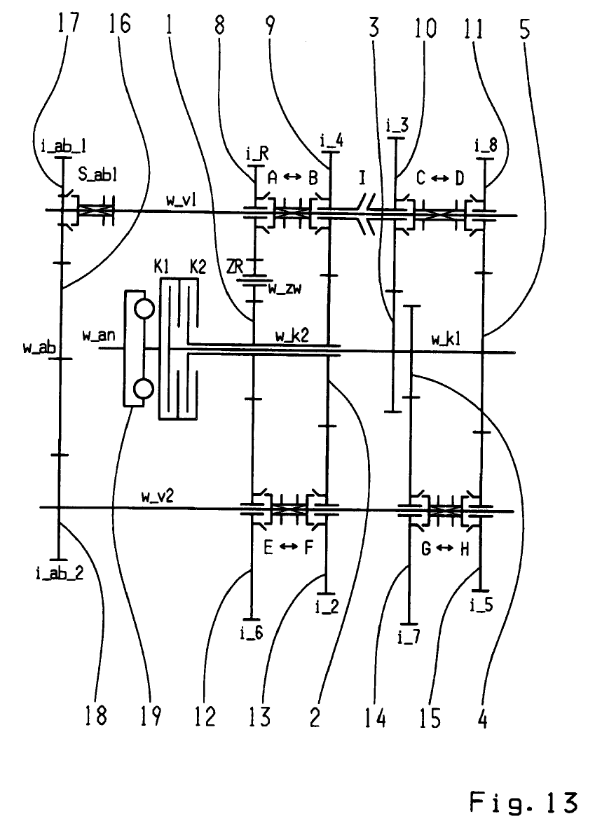

In the case of the 7^{th} to 13^{th} and 15^{th} variants of the embodiment as illustrated in the FIGS. 13 to 26 and 29, there are two dual-acting coupling devices E-F and G-H assigned respectively to the second countershaft w_v2 whereby the coupling devices E-F and G-H have been arranged in such a manner that the engaged coupling device E connects the idler gear 12, the engaged coupling device F connects the idler gear 13, the engaged coupling device G connects the idler gear 14 and the engaged coupling device H connects the idler gear 15 respectively and rigidly with the second countershaft w_v2.

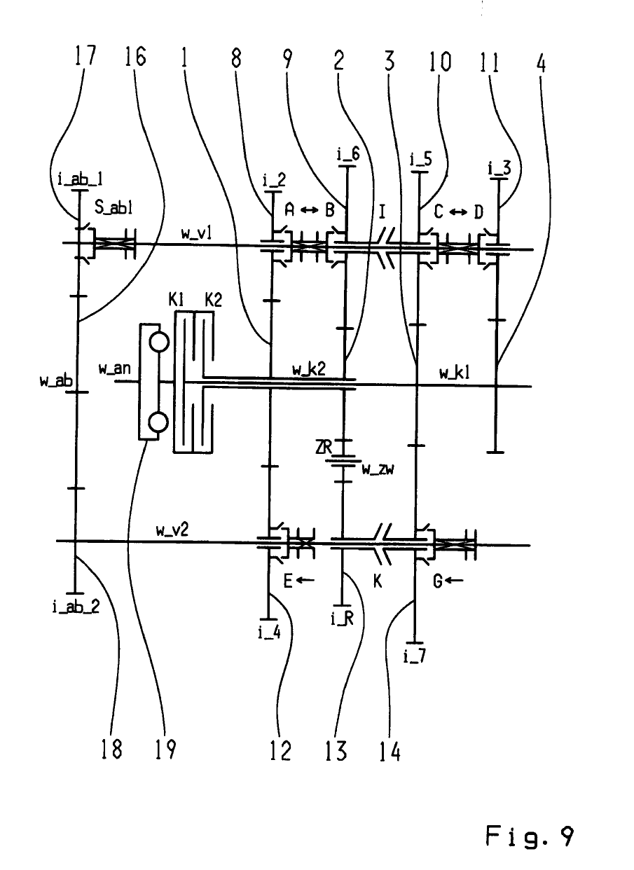

In the case of the 3^{rd} and 5^{th} variants of the embodiment as illustrated in the FIGS. 5 and 9, two single-acting coupling devices E and G are assigned to the second countershaft w_v2 whereby the coupling devices E and G are arranged in such a manner that the engaged coupling device E connects the idler gear 12 and the engaged coupling device G connects the idler gear 14 respectively and rigidly with the second countershaft w_v2.

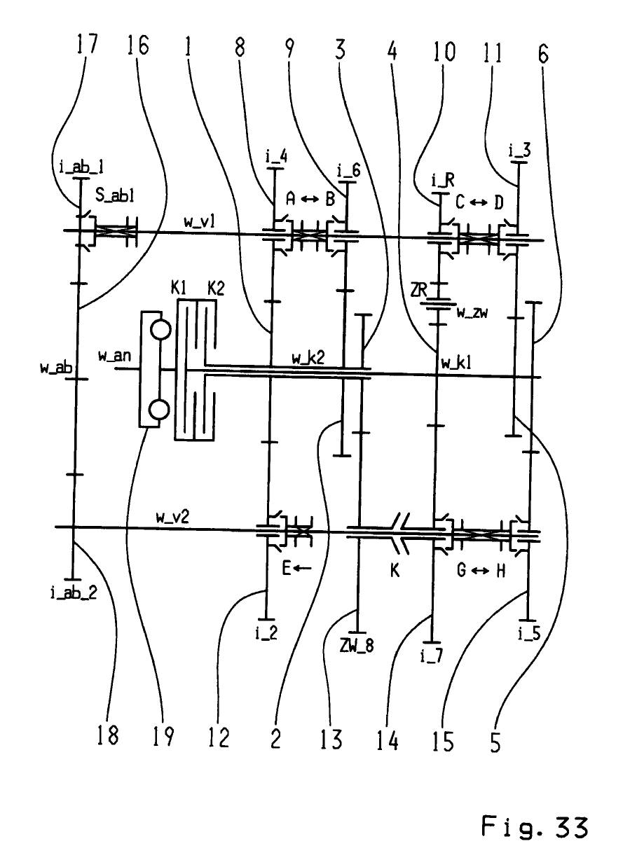

In the case of the 17^{th} and 18^{th} variants of the embodiment as illustrated in the FIGS. 33 to 36, one single-acting coupling device E and one dual-acting coupling device G-H are assigned respectively to the second countershaft w_v2, whereby the coupling devices E and G-H are arranged in such a manner that the engaged coupling device E connects the idler gear 12 and the engaged coupling device G connects the idler gear 14 with the engaged coupling device H and connects idler gear 15 respectively and rigidly with the second countershaft w_v2.

In the case of the 2^{nd} variant of the embodiment as illustrated in FIG. 3, one dual-acting coupling device E-F and one single-acting coupling device G are assigned respectively to the second countershaft w_v2, whereby the coupling devices E-F and G are arranged in such a manner that the engaged coupling device E connects the idler gear 12, the engaged coupling device F connects the idler gear 13 and the engaged coupling device G connects the idler gear 14 respectively and rigidly with the second countershaft w_v2.

In the case of the 14^{th} variant of the embodiment as illustrated in FIG. 27, one dual-acting coupling device G-H and one single-acting coupling device F is assigned to the second countershaft w_v2 whereby the coupling devices G-H and F are arranged in such a manner that the engaged coupling device F connects the idler gear 13, the engaged coupling device G connects the idler gear 14 and the engaged coupling device H connects the idler gear 15 respectively and rigidly with the second countershaft w_v2.

In the case of the 1^{st} and 6^{th} variants of the embodiment as illustrated in the FIGS. 1 to 11, one single-acting coupling device A and one dual-acting coupling device C-D are assigned respectively to the first countershaft w_v1, whereby the coupling devices A and C-D are arranged in such a manner that the engaged coupling device A connects the idler gear 8, the engaged coupling device C connects the idler gear 10 and the engaged coupling device D connects the idler gear 11 respectively and rigidly with the first countershaft w_v1. Furthermore, two dual-acting coupling devices E-F and G-H are assigned to the second countershaft w_v2, whereby the coupling devices E-F and G-H have been arranged in such a manner that the engaged coupling device E connects the idler gear 12, the engaged coupling device F connects the idler gear 13, the engaged coupling device G connects the idler gear 14 and the engaged coupling device H connects the idler gear 15 respectively and rigidly with the second countershaft w_v2.

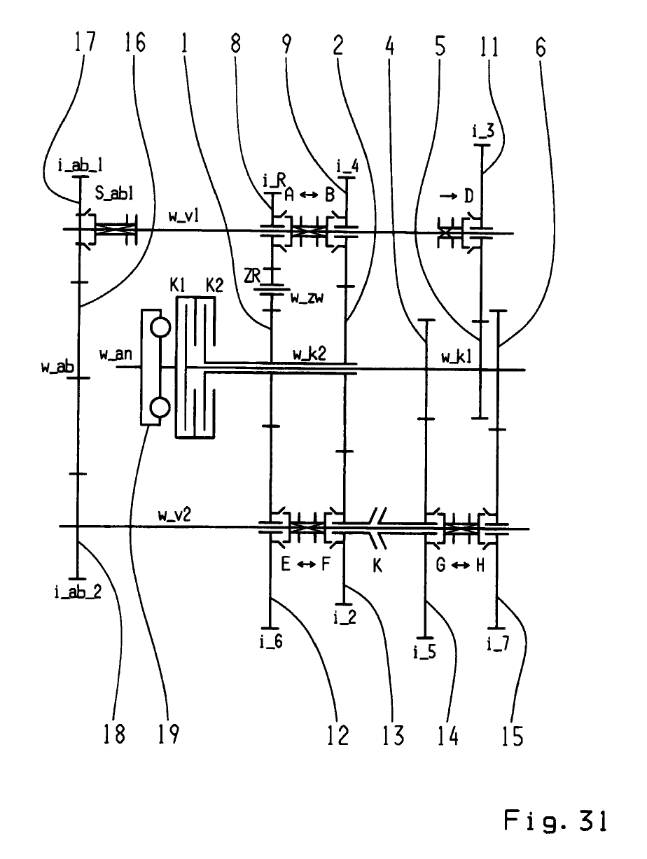

Finally, in the case of the 4^{th} and 16^{th} variants of the embodiment as illustrated in the FIGS. 7 and 31, one dual-acting coupling device A-B and one single-acting coupling device D are assigned respectively to the first countershaft w_v1, whereby the coupling devices A-B and D are arranged in such a manner that the engaged coupling device A connects the idler gear 8, the engaged coupling device B connects the idler gear 9 and the engaged coupling device D connects the idler gear 11 respectively and rigidly with the first countershaft w_v1. Furthermore, two dual-acting coupling devices E-F and G-H are assigned respectively to the second countershaft w_v2, whereby the coupling devices E-F and G-H have been arranged in such a manner that the engaged coupling device E connects the idler gear 12, the engaged coupling device F connects the idler gear 13, the engaged coupling device G connects the idler gear 14 and the engaged coupling device H connects the idler gear 15 respectively and rigidly with the second countershaft w_v2.

Regardless of the respective variant of the embodiment, the inventive double clutch transmission is foreseen to have an integrated output stage with the output gear 17 and the output gear 18. The output gear 17 and the output gear 18 engage respectively with one fixed gear 16 of the output shaft w_ab. It is preferable to realize at least one shiftable connection between the output gear 17 and the associated countershaft w_v1 by means of the shiftable coupling device S_ab1.

Furthermore, with the inventive double clutch transmission, it is possible that the at least the forward gears G1 to G7 can be designed such that they are power shiftable. Depending on the variant of the embodiment, in addition to the eighth forward gear G8, reverse gears and/or crawler gears and/or overdrive gears, for example, also as winding path gears can be designed to be power shiftable. The details for each of the variants of the embodiment are illustrated in the shift diagrams described in the following.

An exemplary shift diagram for the 1^{st} variant of the embodiment of the eight-gear double clutch transmission depicted in FIG. 1 is illustrated in the table shown in FIG. 2.

It can be seen from the shift diagram that the first forward gear G1 can be shifted via the first clutch K1 and via the engaged coupling device E, as a winding path gear via the engaged shift element K, that the second forward gear G2 can be shifted via the second clutch K2 and via the engaged coupling device E, that the third forward gear G3 can be shifted via the first clutch K1 and via the engaged coupling device G, that the fourth forward gear G4 can be shifted via the second clutch K2 and via the engaged coupling device F, that the fifth forward gear G5 can be shifted via the first clutch K1 and via the engaged coupling device H, that the sixth forward gear G6 can be shifted via the second clutch K2 and via the engaged coupling device A, and that the seventh forward gear G7 can be shifted via the first clutch K1 and via the engaged coupling device C. Thus, in this manner, at least the first seven forward gears G1-G7 can be designed to be power shiftable. Furthermore, the eighth forward gear G8 can be shifted via the second clutch K2 and via the engaged coupling device H as a winding path gear via the engaged shift element I.

Over and above this, with the 1^{st} variant of the embodiment, one reverse gear R1 can be shifted via the second clutch K2, via the engaged coupling device A, via the engaged coupling device D and via the engaged coupling device G, as a winding path gear when the coupling device S_ab1 is disengaged. In addition, one reverse gear R2 can be shifted via the second clutch K2, via the engaged coupling device A, via the engaged coupling device D and via the engaged coupling device H, as a winding path gear when the coupling device S_ab1 is disengaged.

Finally, one overdrive gear O1 can be shifted via the second clutch K2 and via the engaged coupling device C, as well as via the engaged shift element K as a winding path gear and/or an overdrive gear O2 can be shifted via the first clutch K1, via the engaged coupling device A, via the engaged coupling device E and via the engaged coupling device H, as well as shifted as a winding path gear when the coupling device S_ab2 is disengaged.

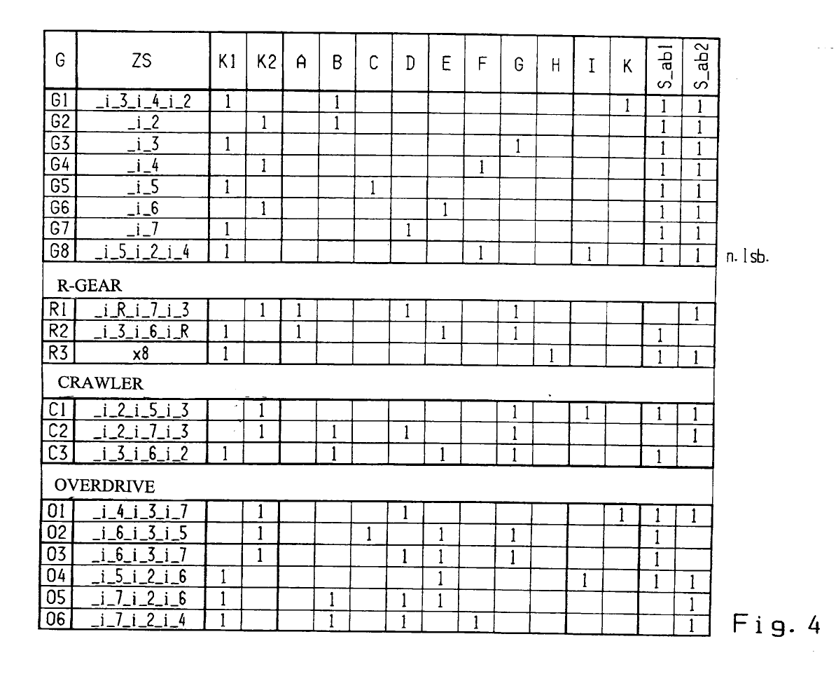

An exemplary shift diagram for the 2^{nd} variant of the embodiment of the eight-gear double clutch transmission depicted in FIG. 3 is illustrated in the table shown in FIG. 4.

It can be seen from the shift diagram that the first forward gear G1 can be shifted via the first clutch K1 and via the engaged coupling device B, as well as via the engaged shift element K as a winding path gear, that the second forward gear G2 can be shifted via the second clutch K2 and via the engaged coupling device B, that the third forward gear G3 can be shifted via the first clutch K1 and via the engaged coupling device G that the fourth forward gear G4 can be shifted via the second clutch K2 and via the engaged coupling device F, that the fifth forward gear G5 can be shifted via the first clutch K1 and via the engaged coupling device C that the sixth forward gear G6 can be shifted via the second clutch K2 and via the engaged coupling device E, and that the seventh forward gear G7 can be shifted via the first clutch K1 and via the engaged coupling device D. Thus, in this manner, at least the first seven forward gears G1-G7 can be designed as being power shiftable. Over and above this, the eighth forward gear G8 can be shifted via the first clutch K1 and via the engaged coupling device F as well as via the engaged shift element I as a winding path gear.

Moreover, for example, one reverse gear R1 can be shifted via the second clutch K2, via the engaged coupling device A, via the engaged coupling device D and via the engaged coupling device G, as well as when the coupling device S_ab1 is disengaged and/or one reverse gear R2 can be shifted via the first clutch K1, via the engaged coupling device A, via the engaged coupling device E and via the engaged coupling device G, as a winding path gear when the coupling device S_ab2 is disengaged, and/or one reverse gear R3 can be shifted via the first clutch K1 and via the engaged coupling device H.

Furthermore, one crawler gear C1 can be shifted via the second clutch K2 and via the engaged coupling device G as a winding path gear via the engaged shift element I, and/or one crawler gear C2 can be shifted via the second clutch K2, via the engaged coupling device B, via the engaged coupling device D, and via the engaged coupling device G as a winding path gear when the coupling device S_ab1 is disengaged, and/or one crawler gear C3 can be shifted via the first clutch K1, via the engaged coupling device B, via the engaged coupling device E and via the engaged coupling device G, as a winding path gear when the coupling device S_ab2 is disengaged.

Finally, even one overdrive gear O1 can be shifted via the second clutch K2 and via the engaged coupling device D as a winding path gear via the engaged shift element K, and/or one overdrive gear O2 can be shifted via the second clutch K2, via the engaged coupling device C, via the engaged coupling device E and via the engaged coupling device G as a winding path gear when the coupling device S_ab2 is disengaged, and/or one overdrive gear O3 can be shifted via the second clutch K2, via the engaged coupling device D, via the engaged coupling device E and via the engaged coupling device G as a winding path gear when the coupling device S_ab2 is disengaged, and/or an overdrive gear O4 via the first clutch K1 and via the engaged coupling device E as well as via the engaged shift element I as a winding path gear and/or an overdrive gear O5 via the first clutch K1, via the engaged coupling device B, via the engaged coupling device D and via the coupling device E as a winding path gear when the coupling device S_ab1 is disengaged, and/or an overdrive gear O6 via the first clutch K1, via the engaged coupling device B, via the engaged coupling device D and via the engaged coupling device F, as a winding path gear when the coupling device S_ab1 is disengaged.

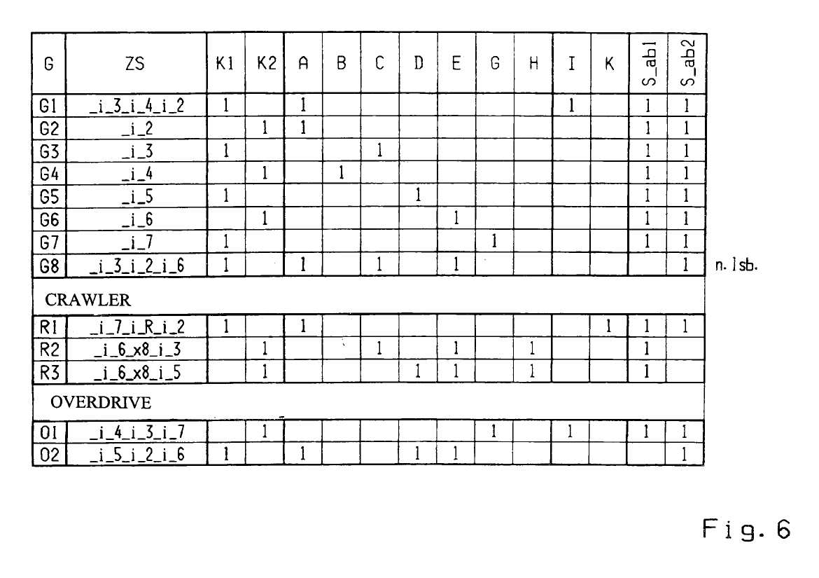

An exemplary shift diagram for the 3^{rd} variant of the embodiment of the eight-gear double clutch transmission depicted in FIG. 5 is illustrated in the table shown in FIG. 6.

It can be seen from the shift diagram that the first forward gear G1 can be shifted via the first clutch K1 and via the engaged coupling device A, as a winding path gear via the engaged shift element I, that the second forward gear G2 can be shifted via the second clutch K2 and via the engaged coupling device A, that the third forward gear G3 can be shifted via the first clutch K1 and via the engaged coupling device C, that the fourth forward gear G4 can be shifted via the second clutch K2 and via the engaged coupling device B, that the fifth forward gear G5 can be shifted via the first clutch K1 and via the engaged coupling device D, that the sixth forward gear G6 can be shifted via the second clutch K2 and via the engaged coupling device E, and that the seventh forward gear G7 can be shifted via the first clutch K1 and via the engaged coupling device G. Thus, in this manner, at least the first seven forward gears can be designed to be power shiftable. Furthermore, the eighth forward gear G8 can be shifted via the first clutch K1, via the engaged coupling device A, via the engaged coupling device C and via the engaged coupling device E, as a winding path gear when the coupling device S_ab1 is disengaged.

Over and above this, one reverse gear R1 can be shifted via the fist clutch K1 and via the engaged coupling device A as a winding path gear via the engaged shift element K, and/or one reverse gear R2 can be shifted via the second clutch K2, via the engaged coupling device C, via the engaged coupling device E and via the engaged coupling device H as a winding path gear when the coupling device S_ab2 is disengaged, and/or one reverse gear R3 can be shifted via the second clutch K2, via the engaged coupling device D, via the engaged coupling device E and via the engaged coupling device H as a winding path gear when the coupling device S_ab2 is disengaged.

In addition, for example, in the case of the third variant of the embodiment, one overdrive gear O1 can be shifted via the second clutch K2 and via the engaged coupling device G, as a winding path gear via the engaged shift element I, and/or an overdrive gear O2 can be shifted via the first clutch K1, via the engaged coupling device A, via the engaged coupling device D and via the engaged coupling device E as a winding path gear when the coupling device S_ab1 is disengaged.

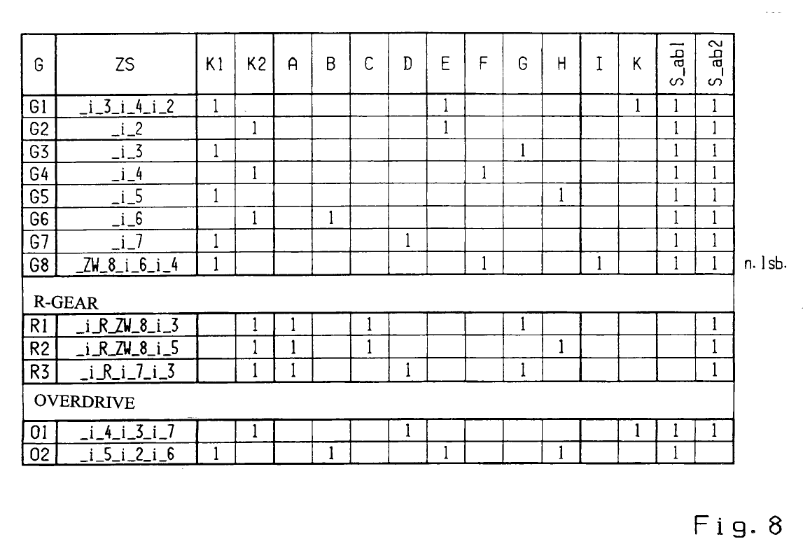

An example shift diagram for the 4^{th} variant of the embodiment of the eight-gear double clutch transmission depicted in FIG. 7 is illustrated in the table shown in FIG. 8.

It can be seen from the shift diagram that the first forward gear G1 can be shifted via the first clutch K1 and via the engaged coupling device E, as a winding path gear via the engaged shift element K, that the second forward gear G2 can be shifted via the second clutch K2 and via the engaged coupling device E, that the third forward gear G3 can be shifted via the first clutch K1 and via the engaged coupling device G, that the fourth forward gear G4 can be shifted via the second clutch K2 and via the engaged coupling device F, that the fifth forward gear G5 can be shifted via the first clutch K1 and via the engaged coupling device H, that the sixth forward gear G6 can be shifted via the second clutch K2 and via the engaged coupling device B, and that the seventh forward gear G7 can be shifted via the first clutch K1 and via the engaged coupling device D. Thus, in this manner, at least the first seven forward gears can be designed to be power shiftable. Furthermore, the eighth forward gear G8 can be shifted via the first clutch K1 and via the engaged coupling device F as a winding path gear via the engaged shift element I.

Moreover, for example, one reverse gear R1 can be shifted via the second clutch K2, via the engaged coupling device A, via the engaged coupling device C and via the engaged coupling device G as a winding path gear when the coupling device S_ab1 is disengaged, and/or one reverse gear R2 via the second clutch K2 via the engaged coupling device A, via the engaged coupling device C and via the engaged coupling device H, as a winding path gear when the coupling device S_ab1 is disengaged, and/or one reverse gear R3 via the second clutch K2, via the engaged coupling device A, via the engaged coupling device D, and via the engaged coupling device G, as a winding path gear when the coupling device S_ab1 is disengaged.

Over and above this, for example, in the case of the 4^{th} variant of the embodiment, one overdrive gear O1 can be shifted via the second clutch K2 and via the engaged coupling device D, as a winding path gear via the engaged shift element K and/or an overdrive gear O2 can be shifted via the first clutch K1, via the engaged coupling device B, via the engaged coupling device E as a winding path gear H when the coupling device S_ab2 is disengaged.

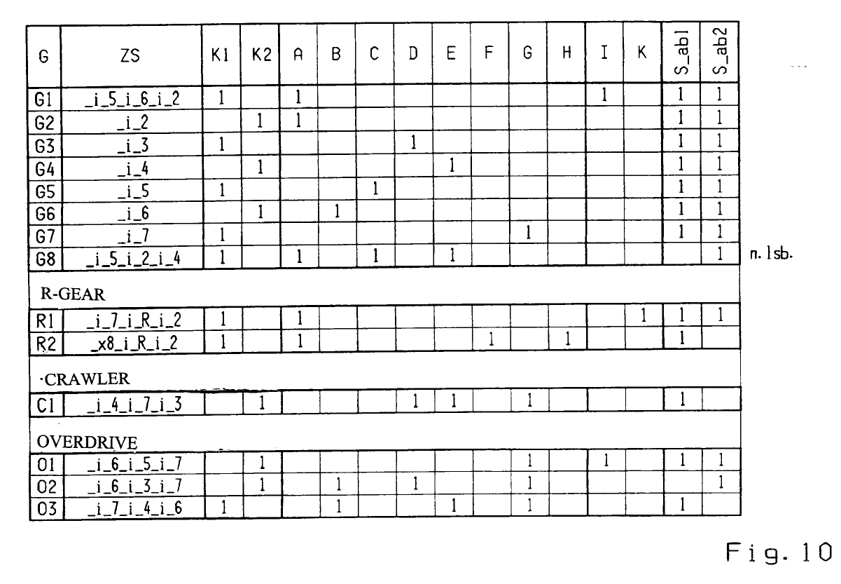

An example shift diagram for the 5^{th} variant of the embodiment of the eight-gear double clutch transmission depicted in FIG. 9 is illustrated in the table shown in FIG. 10.

It can be seen from the shift diagram that the first forward gear G1 can be shifted via the first clutch K1 and via the engaged coupling device A as a winding path gear via the engaged shift element I, that the second forward gear G2 can be shifted via the second clutch K2 and via the engaged coupling device A, that the third forward gear G3 can be shifted via the first clutch K1 and via the engaged coupling device D, that the fourth forward gear G4 can be shifted via the second clutch K2 and via the engaged coupling device E, that the fifth forward gear G5 can be shifted via the first clutch K1 and via the engaged coupling device C, that the sixth forward gear G6 can be shifted via the second clutch K2 and via the engaged coupling device B, and that the seventh forward gear G7 can be shifted via the first clutch K1 and via the engaged coupling device G. Thus, in this manner, at least the first seven forward gears can be designed to be power shiftable. Furthermore, for example, the eighth forward gear G8 can be shifted via the first clutch K1, via the engaged coupling device A, via the engaged coupling device C and via the engaged coupling device E, as a winding path gear when the coupling device S_ab1 is disengaged.

In addition, for example, in the case of the 5^{th} variant of the embodiment, one reverse gear R1 can be shifted via the first clutch K1 and via the engaged coupling device A, as a winding path gear via the engaged shift element K, and/or one reverse gear R2 can be shifted via the first clutch K1, via the engaged coupling device A, via the engaged coupling device F, and via the engaged coupling device H, as a winding path gear when the coupling device S_ab2 is disengaged.

Over and above this, for example, a crawler gear C1 can be shifted via the second clutch K2, via the engaged coupling device D, via the engaged coupling device E and via the engaged coupling device G, as a winding path gear when the coupling device S_ab2 is disengaged.

In addition, in the case of the 5^{th} variant of the embodiment, one overdrive gear O1 can be shifted via the second clutch K2 and via the engaged coupling device G as a winding path gear via the engaged shift element I, and/or one overdrive gear O2 can be shifted via the second clutch K2, via the engaged coupling device B, via the engaged coupling device D and via the engaged coupling device G, as a winding path gear when the coupling device S_ab1 is disengaged, and/or one overdrive gear O3 can be shifted via the first clutch K1, via the engaged coupling device B, via the engaged coupling device E and via the engaged coupling device G, as a winding path gear when the coupling device S_ab2 is disengaged.

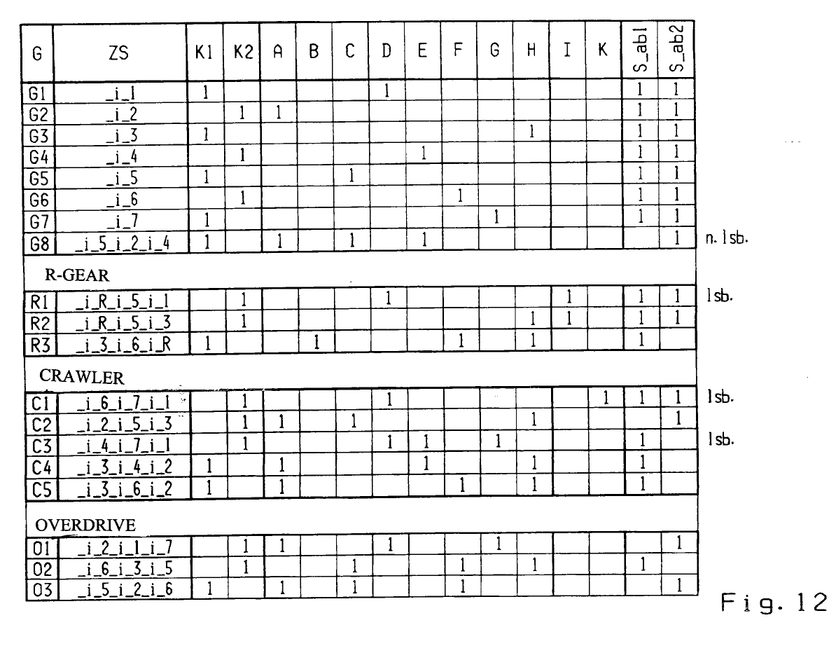

An example shift diagram for the 6^{th} variant of the embodiment of the eight-gear double clutch transmission depicted in FIG. 11 is illustrated in the table shown in FIG. 12.

It can be seen from the shift diagram that the first forward gear G1 can be shifted via the first clutch K1 and via the engaged coupling device D, that the second forward gear G2 can be shifted via the second clutch K2 and via the engaged coupling device A, that the third forward gear G3 can be shifted via the first clutch K1 and via the engaged coupling device H, that the fourth forward gear G4 can be shifted via the second clutch K2 and via the engaged coupling device E, that the fifth forward gear G5 can be shifted via the first clutch K1 and via the engaged coupling device C, that the sixth forward gear G6 can be shifted via the second clutch K2 and via the engaged coupling device F, and that the seventh forward gear G7 can be shifted via the first clutch K1 and via the engaged coupling device G. Thus, in this manner, at least the first seven forward gears can be designed to be power shiftable. Furthermore, the eighth forward gear G8 can be shifted via the first clutch K1, via the engaged coupling device A, via the engaged coupling device C and via the engaged coupling device E, as a winding path gear when the coupling device S_ab1 is disengaged.

In addition, for example, one reverse gear R1 can be shifted via the second clutch K2 and via the engaged coupling device D, as a winding path gear via the engaged shift element I, and/or one reverse gear R2 can be shifted via the second clutch K2 and via the engaged coupling device H, as a winding path gear via the engaged shift element I, and/or one reverse gear R3 via the first clutch K1, via the engaged coupling device B, via the engaged coupling device F and via the engaged coupling device H, as a winding path gear when the coupling device S_ab2 is disengaged.

Over and above this, in the case of the sixth variant of the embodiment, for example, one crawler gear C1 can be shifted via the second clutch K2 and via the engaged coupling device D, as a winding path gear via the engaged shift element K, and/or one crawler gear C2 can be shifted via the second clutch K2, via the engaged coupling device A, via the engaged coupling device C and via the engaged coupling device H, as a winding path gear when the coupling device S_ab1 is disengaged, and/or one crawler gear C3 via the second clutch K2, via the engaged coupling device D, via the engaged coupling device E and via the engaged coupling device G, as a winding path gear when the coupling device S_ab2 is disengaged, and/or one crawler gear C4 can be shifted via the first clutch K1, via the engaged coupling device A, via the engaged coupling device E and via the engaged coupling device H, as a winding path gear when the coupling device S_ab2 is disengaged, and/or one crawler gear C5 can be shifted via the first clutch K1, via the engaged coupling device A, via the engaged coupling device F and via the engaged coupling device H, as a winding path gear when the coupling device S_ab2 is disengaged.

Moreover, for example, one overdrive gear O1 can be shifted via the second clutch K2, via the engaged coupling device A, via the engaged coupling device D and via the engaged coupling device G as a winding path gear when the coupling device S_ab1 is disengaged, and/or one overdrive gear O2 can be shifted via the second clutch K2, via the engaged coupling device C, via the engaged coupling device F and via the engaged coupling device H, as a winding path gear when the coupling device S_ab2 is disengaged, and/or one overdrive gear O3 can be shifted via the first clutch K1, via the engaged coupling device A, via the engaged coupling device C and via the engaged coupling device F, as a winding path gear when the coupling device S_ab1 is disengaged.

In the process, it is particularly beneficial that the reverse gear R1 can be designed to be power shiftable to the first forward gear (R1 power shiftable to G1). In addition, both the crawler gears C1 and C3 are power shiftable to the first forward gear (C1, C3 power shiftable to G1).

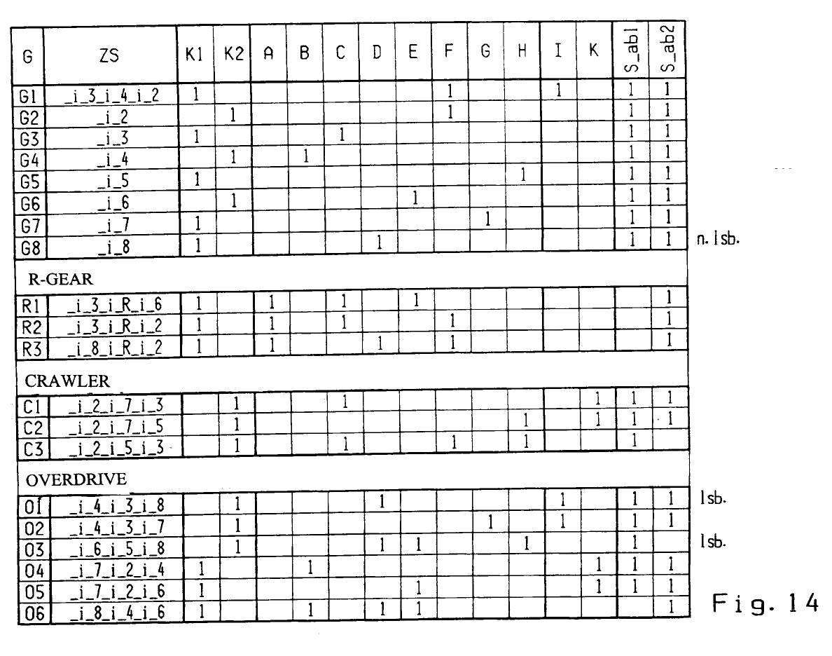

An example shift diagram for the 7^{th} variant of the embodiment of the eight-gear double clutch transmission depicted in FIG. 13 is illustrated in the table shown in FIG. 14.

It can be seen from the shift diagram that the first forward gear G1 can be shifted via the first clutch K1 and via the engaged coupling device F, as a winding path gear via the engaged shift element I, that the second forward gear G2 can be shifted via the second clutch K2 and via the engaged coupling device F, that the third forward gear G3 can be shifted via the first clutch K1 and via the engaged coupling device C, that the fourth forward gear G4 can be shifted via the second clutch K2 and via the engaged coupling device B, that the fifth forward gear G5 can be shifted via the first clutch K1 and via the engaged coupling device H, that the sixth forward gear G6 can be shifted via the second clutch K2 and via the engaged coupling device E, and that the seventh forward gear G7 can be shifted via the first clutch K1 and via the engaged coupling device G. Thus, in this manner, at least the first seven forward gears can be designed to be power shiftable. Furthermore, the eighth forward gear G8 can be shifted via the first clutch K1 and via the engaged coupling device D.

Moreover, one reverse gear R1 can be shifted via the first clutch K1, via the engaged coupling device A, via the engaged coupling device C and via the engaged coupling device E, as a winding path gear when the coupling device S_ab1 is disengaged, and/or one reverse gear R2 can be shifted via the first clutch K1, via the engaged coupling device A, via the engaged coupling device C and via the engaged coupling device F, as a winding path gear when the coupling device S_ab1 is disengaged, and/or one reverse gear R3 can be shifted via the first clutch K1, via the engaged coupling device A, via the engaged coupling device D and via the engaged coupling device F, as a winding path gear when the coupling device S_ab1 is disengaged.

Over and above this, in the case of the 7^{th} variant of the embodiment, one crawler gear C1 can be shifted via the second clutch K2 and via the engaged coupling device C, as a winding path gear via the engaged shift element K, and/or one crawler gear C2 can be shifted via the second clutch K2 and via the engaged coupling device H, as a winding path gear via the engaged shift element K, and/or one crawler gear C3 can be shifted via the second clutch K2, via the engaged coupling device C, via the engaged coupling device F and via the engaged coupling device H, as a winding path gear when the coupling device S_ab2 is disengaged.

In addition, one overdrive gear O1 can be shifted via the second clutch K2 and via the engaged coupling device D, as a winding path gear via the engaged shift element I, and/or one overdrive gear O2 can be shifted via the second clutch K2 and via the engaged coupling device G, as a winding path gear via the engaged shift element I, and/or one overdrive gear O3 can be shifted via the second clutch K2, via the engaged coupling device D, via the engaged coupling device E and via the engaged coupling device H, as a winding path gear when the coupling device S_ab2 is disengaged, and/or one overdrive gear O4 can be shifted via the first clutch K1, and via the engaged coupling device B, as a winding path gear via the engaged shift element K, and/or one overdrive gear O5 can be shifted via the first clutch K1 and via the engaged coupling device E, as a winding path gear via the engaged shift element K, and or one overdrive gear O6 can be shifted via the first clutch K1, via the engaged coupling device B, via the engaged coupling device D and via the engaged coupling device E, as a winding path gear when the coupling device S_ab1 is disengaged.

In the process, it is particularly beneficial that the overdrive gear O1 and the overdrive gear O3 respectively can be designed to be power shiftable to the eighth forward gear (O1, O3 power shiftable to G8).

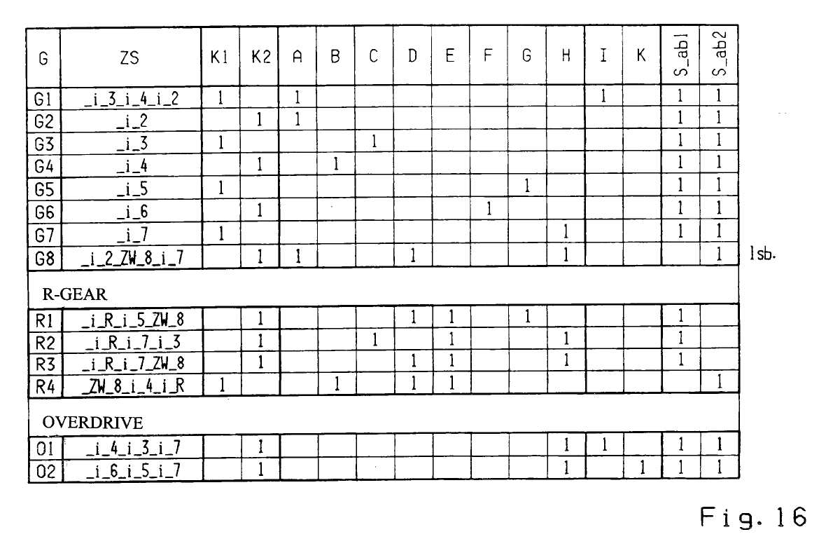

An example shift diagram for the 8^{th} variant of the embodiment of the eight-gear double clutch transmission depicted in FIG. 15 is illustrated in the table shown in FIG. 16.

It can be seen from the shift diagram that the first forward gear G1 can be shifted via the first clutch K1 and via the engaged coupling device A as a winding path gear via the engaged shift element I, that the second forward gear G2 can be shifted via the second clutch K2 and via the engaged coupling device A, that the third forward gear G3 can be shifted via the first clutch K1 and via the engaged coupling device C, that the fourth forward gear G4 can be shifted via the second clutch K2 and via the engaged coupling device B, that the fifth forward gear G5 can be shifted via the first clutch K1 and via the engaged coupling device G, that the sixth forward gear G6 can be shifted via the second clutch K2 and via the engaged coupling device F, and that the seventh forward gear G7 can be shifted via the first clutch K1 and via the engaged coupling device H. Thus, in this manner, at least the first seven forward gears can be designed to be power shiftable. Furthermore, the eighth forward gear G8 can be shifted via the second clutch K2, via the engaged coupling device A, via the engaged coupling device D and via the engaged coupling device H, as a winding path gear when the coupling device S_ab1 is disengaged.

Over and above this, for example, one reverse gear R1 can be shifted via the second clutch K2, via the engaged coupling device D, via the engaged coupling device E and via the engaged coupling device G, as a winding path gear when the coupling device S_ab2 is disengaged, and/or one reverse gear R2 can be shifted via the second clutch K2, via the engaged coupling device C, via the engaged coupling device E and via the engaged coupling device H, as a winding path gear when the coupling device S_ab2 is disengaged, and/or one reverse gear R3 can be shifted via the second clutch K2, via the engaged coupling device D, via the engaged coupling device E and via the engaged coupling device H, as a winding path gear when the coupling device S_ab2 is disengaged, and/or one reverse gear R4 can be shifted via the first clutch K1, via the engaged coupling device B, via the engaged coupling device D and via the engaged coupling device E, as a winding path gear when the coupling device S_ab1 is disengaged.

In addition, one overdrive gear O1 can be shifted via the second clutch K2 and via the engaged coupling device H, as a winding path gear via the engaged shift element I, and/or one overdrive gear O2 can be shifted via the second clutch K2 and via the engaged coupling device H, as a winding path gear via the engaged shift element K.

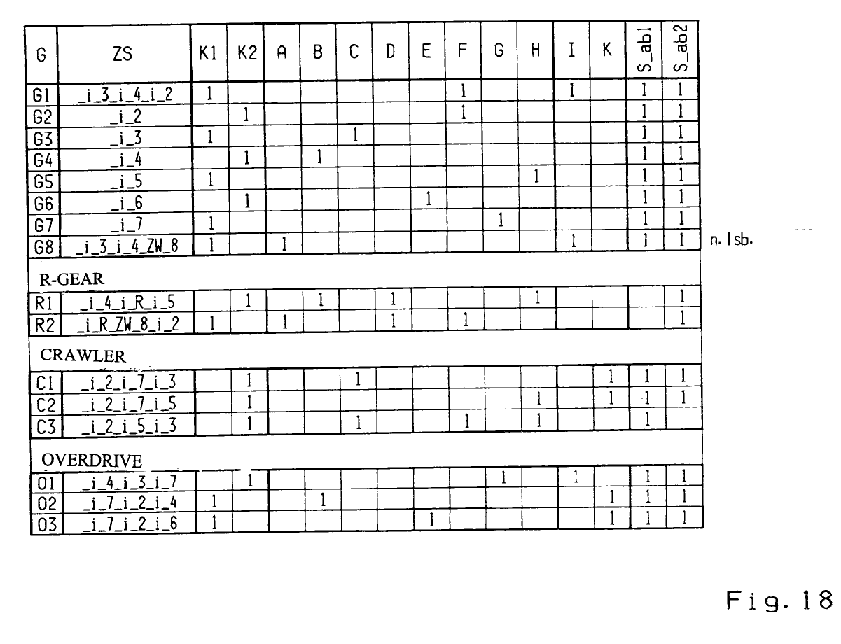

An example shift diagram for the 9^{th} variant of the embodiment of the eight-gear double clutch transmission depicted in FIG. 17 is illustrated in the table shown in FIG. 18.

It can be seen from the shift diagram that the first forward gear G1 can be shifted via the first clutch K1 and via the engaged coupling device F, as a winding path gear via the engaged shift element I, that the second forward gear G2 can be shifted via the second clutch K2 and via the engaged coupling device F, that the third forward gear G3 can be shifted via the first clutch K1 and via the engaged coupling device C, that the fourth forward gear G4 can be shifted via the second clutch K2 and via the engaged coupling device B, that the fifth forward gear G5 can be shifted via the first clutch K1 and via the engaged coupling device H, that the sixth forward gear G6 can be shifted via the second clutch K2 and via the engaged coupling device E, and that the seventh forward gear G7 can be shifted via the first clutch K1 and via the engaged coupling device G. Thus, in this manner, at least the first seven forward gears can be designed to be power shiftable. Furthermore, the eighth forward gear G8 can be shifted via the first clutch K1 and via the engaged coupling device A, as a winding path gear via the engaged shift element I.

Over and above this, for example, one reverse gear R1 can be shifted via the second clutch K2, via the engaged coupling device B, via the engaged coupling device D and via the engaged coupling device H, as a winding path gear when the coupling device S_ab1 is disengaged, and/or one reverse gear R2 can be shifted via the first clutch K1, via the engaged coupling device A, via the engaged coupling device D and via the engaged coupling device F, as a winding path gear when the coupling device S_ab1 is disengaged.

Furthermore, in the case of the 9^{th} variant of the embodiment, one crawler gear C1 can be shifted via the second clutch K2 and via the engaged coupling device C, as a winding path gear via the engaged shift element K, and/or one crawler gear C2 can be shifted via the second clutch K2 and via the engaged coupling device H, as a winding path gear via the engaged shift element K, and/or one crawler gear C3 can be shifted via the second clutch K2, via the engaged coupling device C, via the engaged coupling device F and via the engaged coupling device H, as a winding path gear when the coupling device S_ab2 is disengaged.

In addition, one overdrive gear O1 can be shifted via the second clutch K2 and via the engaged coupling device G, as a winding path gear via the engaged shift element I, and/or one overdrive gear O2 can be shifted via the first clutch K1 and via the engaged coupling device B, as a winding path gear via the engaged shift element K, and/or one overdrive gear O3 can be shifted via the first clutch K1 and via the engaged coupling device E, as a winding path gear via the engaged shift element K.

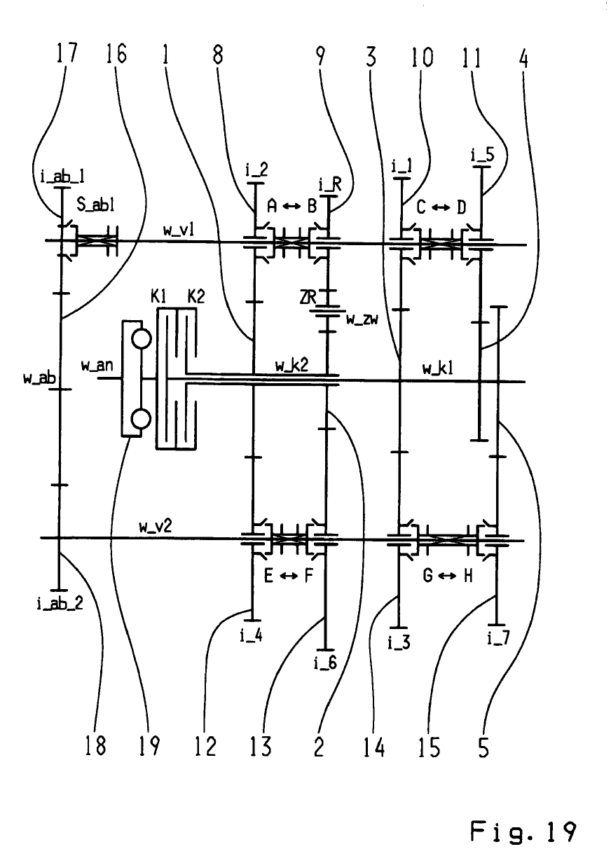

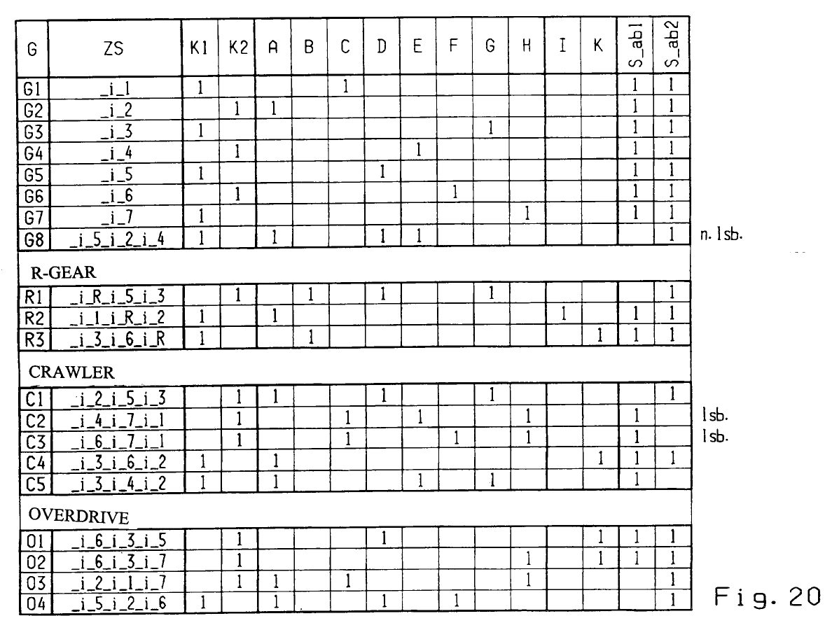

An example shift diagram for the 10^{th} variant of the embodiment of the eight-gear double clutch transmission depicted in FIG. 19 is illustrated in the table shown in FIG. 20.

It can be seen from the shift diagram that the first forward gear G1 can be shifted via the first clutch K1 and via the engaged coupling device C, that the second forward gear G2 can be shifted via the second clutch K2 and via the engaged coupling device A, that the third forward gear G3 can be shifted via the first clutch K1 and via the engaged coupling device G, that the fourth forward gear G4 can be shifted via the second clutch K2 and via the engaged coupling device E, that the fifth forward gear G5 can be shifted via the first clutch K1 and via the engaged coupling device D, that the sixth forward gear G6 can be shifted via the second clutch K2 and via the engaged coupling device F, and that the seventh forward gear G7 can be shifted via the first clutch K1 and via the engaged coupling device H. Thus, in this manner, at least the first seven forward gears can be designed to be power shiftable. Furthermore, the eighth forward gear G8 can be shifted via the first clutch K1, via the engaged coupling device A, via the engaged coupling device D and via the engaged coupling device E, as a winding path gear when the coupling device S_ab1 is disengaged.

In addition, in the case of the 10^{th} variant of the embodiment, for example, one reverse gear R1 can be shifted via the second clutch K2, via the engaged coupling device B, via the engaged coupling device D and via the engaged coupling device G, as a winding path gear when the coupling device S_ab1 is disengaged, and/or one reverse gear R2 can be shifted via the first clutch K1 and via the engaged coupling device A, as a winding path gear via the engaged shift element I, and/or one reverse gear R3 can be shifted via the engaged clutch K1 and via the engaged coupling device B, as a winding path gear via the engaged shift element K.

Over and above this, for example, one crawler gear C1 can be shifted via the second clutch K2, via the engaged coupling device A, via the engaged coupling device D and via the engaged coupling device G, as a winding path gear when the coupling device S_ab1 is disengaged, and/or one crawler gear C2 can be shifted via the second clutch K2, via the engaged coupling device C, via the engaged coupling device E and via the engaged coupling device H, as a winding path gear when the coupling device S_ab2 is disengaged, and/or one crawler gear C3 can be shifted via the second clutch K2, via the engaged coupling device C, via the engaged coupling device F and via the engaged coupling device H, as a winding path gear when the coupling device S_ab2 is disengaged, and/or one crawler gear C4 can be shifted via the first clutch K1, via the engaged coupling device A, as a winding path gear via the engaged shift element K, and/or one crawler gear C5 can be shifted via the first clutch K1, via the engaged coupling device A, via the engaged coupling device E and via the engaged coupling device G, as a winding path gear when the coupling device S_ab2 is disengaged.

Furthermore, for example, one overdrive gear O1 can be shifted via the second clutch K2 and via the engaged coupling device D, as a winding path gear via the engaged shift element K, and/or one overdrive gear O2 can be shifted via the second clutch K2 and via the engaged coupling device H, as a winding path gear via the engaged shift element K, and/or one overdrive gear O3 can be shifted via the second clutch K2, via the engaged coupling device A, via the engaged coupling device C and via the engaged coupling device H, as a winding path gear when the coupling device S_ab1 is disengaged, and/or one overdrive gear O4 can be shifted via the first clutch K1, via the engaged coupling device A, via the engaged coupling device D and via the engaged coupling device F, as a winding path gear when the coupling device S_ab1 is disengaged.

In the process, the advantage is that, among others, the crawler gear C2 and the crawler gear C3 respectively can be designed to be power shiftable to the first forward gear (C2, C3 power shiftable to G1).

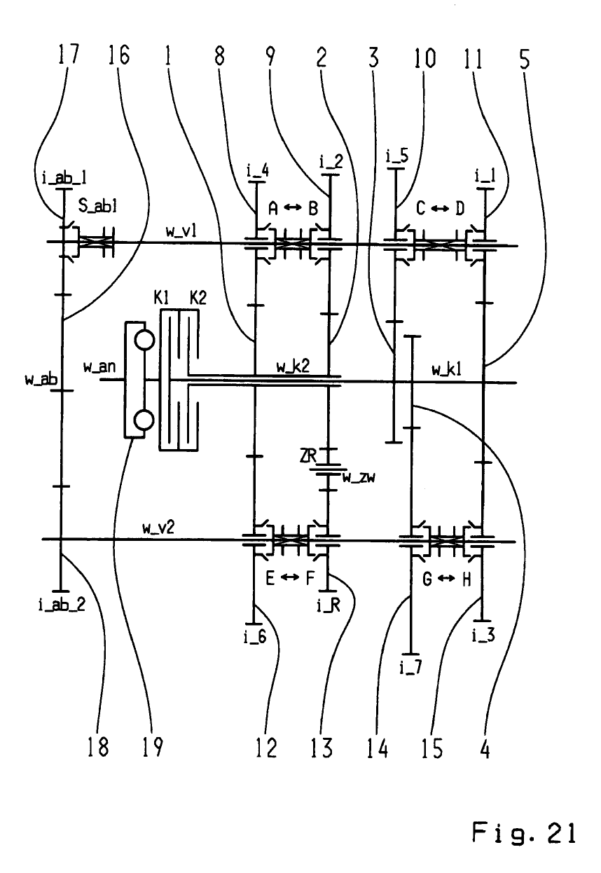

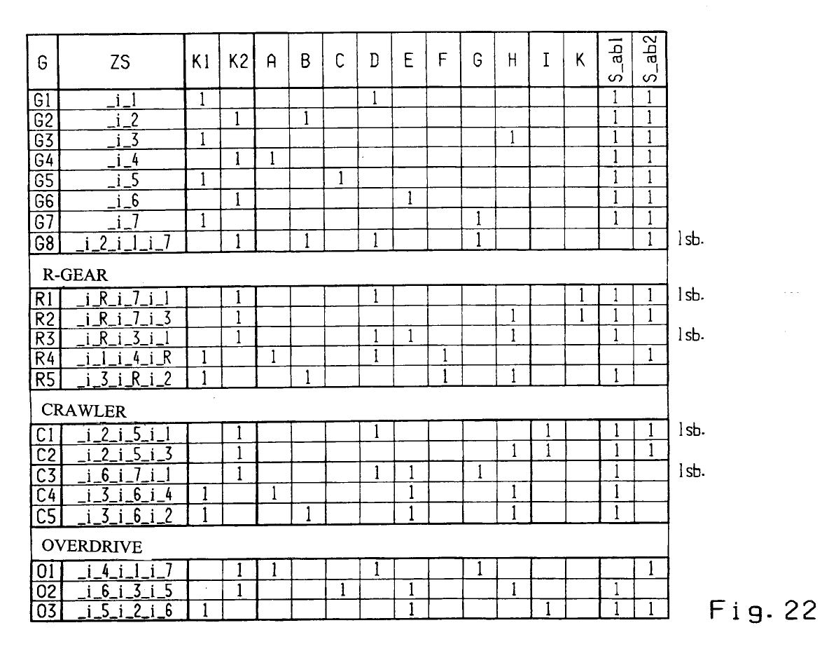

An example shift diagram for the 11^{th} variant of the embodiment of the eight-gear double clutch transmission depicted in FIG. 21 is illustrated in the table shown in FIG. 22.

It can be seen from the shift diagram that the first forward gear G1 can be shifted via the first clutch K1 and via the engaged coupling device D, that the second forward gear G2 can be shifted via the second clutch K2 and via the engaged coupling device B, that the third forward gear G3 can be shifted via the first clutch K1 and via the engaged coupling device H, that the fourth forward gear G4 can be shifted via the second clutch K2 and via the engaged coupling device A, that the fifth forward gear G5 can be shifted via the first clutch K1 and via the engaged coupling device C, that the sixth forward gear G6 can be shifted via the second clutch K2 and via the engaged coupling device E, and that the seventh forward gear G7 can be shifted via the first clutch K1 and via the engaged coupling device G, and/or that the eighth forward gear G8 can be shifted via the second clutch K2, via the engaged coupling device B, via the engaged coupling device D and via the engaged coupling device G, as a winding path gear when the coupling device S_ab1 is disengaged. Thus, in this manner, at least the first eight forward gears can be designed to be power shiftable.

Over and above this, in the case of the 11^{th} variant of the embodiment, one reverse gear R1 can be shifted via the second clutch K2 and via the engaged coupling device D as a winding path gear via the engaged shift element K, and/or one reverse gear R2 can be shifted via the second clutch K2 and via the engaged coupling device H, as a winding path gear via the engaged shift element K, and/or one reverse gear R3 can be shifted via the second clutch K2, via the engaged coupling device D, via the engaged coupling device E and via the engaged coupling device H, as a winding path gear when the coupling device S_ab2 is disengaged, and/or one reverse gear R4 can be shifted via the first clutch K1, via the engaged coupling device A, via the engaged coupling device D and via the coupling device F, as a winding path gear when the coupling device S_ab1 is disengaged, and/or one reverse gear R5 can be shifted via the first clutch K1, via the engaged coupling device B, via the engaged coupling device F and via the engaged coupling device H, as a winding path gear when the coupling device S_ab2 is disengaged.

In addition, one crawler gear C1 can be shifted via the second clutch K2 and via the engaged coupling device D, as a winding path gear via the engaged shift element I, and/or one crawler gear C2 can be shifted via the second clutch K2 and via the engaged coupling device H, as a winding path gear via the engaged shift element I, and/or one crawler gear C3 can be shifted via the second clutch K2, via the engaged coupling device D, via the engaged coupling device E and via the engaged coupling device G, as a winding path gear when the coupling device S_ab2 is disengaged, and/or one crawler gear C4 can be shifted via the first clutch K1, via the engaged coupling device A, via the engaged coupling device E and via the engaged coupling device H, as a winding path gear when the coupling device S_ab2 is disengaged, and/or one crawler gear C5 can be shifted via the first clutch K1, via the engaged coupling device B, via the engaged coupling device E and via the engaged coupling device H, as a winding path gear when the coupling device S_ab2 is disengaged.

Furthermore, in the case of the 11^{th} variant of the embodiment, one overdrive gear O1 can be shifted via the second clutch K2, via the engaged coupling device A, via the engaged coupling device D and via the engaged coupling device G, as a winding path gear when the coupling device S_ab1 is disengaged and/or one overdrive gear O2 can be shifted via the second clutch K2, via the engaged coupling device C, via the engaged coupling device E and via the engaged coupling device H, as a winding path gear when the coupling device S_ab2 is disengaged, and/or one overdrive gear O3 can be shifted via the first clutch K1 and via the engaged coupling device E, as a winding path gear via the engaged shift element I.

In the process, it is beneficial that the reverse gear R1 and the reverse gear R3, as well as the crawler gear C1 and the crawler gear C3 respectively are designed to be power shiftable to the first forward gear (R1, R3 power shiftable to C1, and C1, C3 power shiftable to G1)

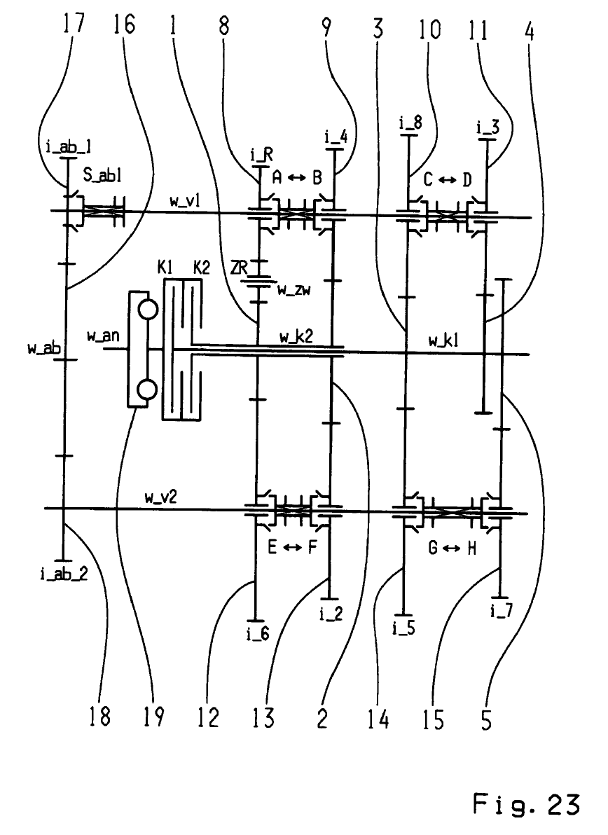

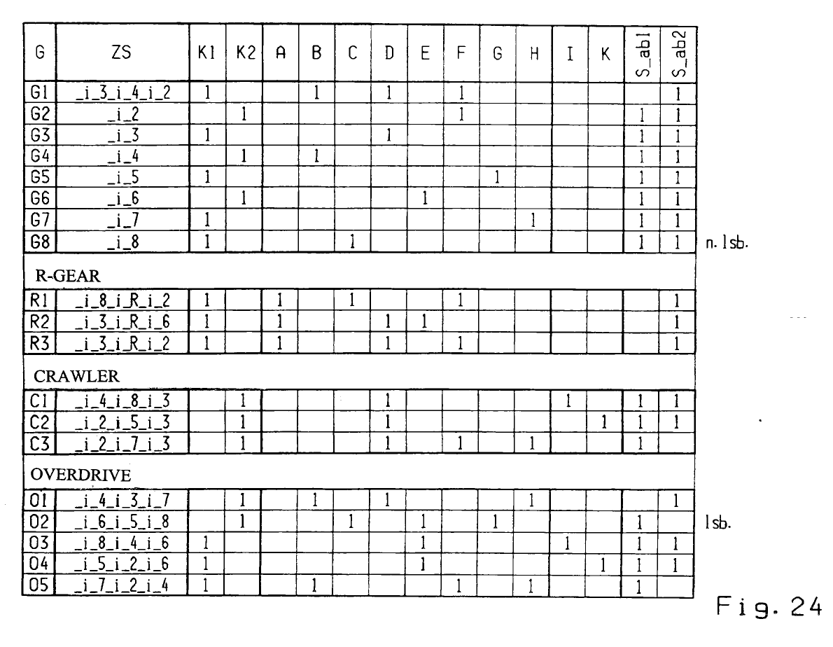

An example shift diagram for the 12^{th} variant of the embodiment of the eight-gear double clutch transmission depicted in FIG. 23 is illustrated in the table shown in FIG. 24.

It can be seen from the shift diagram that the first forward gear G1 can be shifted via the first clutch K1, via the engaged coupling device B, via the engaged coupling device D and via the engaged coupling device F, as a winding path gear when the coupling device S_ab1 is disengaged, that the second forward gear G2 can be shifted via the second clutch K2 and via the engaged coupling device F, that the third forward gear G3 can be shifted via the first clutch K1 and via the engaged coupling device D, that the fourth forward gear G4 can be shifted via the second clutch K2 and via the engaged coupling device B, that the fifth forward gear G5 can be shifted via the first clutch K1 and via the engaged coupling device G, that the sixth forward gear G6 can be shifted via the second clutch K2 and via the engaged coupling device E, and that the seventh forward gear G7 can be shifted via the first clutch K1 and via the engaged coupling device H. Thus, in this manner, at least the first seven forward gears can be designed to be power shiftable. Furthermore, the eighth forward gear G8 can be shifted via the first clutch K1 and via the engaged coupling device C.

In addition, for example, one reverse gear R1 can be shifted via the first clutch K1, via the engaged coupling device A, via the engaged coupling device C and via the engaged coupling device F, as a winding path gear when the coupling device S_ab1 is disengaged, and/or one reverse gear R2 can be shifted via the first clutch K1, via the engaged coupling device A, via the engaged coupling device D and via the engaged coupling device E, as a winding path gear when the coupling device S_ab1 is disengaged, and/or one reverse gear R3 can be shifted via the first clutch K1, via the engaged coupling device A, via the engaged coupling device D and via the engaged coupling device F, as a winding path gear when the coupling device S_ab1 is disengaged.

Over and above this, for example, in the case of the 12^{th} variant of the embodiment, one crawler gear C1 can be shifted via the second clutch K2 and via the engaged coupling device D, as a winding path gear via the engaged shift element I, and/or one crawler gear C2 can be shifted via the second clutch K2 and via the engaged coupling device D, as a winding path gear via the engaged shift element K, and/or one crawler gear C3 can be shifted via the second clutch K2, via the engaged coupling device D, via the engaged coupling device F and via the engaged coupling device H, as a winding path gear when the coupling device S_ab2 is disengaged.

In addition, one overdrive gear O1 can be shifted via the second clutch K2, via the engaged coupling device B, via the engaged coupling device D and via the engaged coupling device H, as a winding path gear when the coupling device S_ab1 is disengaged, and/or one overdrive gear O2 can be shifted via the second clutch K2, via the engaged coupling device C, via the engaged coupling device E and via the engaged coupling device G, as a winding path gear when the coupling device S_ab2 is disengaged, and/or one overdrive gear O3 can be shifted via the first clutch K1 and via the engaged coupling device E, as a winding path gear via the engaged shift element I, and/or one overdrive gear O4 can be shifted via the first clutch K1 and via the engaged coupling device E, as a winding path gear via the engaged shift element K, and/or one overdrive gear O5 can be shifted via the first clutch K1, via the engaged coupling device B, via the engaged coupling device F and via the engaged coupling device H, as a winding path gear when the coupling device S_ab2 is disengaged.

The overdrive gear O2 can be made power shiftable to the first forward gear in a beneficial way (O2 power shiftable to G8)

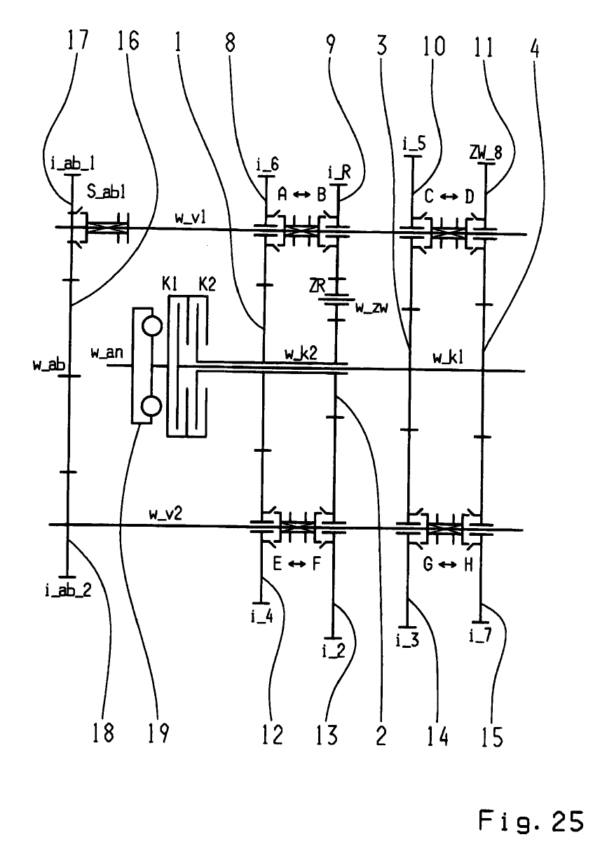

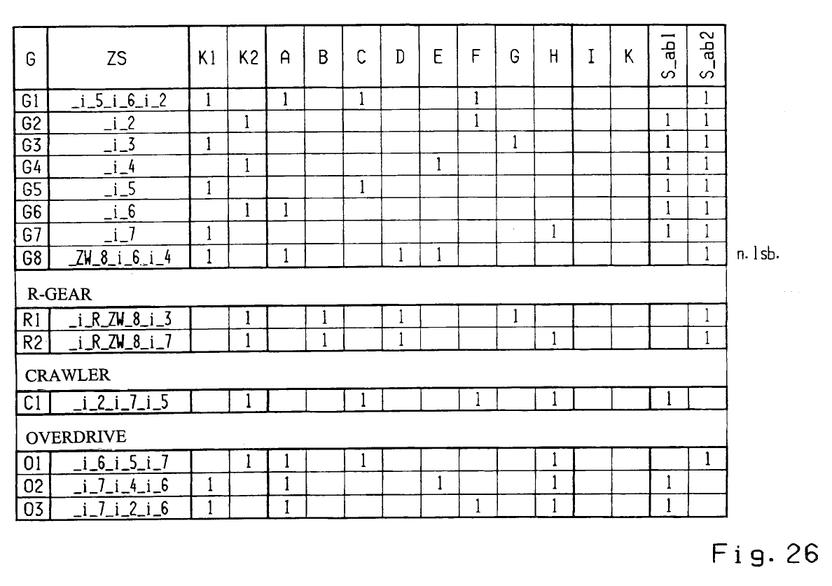

An example shift diagram for the 13^{th} variant of the embodiment of the eight-gear double clutch transmission depicted in FIG. 25 is illustrated in the table shown in FIG. 26.

It can be seen from the shift diagram that the first forward gear G1 can be shifted via the first clutch K1, via the engaged coupling device A, via the engaged coupling device C and via the engaged coupling device F, as a winding path gear when the coupling device S_ab1 is disengaged, that the second forward gear G2 can be shifted via the second clutch K2 and via the engaged coupling device F, that the third forward gear G3 can be shifted via the first clutch K1 and via the engaged coupling device G, that the fourth forward gear G4 can be shifted via the second clutch K2 and via the engaged coupling device E, that the fifth forward gear G5 can be shifted via the first clutch K1 and via the engaged coupling device C, that the sixth forward gear G6 can be shifted via the second clutch K2 and via the engaged coupling device A, and that the seventh forward gear G7 can be shifted via the first clutch K1 and via the engaged coupling device H. Thus, in this manner, at least the first seven forward gears can be designed to be power shiftable. Furthermore, the eighth forward gear G8 can be shifted via the first clutch K1, via the engaged coupling device A, via the engaged coupling device D and via the engaged coupling device E, as a winding path gear when the coupling device S_ab1 is disengaged.

Over and above this, in the case of the 13^{th} variant of the embodiment, for example, one reverse gear R1 can be shifted via the second clutch K2, via the engaged coupling device B, vie the engaged coupling device D and via the engaged coupling device G, as a winding path gear when the coupling device S_ab1 is disengaged, and/or one reverse gear R2 can be shifted via the second clutch K2, via the disengaged coupling device B, via the disengaged coupling device D and via the engaged coupling device H, as a winding path gear when the coupling device S_ab1 is disengaged.

In addition, one crawler gear C1 can be shifted via the second clutch K2, via the engaged coupling device C, via the engaged coupling device F and via the engaged coupling device H, as a winding path gear when the coupling device S_ab2 is disengaged, and/or one overdrive gear O1 can be shifted via the second clutch K2, via the engaged coupling device A, via the engaged coupling device C and via the engaged coupling device H, as a winding path gear when the coupling device S_ab1 is disengaged, and/or one overdrive gear O2 can be shifted via the first clutch K1, via the engaged coupling device A, via the engaged coupling device E and via the engaged coupling device H, as a winding path gear when the coupling device S_ab2 is disengaged, and/or one overdrive gear O3 can be shifted via the first clutch K1, via the engaged coupling device A, via the engaged coupling device F and via the engaged coupling device H, as a winding path gear when the coupling device S_ab2 is disengaged.

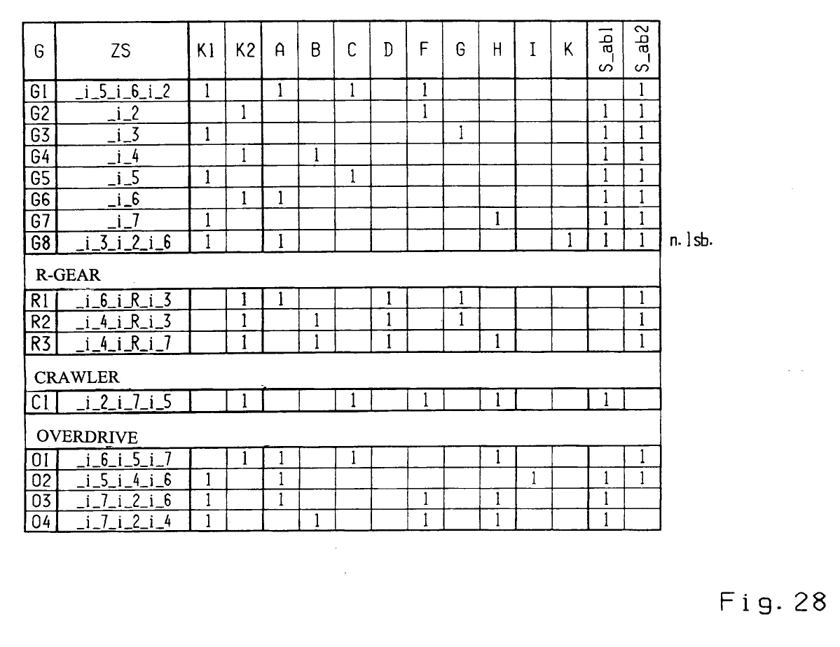

An example shift diagram for the 14^{th} variant of the embodiment of the eight-gear double clutch transmission depicted in FIG. 27 is illustrated in the table shown in FIG. 28.

It can be seen from the shift diagram that the first forward gear G1 can be shifted via the first clutch K1, via the engaged coupling device A, via the engaged coupling device C and via the engaged coupling device F, as a winding path gear when the coupling device S_ab1 is disengaged, that the second forward gear G2 can be shifted via the second clutch K2 and via the engaged coupling device F, that the third forward gear G3 can be shifted via the first clutch K1 and via the engaged coupling device G, that the fourth forward gear G4 can be shifted via the second clutch K2 and via the engaged coupling device B, that the fifth forward gear G5 can be shifted via the first clutch K1 and via the engaged coupling device C, that the sixth forward gear G6 can be shifted via the second clutch K2 and via the engaged coupling device A, and that the seventh forward gear G7 can be shifted via the first clutch K1 and via the engaged coupling device H. Thus, in this manner, at least the first seven forward gears can be designed to be power shiftable. Furthermore, the eighth forward gear G8 can be shifted via the first clutch K1 and via the engaged coupling device A, as a winding path gear via the engaged shift element K.

Moreover, in the case of the 14^{th} variant of the embodiment, one reverse gear R1 can be shifted via the second clutch K2, via the engaged coupling device A, via the engaged coupling device D and via the engaged coupling device G as a winding path gear when the coupling device S_ab1 is disengaged, and/or one reverse gear R2 via the second clutch K2 via the engaged coupling device B, via the engaged coupling device D and via the engaged coupling device G, as a winding path gear when the coupling device S_ab1 is disengaged, and/or one reverse gear R3 can be shifted via the second clutch K2, via the engaged coupling device B, via the engaged coupling device D and via the engaged coupling device H, as a winding path gear when the coupling device S_ab1 is disengaged.

Over and above this, for example, one crawler gear C1 can be shifted via the second clutch K2, via the engaged coupling device C, via the engaged coupling device F and via the engaged coupling device H, as a winding path gear when the coupling device S_ab2 is disengaged, and/or one overdrive gear O1 can be shifted via the second clutch K2, via the engaged coupling device A, via the engaged coupling device C and via the engaged coupling device H, as a winding path gear when the coupling device S_ab1 is disengaged, and/or one overdrive gear O2 can be shifted via the first clutch K1, via the engaged coupling device A, and as a winding path gear via the engaged shift element I, and/or one overdrive gear O3 can be shifted via the first clutch K1, via the engaged coupling device A, via the engaged coupling device F, and via the engaged coupling device H, as a winding path gear when the coupling device S_ab2 is disengaged, and/or one overdrive gear O4 can be shifted via the first clutch K1, via the engaged coupling device B, via the engaged coupling device F and via the engaged coupling device H, as a winding path gear when the coupling device S_ab2 is disengaged.

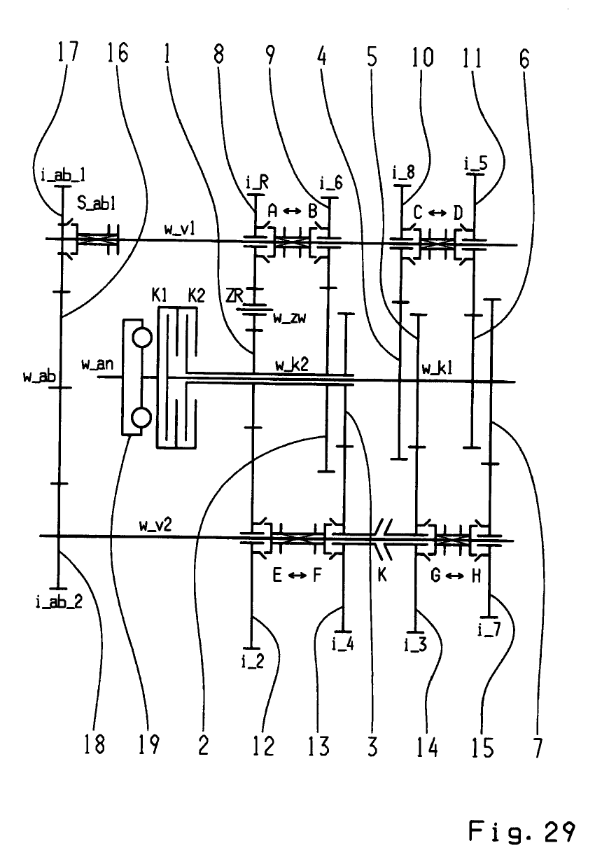

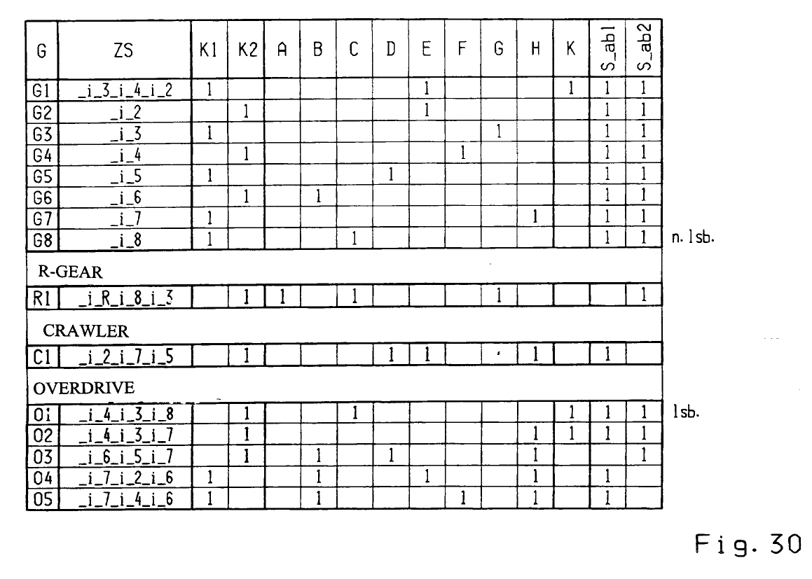

An example shift diagram for the 15^{th} variant of the embodiment of the eight-gear double clutch transmission depicted in FIG. 29 is illustrated in the table shown in FIG. 30.

It can be seen from the shift diagram that the first forward gear G1 can be shifted via the first clutch K1 and via the engaged coupling device E, as a winding path gear via the engaged shift element K, that the second forward gear G2 can be shifted via the second clutch K2 and via the engaged coupling device E, that the third forward gear G3 can be shifted via the first clutch K1 and via the engaged coupling device G, that the fourth forward gear G4 can be shifted via the second clutch K2 and via the engaged coupling device F, that the fifth forward gear G5 can be shifted via the first clutch K1 and via the engaged coupling device D, that the sixth forward gear G6 can be shifted via the second clutch K2 and via the engaged coupling device B, and that the seventh forward gear G7 can be shifted via the first clutch K1 and via the engaged coupling device H. Thus, in this manner, at least the first seven forward gears can be designed to be power shiftable. Furthermore, the eighth forward gear G8 can be shifted via the first clutch K1 and via the engaged coupling device C.

Over and above this, for example, in the case of the 15^{th} variant of the embodiment, one reverse gear R1 can be shifted via the second clutch K2, via the engaged coupling device A, via the engaged coupling device C and via the engaged coupling device G, as a winding path gear when the coupling device, S_ab1, is disengaged, and/or one crawler gear C1 can be shifted via the second clutch K2, via the engaged coupling device D, via the engaged coupling device E and via the engaged coupling device H, as a winding path gear when the coupling device S_ab2 is disengaged.

Furthermore, one overdrive gear O1 can be shifted via the second clutch K2 and via the engaged coupling device C, as a winding path gear via the engaged shift element K, and/or one overdrive gear O2 can be shifted via the second clutch K2 and via the engaged coupling device H, as a winding path gear via the engaged shift element K, and/or one overdrive gear O3 can be shifted via the second clutch K2, via the engaged coupling device B, via the engaged coupling device D and via the engaged coupling device H, as a winding path gear when the coupling device S_ab1 is disengaged, and/or one overdrive gear O4 can be shifted via the first clutch K1, via the engaged coupling device B, via the engaged coupling device E and via the engaged coupling device H, as a winding path gear when the coupling device S_ab2 is disengaged, and/or one overdrive gear O5 can be shifted via the first clutch K1, via the engaged coupling device B, via the engaged coupling device F and via the engaged coupling device H, as a winding path gear when the coupling device S_ab2 is disengaged.

The overdrive gear O1 can be made power shiftable to the eighth forward gear in a beneficial way (O1 power shiftable to G8).

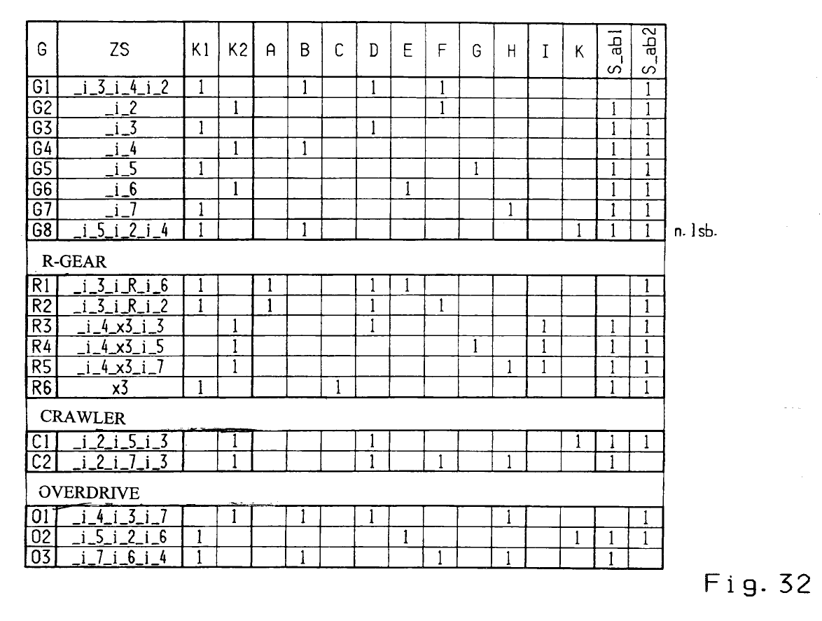

An example shift diagram for the 16^{th} variant of the embodiment of the eight-gear double clutch transmission depicted in FIG. 31 is illustrated in the table shown in FIG. 32.

It can be seen from the shift diagram that the first forward gear G1 can be shifted via the first clutch K1, via the engaged coupling device B, via the engaged coupling device D and via the engaged coupling device F, as a winding path gear when the coupling device S_ab1 is disengaged, that the second forward gear G2 can be shifted via the second clutch K2 and via the engaged coupling device F, that the third forward gear G3 can be shifted via the first clutch K1 and via the engaged coupling device D, that the fourth forward gear G4 can be shifted via the second clutch K2 and via the engaged coupling device B, that the fifth forward gear G5 can be shifted via the first clutch K1 and via the engaged coupling device G, that the sixth forward gear G6 can be shifted via the second clutch K2 and via the engaged coupling device E, and that the seventh forward gear G7 can be shifted via the first clutch K1 and via the engaged coupling device H. Thus, in this manner, at least the first seven forward gears can be designed to be power shiftable. Furthermore, the eighth forward gear G8 can be shifted via the first clutch K1 and via the engaged coupling device B, as a winding path gear via the engaged shift element K.

Over and above this, in the case of the 16^{th} variant of the embodiment, one reverse gear R1 can be shifted via the first clutch K1, via the engaged coupling device A, via the engaged coupling device D and via the engaged coupling device E, as a winding path gear when the coupling device S_ab1 is disengaged, and/or one reverse gear R2 can be shifted via the first clutch K1, via the engaged coupling device A, via the engaged coupling device D, and via the engaged coupling device F, as a winding path gear when the coupling device S_ab1 is disengaged, and/or one reverse gear R3 can be shifted via the second clutch K2 and via the engaged coupling device D, as a winding path gear via the engaged shift element I, and/or one reverse gear R4 can be switched via the second clutch K2 and via the engaged coupling device G as a winding path gear via the engaged shift element I, and/or one reverse gear R5 can be shifted via the second clutch K2 and via the engaged coupling device H, as a winding path gear via the engaged shift element I, and/or one reverse gear R6 can be shifted via the first clutch K1 and via the engaged coupling device C.

In addition, one crawler gear C1 can be shifted via the second clutch K2 and via the engaged coupling device D, as a winding path gear via the engaged shift element K, and/or one crawler gear C2 can be shifted via the second clutch K2, via the engaged coupling device D, via the engaged coupling device F and via the engaged coupling device H, as well as shifted as a winding path gear when the coupling device S_ab2 is disengaged.

Furthermore, one overdrive gear O1 can be shifted via the second clutch K2, via the engaged coupling device B, via the engaged coupling device D and via the engaged coupling device H, as a winding path gear when the coupling device S_ab1 is disengaged, and/or one overdrive gear O2 can be shifted via the first clutch K1 and via the engaged coupling device E, as a winding path gear via the engaged shift element K, and/or one overdrive gear O3 can be shifted via the first clutch K1, via the engaged coupling device B, via the engaged coupling device F and via the engaged coupling device H, as a winding path gear when the coupling device S_ab2 is disengaged.

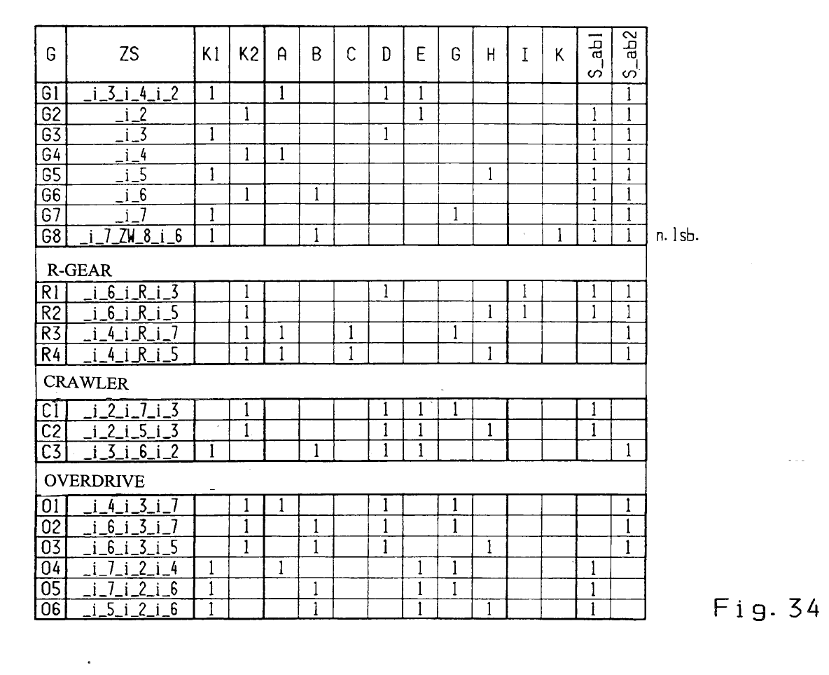

An example shift diagram for the 17^{th} variant of the embodiment of the eight-gear double clutch transmission depicted in FIG. 33 is illustrated in the table shown in FIG. 34.

It can be seen from the shift diagram that the first forward gear G1 can be shifted via the first clutch K1, via the engaged coupling device A, via the engaged coupling device D and via the engaged coupling device E, as a winding path gear when the coupling device S_ab1 is disengaged, that the second forward gear G2 can be shifted via the second clutch K2 and via the engaged coupling device E, that the third forward gear G3 can be shifted via the first clutch K1 and via the engaged coupling device D, that the fourth forward gear G4 can be shifted via the second clutch K2 and via the engaged coupling device A, that the fifth forward gear G5 can be shifted via the first clutch K1 and via the engaged coupling device H, that the sixth forward gear G6 can be shifted via the second clutch K2 and via the engaged coupling device B, and that the seventh forward gear G7 can be shifted via the first clutch K1 and via the engaged coupling device G. Thus, in this manner, at least the first seven forward gears can be designed to be power shiftable. Furthermore, the eighth forward gear G8 can be shifted via the first clutch K1 and via the engaged coupling device B, as a winding path gear via the engaged shift element K.

Over and above this, in the case of the 17^{th} variant of the embodiment, one reverse gear R1 can be shifted via the second clutch K2 and via the engaged coupling device D, as a winding path gear via the engaged shift element I, and/or one reverse gear R2 can be shifted via the second clutch K2 and via the engaged coupling device H, as a winding path gear via the engaged shift element I, and/or one reverse gear R3 can be shifted via the second clutch K2, via the engaged coupling device A, via the engaged coupling device C and via the engaged coupling device G, as a winding path gear when the coupling device S_ab1 is disengaged and/or one reverse gear R4 can be shifted via the second clutch K2, via the engaged coupling device A, via the engaged coupling device C and via the engaged coupling device H, as a winding path gear when the coupling device S_ab1 is disengaged.

Moreover, one crawler gear C1 can be shifted via the second clutch K2, via the engaged coupling device D, via the engaged coupling device E and via the engaged coupling device G as a winding path gear when the coupling device S_ab2 is disengaged, and/or one crawler gear C2 can be shifted via the second clutch K2, via the engaged coupling device D, via the engaged coupling device E and via the engaged coupling device H, as a winding path gear when the coupling device S_ab2 is disengaged, and/or one crawler gear C3 can be shifted via the first clutch K1, via the engaged coupling device B, via the engaged coupling device D and via the engaged coupling device E, as a winding path gear when the coupling device S_ab1 is disengaged.

Furthermore, one overdrive gear O1 can be shifted via the second clutch K2, via the engaged coupling device A, via the engaged coupling device D and via the engaged coupling device G, as a winding path gear when the coupling device S_ab1 is disengaged, and/or one overdrive gear O2 can be shifted via the second clutch K2, via the engaged coupling device B, via the engaged coupling device D and via the engaged coupling device G, as a winding path gear when the coupling device S_ab1 is disengaged, and/or one overdrive gear O3 can be shifted via the second clutch K2, via the engaged coupling device B, via the engaged coupling device D and via the engaged coupling device H, as a winding path gear when the coupling device S_ab1 is disengaged, and/or one overdrive gear O4 can be shifted via the first clutch K1, via the engaged coupling device A, via the engaged coupling device E and via the engaged coupling device G, as a winding path gear when the coupling device S_ab2 is disengaged, and/or one overdrive gear O5 can be shifted via the first clutch K1, via the engaged coupling device B, via the engaged coupling device E and via the engaged coupling device G, as a winding path gear when the coupling device S_ab2 is disengaged, and/or one overdrive gear O6 can be shifted via the first clutch K1, via the engaged coupling device B, via the engaged coupling device E and via the engaged coupling device H, as a winding path gear when the coupling device S_ab2 is disengaged.

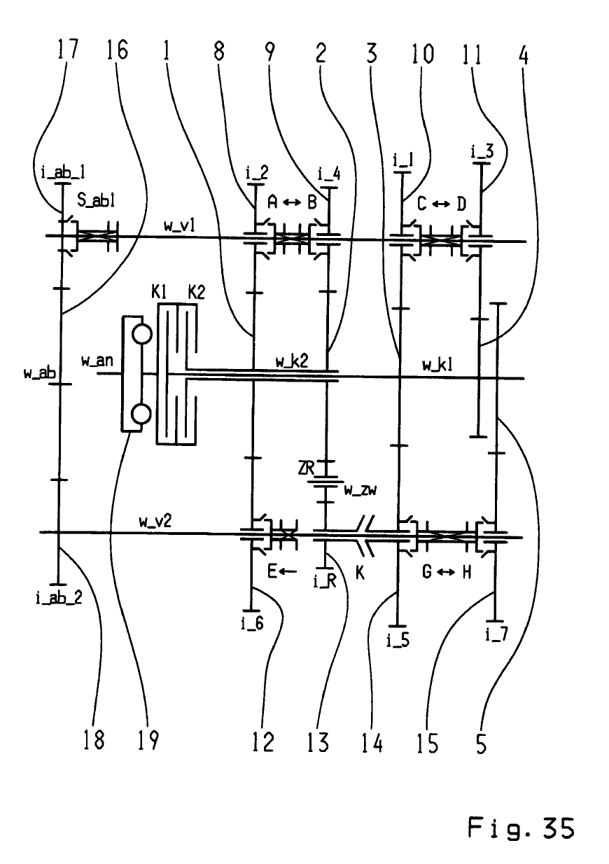

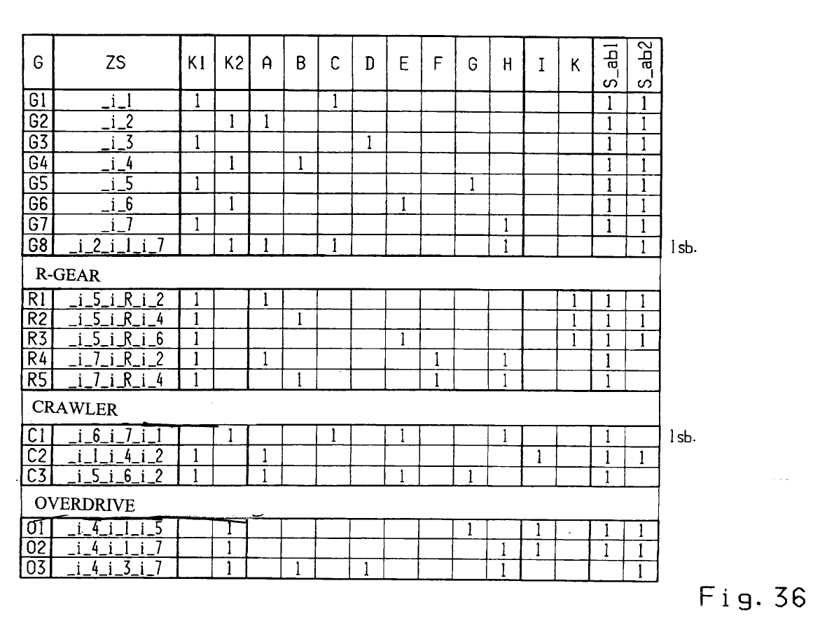

An example shift diagram for the 18^{th} variant of the embodiment of the eight-gear double clutch transmission depicted in FIG. 35 is illustrated in the table shown in FIG. 36.

It can be seen from the shift diagram that the first forward gear G1 can be shifted via the first clutch K1 and via the engaged coupling device C, that the second forward gear G2 can be shifted via the second clutch K2 and via the engaged coupling device A, that the third forward gear G3 can be shifted via the first clutch K1 and via the engaged coupling device D, that the fourth forward gear G4 can be shifted via the second clutch K2 and via the engaged coupling device B, that the fifth forward gear G5 can be shifted via the first clutch K1 and via the engaged coupling device G, that the sixth forward gear G6 can be shifted via the second clutch K2 and via the engaged coupling device E, and that the seventh forward gear G7 can be shifted via the first clutch K1 and via the engaged coupling device H, and/or that the eighth forward gear G8 can be shifted via the second clutch K2, via the engaged coupling device A, via the engaged coupling device C, via the engaged coupling device H, as a winding path gear when the coupling device S_ab1 is disengaged. Thus, in this manner, at least the first eight forward gears can be designed to be power shiftable.

Over and above this, in the case of the 18^{th} variant of the embodiment, one reverse gear R1 can be shifted via the first clutch K1 and via the engaged coupling device A, as a winding path gear via the engaged shift element K, and/or one reverse gear R2 can be shifted via the first clutch K1 and via the engaged coupling device B, as a winding path gear via the engaged shift element K, and/or one reverse gear R3 can be shifted via the first clutch K1 and via the engaged coupling device E, as a winding path gear via the engaged shift element K, and/or one reverse gear R4 can be shifted via the first clutch K1, via the engaged coupling device A, via the engaged coupling device F and via the engaged coupling device H, as a winding path gear when the coupling device S_ab2 is disengaged, and/or one reverse gear R5 can be shifted via the first clutch K1, via the engaged coupling device B, via the engaged coupling device F and via the engaged coupling device H, as a winding path gear when the coupling device S_ab2 is disengaged.

In addition, one crawler gear C1 can be shifted via the second clutch K2, via the engaged coupling device C, via the engaged coupling device E and via the engaged coupling device H, as a winding path gear when the coupling device S_ab2 is disengaged, and/or one crawler gear C2 can be shifted via the first clutch K1 and via the engaged coupling device A, as a winding path gear via the engaged shift element I, and/or one crawler gear C3 can be shifted via the first clutch K1, via the engaged coupling device A, via the engaged coupling device E and via the engaged coupling device G, as a winding path gear when the coupling device S_ab2 is disengaged.

Furthermore, one overdrive gear O1 can be shifted via the second clutch K2 and via the engaged coupling device G, as a winding path gear via the engaged shift element I, and/or one overdrive gear O2 can be shifted via the second clutch K2 and via the engaged coupling device H, as a winding path gear via the engaged shift element I, and/or one overdrive gear O3 can be shifted via the second clutch K2, via the engaged coupling device B, via the engaged coupling device D and via the engaged coupling device H, as a winding path gear when the coupling device S_ab1 is disengaged.

The crawler gear C1 can be made power shiftable to the first forward gear in a beneficial way (C1 power shiftable to G1).

It can be seen from the shift diagram illustrated in FIG. 2 that for the first forward gear G1 the gear stages i_3, i_4 and i_2 based on the first clutch K1 are used, and the shift element K is engaged to couple both the subtransmissions. For the second forward gear G2 the gear stage i_2 is used, for the third forward gear G3 the gear stage i_3 is used, for the fourth forward gear G4 the gear stage i_4 is used, for the fifth forward gear G5 the gear stage i_5 is used, for the sixth forward gear G6 the gear stage i_6 is used, and for the seventh forward gear G7 the gear stage i_7 is used. In the case of the eighth forward gear G8, starting from the second clutch K2, the gear stages or gear steps ZW_8, i_7 and i_5 are used, and both the subtransmissions are coupled in the first variant of the embodiment via the shift element I.

In addition, for the reverse gear R1, the gear stages i_6, i_R and i_3 based on the second clutch K2 are used, and both the subtransmissions are coupled to one another when the coupling device S_ab1 is disengaged. Furthermore, with the next reverse gear R2, the gear stages i_6, i_R and i_5 based on the second clutch K2 are used, whereby the coupling device S_ab1 is disengaged in order to couple both the subtransmissions. In the case of the overdrive gear O1, the gear stages i_4, i_3 and i_7 based on the second clutch K2 are used, whereby both the subtransmissions are coupled via the engaged shift element K. In the case of the overdrive gear O2, the gear stages i_5, i_2 and i_6 based on the first clutch K1 are used, and both the subtransmissions are coupled when the coupling device S_ab2 is disengaged.

It can be seen from the shift diagram illustrated in FIG. 4 that for the first forward gear G1, starting from the first clutch K1, the gear stages i_3, i_4 and i_2 are used, and both the subtransmissions get coupled to one another via the shift element K. The gear stage i_2 is used for the second forward gear G2, the gear stage i_3 is used for the third forward gear G3, the gear stage i_4 is used for the fourth forward gear G4, the gear stage i_5 is used for the fifth forward gear G5, the gear stage i_6 is used for the sixth forward gear G6 and the gear stage i_7 is used for the seventh forward gear G7. In the case of the eighth forward gear G8, the gear stages i_5, i_2 and i_4 are used based on the first clutch K1, whereby the shift element I is engaged to couple both the subtransmissions. In addition, the gear stages i_R, i_7 and i_3 based on the second clutch K2 are used for the reverse gear R1, and the coupling device, S_ab1, is disengaged to couple both the subtransmissions. Furthermore, the gear stages i_3, i_6 and i_R based on the first clutch K1 are used for the next reverse gear R2, whereby both the subtransmissions are coupled when the coupling device S_ab2 is disengaged. The gear stage x8 based on the first clutch K1 is used for the reverse gear R3. The gear stages i_2, i_5 and i_3 based on the second clutch K2 are used for the crawler gear C1, and both the subtransmissions are coupled via the engaged shift element I. The gear stages i_2, i_7 and i_3 based on the second clutch K2 are used for the crawler gear C2, and the coupling device S_ab1 is disengaged to couple both the subtransmissions. The gear stages i_3, i_6 and i_2 based on the first clutch K1 are used for the crawler gear C3, and the coupling device S_ab2 is disengaged to couple both the subtransmissions. In the case of the overdrive gear O1, the gear stages i_4, i_3 and i_7 based on the second clutch K2 are used, and both the subtransmissions are coupled via the engaged shift element K. The gear stages i_6, i_3 and i_5 based on the second clutch K2 are used for the overdrive gear O2, and the coupling device S_ab2 is disengaged to couple both the subtransmissions. The gear stages i_6, i_3 and i_7 based on the second clutch K2 are used for the overdrive gear O3, and the coupling device S_ab2 is disengaged to couple both the subtransmissions. In the case of the overdrive gear O4, the gear stages i_5, i_2 and i_6 based on the first clutch K1 are used, and the shift element I is engaged to couple both the subtransmissions. The gear stages i_7, i_2 and i_6 based on the first clutch K1 are used for the overdrive gear O5, whereby the coupling device S_ab1 is disengaged to couple both the subtransmissions. The gear stages i_7, i_2 and i_4 based on the first clutch K1 are used for the overdrive gear O6, and the coupling device S_ab1 is disengaged to couple both the subtransmissions.

It can be seen from the shift diagram illustrated in FIG. 6 that for the first forward gear G1, the gear stages i_3, i_4 and i_2 are used based on the first clutch K1, and both the subtransmissions get coupled to one another via the shift element I. The gear stage i_2 is used for the second forward gear G2, the gear stage i_3 is used for the third forward gear G3, the gear stage i_4 is used for the fourth forward gear G4, the gear stage i_5 is used for the fifth forward gear G5, the gear stage i_6 is used for the sixth forward gear G6, and the gear stage i_7 is used for the seventh forward gear G7. The gear stages i_3, i_2 and i_6 based on the first clutch K1 are used for the eighth forward G8, whereby the coupling device S_ab1 is disengaged to couple both the subtransmissions. In addition, the gear stages i_7, i_R and i_2 based on the first clutch K1 are used for the reverse gear R1, and both the subtransmissions are coupled via the engaged shift element K. In the case of the reverse gear R2, the gear stages i_6, x_8 and i_3 based on the second clutch K2 are used, and both the subtransmissions are coupled to one another when the coupling device S_ab2 is disengaged for the reverse gear R2. In the case of the reverse gear R3, the gear stages i_6, x_8 and i_5 based on the second clutch K2 are used, and both the subtransmissions are coupled to one another when the coupling device S_ab2 is disengaged. Furthermore, in the case of the overdrive gear O1, the gear stages i_4, i_3 and i_7 based on the second clutch K2 are used, whereby both the subtransmissions are coupled to one another via the engaged shift element I. In the case of the overdrive gear O2, the gear stages i_5, i_2 and i_6 based on the first clutch K1 are used, and both the subtransmissions are coupled when the coupling device S_ab1 is disengaged.

It can be seen from the shift diagram illustrated in FIG. 8 that the gear stages i_3, i_4 and i_2 based on the first clutch K1 are used for the first forward gear G1, whereby both the subtransmissions get coupled via the shift element I. The gear stage i_2 is used for the second forward gear G2, the gear stage i_3 is used for the third forward gear G3, the gear stage i_4 is used for the fourth forward gear G4, the gear stage i_5 is used for the fifth forward gear G5, the gear stage i_6 is used for the sixth forward gear G6 and the gear stage i_7 is used for the seventh forward gear G7. The gear stages ZW_8, i_6 and i_4 based on the first clutch K1 are used for the eighth forward gear G8, and both the subtransmissions are coupled via the engaged shift element I. In addition, the gear stages i_R, ZW_8 and i_3 based on the second clutch K2 are used for the reverse gear R1, whereby both the subtransmissions are coupled when the coupling device, S_ab1, is disengaged. In the case of the next reverse gear R2, the gear stages i_R, ZW_8 and i_5 based on the second clutch K2 are used, and both the subtransmissions are coupled when the coupling device S_ab1 is disengaged. The next reverse gear R3 uses the gear stages i_R, i_7 and i_3 based on the second clutch K2, and both the subtransmissions are coupled when the coupling device S_ab1 is disengaged. In addition, in the case of the overdrive gear O1, the gear stages i_4, i_3 and i_7 based on the second clutch K2 are used, whereby both the subtransmissions are coupled to one another via the shift element K. In the case of the overdrive gear O2, the gear stages i_5, i_2 and i_6 based on the first clutch K1 are used, and both the subtransmissions are coupled when the coupling device S_ab2 is disengaged.

It can be seen from the shift diagram illustrated in FIG. 10 that the gear stages i_5, i_6 and i_2 based on the first clutch K1 are used for the first forward gear G1, and both the subtransmissions are coupled via the engaged shift element I. The gear stage i_2 is used for the second forward gear G2, the gear stage i_3 is used for the third forward gear G3, the gear stage i_4 is used for the fourth forward gear G4, the gear stage i_5 is used for the fifth forward gear G5, the gear stage i_6 is used for the sixth forward gear G6 and the gear stage i_7 is used for the seventh forward gear G7. The gear stages i_5, i_2 and i_4 based on the first clutch K1 are used for the eighth forward gear G8, and both the subtransmissions are coupled when the coupling device S_ab1 is disengaged. In addition, the gear stages i_7, i_R and i_2 based on the first clutch K1 are used for the reverse gear R1, whereby both the subtransmissions are coupled via the engaged shift element K. The gear stages x_8, i_R and i_2 based on the first clutch K1 are used for the next reverse gear R2, and both the subtransmissions are coupled when the coupling device, S_ab2, is disengaged. In the case of the crawler gear C1, the gear stages i_4, i_7 and i_3 based on the second clutch K2 are used, and both the subtransmissions are coupled to one another when the coupling device S_ab2 is disengaged. In the case of the overdrive gear O1, the gear stages i_6, i_5 and i_7 based on the second clutch K2 are used, and both the subtransmissions are coupled with one another via the shift element I. In addition, for the overdrive gear O2, the gear stages i_6, i_3 and i_7 based on the second clutch K2 are used, and both the subtransmissions are coupled to one another when the coupling device S_ab1 is disengaged. Finally, in the case of the overdrive gear O3, the gear stages i_7, i_4 and 16 based on the first clutch K1 are used, and both the subtransmissions are coupled to one another when the coupling device S_ab2 is disengaged.

It can be seen from the shift diagram illustrated in FIG. 12 that the gear stage i_1 based on the first clutch K1 is used for the first forward gear G1. The gear stage i_2 is used for the second forward gear G2, the gear stage i_3 is used for the third forward gear G3, the gear stage i_4 is used for the fourth forward gear G4, the gear stage i_5 is used for the fifth forward gear G5, the gear stage i_6 is used for the sixth forward gear G6 and the gear stage i_7 is used for the seventh forward gear G7. The gear stages i_5, i_2 and i_4 based on the first clutch K1 are used for the eighth forward gear G8, and both the subtransmissions are coupled when the coupling device S_ab1 is disengaged. In addition, the gear stages i_R, i_5 and i_1 based on the second clutch K2 are used for the reverse gear R1, and both the subtransmissions are coupled via the engaged shift element I. The gear stages i_R, i_5 and i_3 based on the second clutch K2 are used for the next reverse gear R2, and both the subtransmissions are coupled when the shift element I is engaged. In the case of the reverse gear R3, the gear stages i_3, i_6 and i_R based on the first clutch K1 are used, and both the subtransmissions are coupled to one another when the coupling device S_ab2 is disengaged. In the case of the crawler gear C1, the gear stages i_6, i_7 and i_1 based on the second clutch K2 are used, and both the subtransmissions are coupled to one another when the shift element K is engaged. In the case of the crawler gear C2, the gear stages i_2, i_5 and i_3 based on the second clutch K2 are used, and both the subtransmissions are coupled to one another when the coupling device S_ab1 is disengaged. In the case of the crawler gear C3, the gear stages i_4, i_7 and i_1 based on the second clutch K2 are used, and both the subtransmissions are coupled to one another when the coupling device S_ab2 is disengaged. In the case of the crawler gear C4, the gear stages i_3, i_4 and i_2 based on the first clutch K1 are used, and both the subtransmissions are coupled to one another when the coupling device, S_ab2, is disengaged. In the case of the crawler gear C5, the gear stages i_3, i_6 and i_2 based on the first clutch K1 are used, and both the subtransmissions are coupled to one another when the coupling device S_ab2 is disengaged. In the case of the overdrive gear O1, the gear stages i_2, i_1 and i_7 based on the second clutch K2 are used, whereby both the subtransmissions are coupled to one another when the coupling device S_ab1 is disengaged. In addition, for the overdrive gear O2, the gear stages i_6, i_3 and i_5 based on the second clutch K2 are used, and both the subtransmissions are coupled to one another when the coupling device S_ab2 is disengaged. Finally, in the case of the overdrive gear O3, the gear stages i_5, i_2 and i_6 based on the first clutch K1 are used, and both the subtransmissions are coupled to one another when the coupling device S_ab1 is disengaged.

It can be seen from the shift diagram illustrated in FIG. 14 that for the first forward gear G1, the gear stages i_3, i_4 and i_2 are used based on the first clutch K1, and both the subtransmissions get coupled to one another via the shift element I. The gear stage i_2 is used for the second forward gear G2, the gear stage i_3 is used for the third forward gear G3, the gear stage i_4 is used for the fourth forward gear G4, the gear stage i_5 is used for the fifth forward gear G5, the gear stage i_6 is used for the sixth forward gear G6 and the gear stage i_7 is used for the seventh forward gear G7. The gear stage i_8 based on the first clutch K1 is used for the eighth forward gear G8. In addition, the gear stages i_3, i_R and i_6 based on the first clutch K1 are used for the reverse gear R1, and the subtransmissions are coupled when the coupling device S_ab1 is disengaged. The gear stages i_3, i_R and i_2 based on the first clutch K1 are used for the next reverse gear R2, and the subtransmissions are coupled when the coupling device S_ab1 is disengaged. The gear stages i_8, i_R and i_2 based on the first clutch K1 are used for the reverse gear R3, and the subtransmissions are coupled when the coupling device S_ab1 is disengaged. In the case of the crawler gear C1, the gear stages i_2, i_7 and i_3 based on the second clutch K2 are used, and both the subtransmissions are coupled to one another when the shift element K is engaged. The gear stages i_2, i_7 and i_5 based on the second clutch K2 are used for the crawler gear C2, and both the subtransmissions are coupled to one another when the shift element K is engaged. In the case of the crawler gear C3, the gear stages i_2, i_5 and i_3 based on the second clutch K2 are used, and both the subtransmissions are coupled to one another when the coupling device S_ab2 is disengaged. The gear stages i_4, i_3 and i_8 based on the second clutch K2 are used for the overdrive gear O1, whereby both the subtransmissions are coupled to one another when the shift element I is engaged. In addition, the gear stages i_4, i_3 and i_7 based on the second clutch K2 are used for the overdrive gear O2, and both the subtransmissions are coupled to one another when the shift element I is engaged. The gear stages i_6, i_5 and i_8 based on the second clutch K2 are used for the overdrive gear O3, and the subtransmissions are coupled to one another when the coupling device S_ab2 is disengaged. In the case of the overdrive gear O4, the gear stages i_7, i_2 and i_4 based on the first clutch K1 are used, and the subtransmissions are coupled to one another via the engaged shift element K. In the case of the overdrive gear O5, the gear stages i_7, i_2 and i_6 based on the first clutch K1 are used, and the subtransmissions are coupled to one another via the engaged shift element K. The gear stages i_8, i_4 and i_6 based on the first clutch K1 are used for the overdrive gear O6, and the subtransmissions are coupled to one another when the coupling device S_ab1 is disengaged.

It can be seen from the shift diagram illustrated in FIG. 16 that for the first forward gear G1, the gear stages i_3, i_4 and i_2 are used based on the first clutch K1, and both the subtransmissions get coupled to one another via the shift element I. The gear stage i_2 is used for the second forward gear G2, the gear stage i_3 is used for the third forward gear G3, the gear stage i_4 is used for the fourth forward gear G4, the gear stage i_5 is used for the fifth forward gear G5, the gear stage i_6 is used for the sixth forward gear G6 and the gear stage i_7 is used for the seventh forward gear G7. In the case of the eighth forward gear G8, based on the second clutch K2, the gear stages i_2, ZW_8 and i_7 are used, and both the subtransmissions are coupled to one another when the coupling device S_ab1 is disengaged. In addition, the gear stages i_R, i_5 and ZW_8 based on the second clutch K2 are used for the reverse gear R1, and the subtransmissions are coupled when the coupling device S_ab2 is disengaged. The gear stages i_R, i_7 and i_3 based on the first clutch K2 are used for the next reverse gear R2, and the subtransmissions are coupled when the coupling device S_ab2 is disengaged. The gear stages i_R, i_7 and ZW_8 based on the second clutch K2 are used for the reverse gear R3, and the subtransmissions are coupled when the coupling device S_ab2 is disengaged. The gear stages ZW_8, i_4 and i_R based on the first clutch K1 are used for the reverse gear R4, and the subtransmissions are coupled when the coupling device S_ab1 is disengaged. The gear stages i_4, i_3 and i_7 based on the second clutch K2 are used for the overdrive gear O1, and both the subtransmissions are coupled to one another when the shift element I is engaged. In addition, the gear stages i_6, i_5 and i_7 based on the second clutch K2 are used for the overdrive gear O2, and both the subtransmissions are coupled to one another when the shift element K is engaged.

It can be seen from the shift diagram illustrated in FIG. 18 that for the first forward gear G1, the gear stages i_3, i_4 and i_2 are used based on the first clutch K1, and both the subtransmissions get coupled to one another via the engaged shift element I. The gear stage i_2 is used for the second forward gear G2, the gear stage i_3 is used for the third forward gear G3, the gear stage i_4 is used for the fourth forward gear G4, the gear stage i_5 is used for the fifth forward gear G5, the gear stage i_6 is used for the sixth forward gear G6 and the gear stage i_7 is used for the seventh forward gear G7. The gear stages i_3, i_4 and ZW_8 based on the first clutch K1 are used for the eighth forward gear G8, and both the subtransmissions are coupled when the shift element I is engaged. In addition, the gear stages i_4, i_R and i_5 based on the second clutch K2 are used for the reverse gear R1, and the subtransmissions are coupled when the coupling device S_ab1 is disengaged. In the case of the next reverse gear R2, based on the first clutch K1, the gear stages i_R, ZW_8 and i_2 are used, and the subtransmissions are coupled when the coupling device S_ab1 is disengaged. In the case of the crawler gear C1, the gear stages i_2, i_7 and i_3 based on the second clutch K2 are used, and both the subtransmissions are coupled to one another when the shift element K is engaged. The gear stages i_2, i_7 and i_5 based on the second clutch K2 are used for the crawler gear C2, and both the subtransmissions are coupled to one another when the shift element K is engaged. In the case of the crawler gear C3, the gear stages i_2, i_5 and i_3 based on the second clutch K2 are used, and both the subtransmissions are coupled to one another when the coupling device S_ab2 is disengaged. The gear stages i_4, i_3 and i_7 based on the second clutch K2 are used for the overdrive gear O1, and both the subtransmissions are coupled to one another when the shift element I is engaged. In addition, the gear stages i_7, i_2 and i_4 based on the first clutch K1 are used for the overdrive gear O2, and both the subtransmissions are coupled to one another when the shift element K is engaged. Moreover, the gear stages i_7, i_2 and i_6 based on the first clutch K1 are used for the overdrive gear O3, and both the subtransmissions are coupled to one another when the shift element K is engaged.

It can be seen from the shift diagram illustrated in FIG. 20 that the gear stage i_1 based on the first clutch K1 is used for the first forward gear G1. The gear stage i_2 is used for the second forward gear G2, the gear stage i_3 is used for the third forward gear G3, the gear stage i_4 is used for the fourth forward gear G4, the gear stage i_5 is used for the fifth forward gear G5, the gear stage i_6 is used for the sixth forward gear G6 and the gear stage i_7 is used for the seventh forward gear G7. The gear stages i_5, i_2 and i_4 based on the first clutch K1 are used for the eighth forward gear G8, and both the subtransmissions are coupled when the coupling device S_ab1 is disengaged. In addition, the gear stages i_R, i_5 and i_3 based on the second clutch K2 are used for the reverse gear R1, whereby the subtransmissions are coupled when the coupling device S_ab1 is disengaged. The gear stages i_1, i_R and i_2 based on the first clutch K1 are used for the next reverse gear R2, and the subtransmissions are coupled when the switch element I is engaged. In the case of the reverse gear R3, the gear stages i_3, i_6 and i_R based on the first clutch K1 are used, and both the subtransmissions are coupled to one another when the shift element K is engaged. In the case of the crawler gear C1, the gear stages i_2, i_5 and i_3 based on the second clutch K2 are used, and both the subtransmissions are coupled to one another when the coupling device S_ab1 is disengaged. In the case of the crawler gear C2, the gear stages i_4, i_7 and i_1 based on the second clutch K2 are used, and both the subtransmissions are coupled to one another when the coupling device S_ab2 is disengaged. In the case of the crawler gear C3, the gear stages i_6, i_7 and i_1 based on the second clutch K2 are used, and both the subtransmissions are coupled to one another when the coupling device S_ab2 is disengaged. The gear stages i_3, i_6 and i_2 based on the first clutch K1 are used for the crawler gear C4, and both the subtransmissions are coupled to one another when the shift element K is engaged. In the case of the crawler gear C5, the gear stages i_3, i_4 and i_2 based on the first clutch K1 are used, and both the subtransmissions are coupled to one another when the coupling device S_ab2 is disengaged. The gear stages i_6, i_3 and i_5 based on the second clutch K2 are used for the overdrive gear O1, and both the subtransmissions are coupled to one another when the shift element K is engaged. In addition, the gear stages i_6, i_3 and i_7 based on the second clutch K2 are used for the overdrive gear O2, and both the subtransmissions are coupled to one another when the shift element K is engaged. In the case of the overdrive gear O3, the gear stages i_2, i_1 and i_7 based on the second clutch K2 are used, and both the subtransmissions are coupled to one another when the coupling device S_ab1 is disengaged. The gear stages i_5, i_2 and i_6 based on the first clutch K1 are used for the overdrive gear O4, and both the subtransmissions are coupled to one another when the coupling device S_ab1 is disengaged.

The shift diagram according to FIG. 22 shows in detail that the gear stage i_1 is used for the first forward gear G1 based on the first clutch K1. For the second forward gear G2, the gear stage i_2 is used; for the third forward gear G3, the gear stage i_3; for the fourth forward gear G4, the gear stage i_4; for the fifth forward gear G5, the gear stage i_5, for the sixth forward gear G6, the gear stage i_6 and for the seventh forward gear G7, the gear stage i_7 is used. For the eighth forward gear G8, the gear stages i_2, i_1 and i_7 are used based on the second clutch K2, and the subtransmissions are coupled with opened coupling device S_ab1. In addition, for the reverse gear R1, the gear stages i_R, i_7 and i_1 are used based on the second clutch K2, and the subtransmissions are coupled with activated shift element K. For the additional reverse gear R2, the gear stages i_R, i_7 and i_3 are used based on the second clutch K2, and the subtransmissions are coupled with activated shift element K. For the reverse gear R3, the gear stages i_R, i_3 and i_1 are used based on the second clutch K2, and the two subtransmissions are coupled together with opened coupling device S_ab2. For the reverse gear R4, the gear stages i_1, i_4 and i_R are used based on the first clutch K1, and the two subtransmissions are coupled together with opened coupling device S_ab1. For the reverse gear R5, the gear stages i_3, i_R and i_2 are used based on the first clutch K1, and the two subtransmissions are coupled together with opened coupling device S_ab2. For the crawler gear C1, the gear stages i_2, i_5 and i_1 are used based on the second clutch K2, and the two subtransmissions are coupled together with activated shift element I. For the crawler gear C2, the gear stages i_2, i_5 and i_3 are used based on the second clutch K2, and the two subtransmissions are coupled together with activated shift element I. For the crawler gear C3, the gear stages i_6, i_7 and i_1 are used based on the second clutch K2, and the two subtransmissions are coupled together with opened coupling device S_ab2. For the crawler gear C4, the gear stages i_3, i_6 and i_4 are used based on the first clutch K1, and the two subtransmissions are coupled together with opened coupling device S_ab2. For the crawler gear C5, the gear stages i_3, i_6 and i_2 are used based on the first clutch K1, and the two subtransmissions are coupled together with opened coupling device S_ab2. For the overdrive gear O1, the gear stages i_4, i_1 and i_7 are used based on the second clutch K2, and the two subtransmissions are coupled together with opened coupling device S_ab1. In addition, for the overdrive gear O2, the gear stages i_6, i_3 and i_5 are used based on the second clutch K2, and the two subtransmissions are coupled together with opened coupling device S_ab2. For the overdrive gear O3, the gear stages i_5, i_2 and i_6 are used based on the first clutch K1, and the subtransmissions are coupled together with activated shift element I.

The shift diagram according to FIG. 24 shows in detail that for the first forward gear G1, the gear stages i_3, i_4 and i_2 are used based on the first clutch K1, and the two subtransmissions are coupled together with opened coupling device S_ab1. For the second forward gear G2, the gear stage i_2 is used; for the third forward gear G3, the gear stage i_3; for the fourth forward gear G4, the gear stage i_4; for the fifth forward gear G5, the gear stage i_5, for the sixth forward gear G6, the gear stage i_6 and for the seventh forward gear G7, the gear stage i_7 is used. For the eighth forward gear G8, the gear stage i_8 is used based on the first clutch K1. In addition, for the reverse gear R1, the gear stages i_8, i_R and i_2 are used based on the first clutch K1, and the subtransmissions are coupled with opened coupling device S_ab1. For the additional reverse gear R2, the gear stages i_3, i_R and i_6 are used based on the first clutch K1, and the subtransmissions are coupled with opened coupling device S_ab1. For the reverse gear R3, the gear stages i_3, i_R and i_2 are used based on the first clutch K1, and the subtransmissions are coupled with opened coupling device S_ab1. For the crawler gear C1, the gear stages i_4, i_8 and i_3 are used based on the second clutch K2, and the two subtransmissions are coupled together with activated shift element I. For the crawler gear C2, the gear stages i_2, i_5 and i_3 are used based on the second clutch K2, and the two subtransmissions are coupled together with activated shift element K. For the crawler gear C3, the gear stages i_2, i_7 and i_3 are used based on the second clutch K2, and the two subtransmissions are coupled together with opened coupling device S_ab2. For the overdrive gear O1, the gear stages i_4, i_3 and i_7 are used based on the second clutch K2, and the two subtransmissions are coupled together with opened coupling device S_ab1. In addition, for the overdrive gear O2, the gear stages i_6, i_5 and i_8 are used based on the second clutch K2, and the two subtransmissions are coupled together with opened coupling device S_ab2. In addition, for the overdrive gear O3, the gear stages i_8, i_4 and i_6 are used based on the first clutch K1, and the two subtransmissions are coupled together with activated shift element I. For the overdrive gear O4, the gear stages i_5, i_2 and i_6 are used based on the first clutch K1, and the two subtransmissions are coupled together with activated shift element K. For the overdrive gear O5, the gear stages i_7, i_2 and i_4 are used based on the first clutch K1, and the two subtransmissions are coupled together with opened coupling device S_ab2.

The shift diagram according to FIG. 26 shows in detail that for the first forward gear G1, the gear stages i_5, i_6 and i_2 are used based on the first clutch K1, and the subtransmissions are coupled with opened coupling device S_ab1. For the second forward gear G2, the gear stage i_2 is used; for the third forward gear G3, the gear stage i_3; for the fourth forward gear G4, the gear stage i_4; for the fifth forward gear G5, the gear stage i_5, for the sixth forward gear G6, the gear stage i_6 and for the seventh forward gear G7, the gear stage i_7 is used. For the eighth forward gear G8, the gear stages ZW_8, i_6 and i_4 are used based on the first clutch K1, and the subtransmissions are coupled with opened coupling device S_ab1. In addition, for the reverse gear R1, the gear stages i_R, ZW_8 and i_3 are used based on the second clutch K2, and the subtransmissions are coupled with opened coupling device S_ab1. For the additional reverse gear R2, the gear stages i_R, ZW_8 and i_7 are used based on the second clutch K2, and the subtransmissions are coupled with opened coupling device S_ab1. For the crawler gear C1, the gear stages i_2, i_7 and i_5 are used based on the second clutch K2, whereas the two subtransmissions are coupled together with opened coupling device S_ab2. For the overdrive gear O1, the gear stages i_6, i_5 and i_7 are used based on the second clutch K2, and the two subtransmissions are coupled together with opened coupling device S_ab1. In addition, for the overdrive gear O2, the gear stages i_7, i_4 and i_6 are used based on the first clutch K1, and the two subtransmissions are coupled together with opened coupling device S_ab2. Finally, for the overdrive gear O3, the gear stages i_7, i_2 and i_6 are used based on the first clutch K1, and the subtransmissions are coupled together with opened coupling device S_ab2.

The shift diagram according to FIG. 28 shows in detail that for the first forward gear G1, the gear stages i_5, i_6 and i_2 are used based on the first clutch K1, and the subtransmissions are coupled with opened coupling device S_ab1. For the second forward gear G2, the gear stage i_2 is used; for the third forward gear G3, the gear stage i_3; for the fourth forward gear G4, the gear stage i_4; for the fifth forward gear G5, the gear stage i_5, for the sixth forward gear G6, the gear stage i_6 and for the seventh forward gear G7, the gear stage i_7 is used. For the eighth forward gear G8, the gear stages i_3, i_2 and i_6 are used based on the first clutch K1, and the subtransmissions are coupled with activated shift element K. In addition, for the reverse gear R1, the gear stages i_6, i_R and i_3 are used based on the second clutch K2, and the subtransmissions are coupled with opened coupling device S_ab1. For the additional reverse gear R2, the gear stages i_4, i_R and i_3 are used based on the second clutch K2, and the subtransmissions are coupled with opened coupling device S_ab1. For the reverse gear R3, the gear stages i_4, i_R and i_7 are used based on the second clutch K2, and the subtransmissions are coupled with opened coupling device S_ab1. For the crawler gear C1, the gear stages i_2, i_7 and i_5 are used based on the second clutch K2, and the two subtransmissions are coupled together with opened coupling device S_ab2. For the overdrive gear O1, the gear stages i_6, i_5 and i_7 are used based on the second clutch K2, and the two subtransmissions are coupled together with opened coupling device S_ab1. In addition, for the overdrive gear O2, the gear stages i_5, i_4 and i_6 are used based on the first clutch K1, and the two subtransmissions are coupled together with activated shift element I. For the overdrive gear O3, the gear stages i_7, i_2 and i_6 are used based on the first clutch K1, and the subtransmissions are coupled together with opened coupling device S_ab2. For the overdrive gear O4, the gear stages i_7, i_2 and i_4 are used based on the first clutch K1, and the subtransmissions are coupled together with opened coupling device S_ab2.

The shift diagram according to FIG. 30 shows in detail that for the first forward gear G1, the gear stages i_3, i_4 and i_2 are used based on the first clutch K1, and the subtransmissions are coupled with activated shift element K. For the second forward gear G2, the gear stage i_2 is used; for the third forward gear G3, the gear stage i_3; for the fourth forward gear G4, the gear stage i_4; for the fifth forward gear G5, the gear stage i_5, for the sixth forward gear G6, the gear stage i_6 and for the seventh forward gear G7, the gear stage i_7 is used. For the eighth forward gear G8, the gear stage i_8 is used based on the first clutch K1. In addition, for the reverse gear R1, the gear stages i_R, i_8 and i_3 are used based on the second clutch K2, and the subtransmissions are coupled with opened coupling device S_ab1. For the crawler gear C1, the gear stages i_2, i_7 and i_5 are used based on the second clutch K2, and the two subtransmissions are coupled together with opened coupling device S_ab2. For the overdrive gear O1, the gear stages i_4, i_3 and i_8 are used based on the second clutch K2, and the two subtransmissions are coupled together with activated shift element K. In addition, for the overdrive gear O2, the gear stages i_4, i_3 and i_7 are used based on the second clutch K2, and the two subtransmissions are coupled together with activated shift element K. For the overdrive gear O3, the gear stages i_6, i_5 and i_7 are used based on the second clutch K2, and the subtransmissions are coupled together with opened coupling device S_ab1. For the overdrive gear O4, the gear stages i_7, i_2 and i_6 are used based on the first clutch K1, and the subtransmissions are coupled together with opened coupling device S_ab2. For the overdrive gear O5, the gear stages i_7, i_4 and i_6 are used based on the first clutch K1, and the subtransmissions are coupled together with opened coupling device S_ab2.

The shift diagram according to FIG. 32 shows in detail that for the first forward gear G1, the gear stages i_3, i_4 and i_2 are used based on the first clutch K1, and the subtransmissions are coupled with opened coupling device S_ab1. For the second forward gear G2, the gear stage i_2 is used; for the third forward gear G3, the gear stage i_3; for the fourth forward gear G4, the gear stage i_4; for the fifth forward gear G5, the gear stage i_5, for the sixth forward gear G6, the gear stage i_6 and for the seventh forward gear G7, the gear stage i_7 is used. For the eighth forward gear G8, the gear stages i_5, i_2 and i_4 are used based on the first clutch K1, and the two subtransmissions are coupled together with activated shift element K. In addition, for the reverse gear R1, the gear stages i_3, i_R and i_6 are used based on the first clutch K1, and the subtransmissions are coupled with opened coupling device S_ab1. For the reverse gear R2, the gear stages i_3, i_R and i_2 are used based on the first clutch K1, and the subtransmissions are coupled with opened coupling device S_ab1. For the reverse gear R3, the gear stages i_4, x_3 and i_3 are used based on the second clutch K2, and the subtransmissions are coupled with activated shift element I. For the reverse gear R4, the gear stages i_4, x_3 and i_5 are used based on the second clutch K2, and the subtransmissions are coupled with activated shift element I. For the reverse gear R5, the gear stages i_4, x_3 and i_7 are used based on the second clutch K2, and the subtransmissions are coupled with activated shift element I. For the reverse gear R6, the gear stage x_3 is used based on the first clutch K1. For the crawler gear C1, the gear stages i_2, i_5 and i_3 are used based on the second clutch K2, and the two subtransmissions are coupled together with activated shift element K. For the crawler gear C2, the gear stages i_2, i_7 and i_3 are used based on the second clutch K2, and the two subtransmissions are coupled together with opened coupling device S_ab2. For the overdrive gear O1, the gear stages i_4, i_3 and i_7 are used based on the second clutch K2, and the two subtransmissions are coupled together with opened coupling device S_ab1. In addition, for the overdrive gear O2, the gear stages i_5, i_2 and i_6 are used based on the first clutch K1, and the two subtransmissions are coupled together with activated shift element K. For the overdrive gear O3, the gear stages i_7, i_6 and i_4 are used based on the first clutch K1, and the subtransmissions are coupled together with opened coupling device S_ab2.

The shift diagram according to FIG. 34 shows in detail that for the first forward gear G1, the gear stages i_3, i_4 and i_2 are used based on the first clutch K1, and the subtransmissions are coupled with opened coupling device S_ab1. For the second forward gear G2, the gear stage i_2 is used; for the third forward gear G3, the gear stage i_3; for the fourth forward gear G4, the gear stage i_4; for the fifth forward gear G5, the gear stage i_5, for the sixth forward gear G6, the gear stage i_6 and for the seventh forward gear G7, the gear stage i_7 is used. For the eighth forward gear G8, the gear stages i_7, ZW_8 and i_6 are used based on the first clutch K1, and the two subtransmissions are coupled together with activated shift element K. In addition, for the reverse gear R1, the gear stages i_6, i_R and i_3 are used based on the second clutch K2, and the subtransmissions are coupled with activated shift element I. For the reverse gear R2, the gear stages i_6, i_R and i_5 are used based on the second clutch K2, and the subtransmissions are coupled with activated shift element I. For the reverse gear R3, the gear stages i_4, i_R and i_7 are used based on the second clutch K2, and the subtransmissions are coupled with opened coupling device S_ab1. For the reverse gear R4, the gear stages i_4, i_R and i_5 are used based on the second clutch K2, and the subtransmissions are coupled with opened coupling device S_ab1. For the crawler gear C1, the gear stages i_2, i_7 and i_3 are used based on the second clutch K2, and the two subtransmissions are coupled together with opened coupling device S_ab2. For the crawler gear C2, the gear stages i_2, i_5 and i_3 are used based on the second clutch K2, and the two subtransmissions are coupled together with opened coupling device S_ab2. For the crawler gear C3, the gear stages i_3, i_6 and i_2 are used based on the second clutch K2, and the two subtransmissions are coupled together with opened coupling device S_ab1. For the overdrive gear O1, the gear stages i_4, i_3 and i_7 are used based on the second clutch K2, and the two subtransmissions are coupled together with opened coupling device S_ab1. For the overdrive gear O2, the gear stages i_6, i_3 and i_7 are used based on the second clutch K2, and the two subtransmissions are coupled together with opened coupling device S_ab1. For the overdrive gear O3, the gear stages i_6, i_3 and i_5 are used based on the second clutch K2, and the two subtransmissions are coupled together with opened coupling device S_ab1. For the overdrive gear O4, the gear stages i_7, i_2 and i_4 are used based on the first clutch K1, and the subtransmissions are coupled together with opened coupling device S_ab2. For the overdrive gear O5, the gear stages i_7, i_2 and i_6 are used based on the first clutch K1, and the subtransmissions are coupled together with opened coupling device S_ab2. For the overdrive gear O6, the gear stages i_5, i_2 and i_6 are used based on the first clutch K1, and the subtransmissions are coupled together with opened coupling device S_ab2.

The shift diagram according to FIG. 36 shows in detail that the gear stage i_1 is used for the first forward gear G1 based on the first clutch K1. For the second forward gear G2, the gear stage i_2 is used; for the third forward gear G3, the gear stage i_3; for the fourth forward gear G4, the gear stage i_4; for the fifth forward gear G5, the gear stage i_5, for the sixth forward gear G6, the gear stage i_6 and for the seventh forward gear G7, the gear stage i_7 is used. For the eighth forward gear G8, the gear stages i_2, i_1 and i_7 are used based on the second clutch K2, and the two subtransmissions are coupled together with opened coupling device S_ab1. In addition, for the reverse gear R1, the gear stages i_5, i_R and i_2 are used based on the first clutch K1, and the subtransmissions are coupled with activated shift element K. For the reverse gear R2, the gear stages i_5, i_R and i_4 are used based on the first clutch K1, and the subtransmissions are coupled with activated shift element K. For the reverse gear R3, the gear stages i_5, i_R and i_6 are used based on the first clutch K1, and the subtransmissions are coupled with activated shift element K. For the reverse gear R4, the gear stages i_7, i_R and i_2 are used based on the first clutch K1, and the subtransmissions are coupled with opened coupling device S_ab2. For the reverse gear R5, the gear stages i_7, i_R and i_4 are used based on the first clutch K1, and the subtransmissions are coupled with opened coupling device S_ab2. For the crawler gear C1, the gear stages i_6, i_7 and i_1 are used based on the second clutch K2, and the two subtransmissions are coupled together with opened coupling device S_ab2. For the crawler gear C2, the gear stages i_1, i_4 and i_2 are used based on the first clutch K1, and the two subtransmissions are coupled together with activated shift element I. For the crawler gear C3, the gear stages i_5, i_6 and i_2 are used based on the first clutch K1, and the two subtransmissions are coupled together with opened coupling device S_ab2. For the overdrive gear O1, the gear stages i_4, i_1 and i_5 are used based on the second clutch K2, and the two subtransmissions are coupled together with activated shift element I. For the overdrive gear O2, the gear stages i_4, i_1 and i_7 are used based on the second clutch K2, and the two subtransmissions are coupled together with activated shift element I. For the overdrive gear O3, the gear stages i_4, i_3 and i_7 are used based on the second clutch K2, and the two subtransmissions are coupled together with opened coupling device S_ab1.

In summary, in the 1^{st} to 5^{th} embodiment variants according to FIGS. 1 to 10 with a winding path gear coupling device S_ab1 and with the winding path gear shift elements I and K, there is a winding path gear in the first forward gear via the gear stages i_3, i_4, and i_2, whereas the eighth forward gear is not power-shiftable.

The 1^{st} embodiment variant has three dual gear planes and two single gear planes. In addition, there is an additional overdrive gear O1 power-shiftable to the seventh forward gear as an alternative power-shiftable eighth forward gear, which can save fuel.

Specifically, in the first embodiment variant, the idler gear 8 is used for a forward gear G6, O2 and for two reverse gears R1, R2, and the idler gear 12 is used for three forward gears G1, G2, O2 in the first gear plane 8-12 designed as a dual gear plane. On the second gear plane 9-13 designed as a dual gear plane, the idler gear 9 is used for a forward gear G8 and the idler gear 13 is used for three forward gears G1, G4, O1. On the third gear plane 10-3 designed as a single gear plane, the idler gear 10 is used for three forward gears G7, G8, O1. On the fourth gear plane 4-14 designed as a single gear plane, the idler gear 14 is used for three forward gears G1, G3, O1 as well as for one reverse gear R1. On the fifth gear plane 11-15 designed as a dual gear plane, the idler gear 11 is used for two reverse gears R1, R2 and the idler gear 15 is used for three forward gears G5, G8, O2 as well as one reverse gear R2.

In summary, in the 2^{nd} embodiment variant according to FIGS. 3 and 4 with one dual gear plane and five single gear planes, there are three crawler gears C1, C2, C3 for improved off-road driving characteristics.

Specifically, in the second embodiment variant, the idler gear 8 is used for two reverse gears R1, R2 and the idler gear 12 is used for six forward gears G6, C3, O2, O3, O4, O5 as well as for one reverse gear R2 on the first gear plane 8-12 designed as a gear plane. On the second gear plane 9-2 designed as a single gear plane, the idler gear 9 is used for nine forward gears G1, G2, G8, C1, C2, C3, O4, O5, O6 as well as for one reverse gear R2. On the third gear plane 3-13 designed as a single gear plane, the idler gear 13 is used for five forward gears G1, G4, G8, O1, O6. On the fourth gear plane 10-4 designed as a single gear plane, the idler gear 10 is used for five forward gears G5, G8, C1, O2, O4. On the fifth gear plane 5-14 designed as a single gear plane, the idler gear 14 is used for eight forward gears G1, G3, C1, C2, C3, O1, O2, O3 as well as for two reverse gears R1, R2. On the sixth gear plane 11-6 designed as a single gear plane, the idler gear 11 is used for six forward gears G7, C2, O1, O3, O5, O6 as well as for one reverse gear R1.

In summary, in the third embodiment variant according to FIGS. 5 and 6 with two dual gear planes and three single gear planes, there is one reverse gear R1 power-shiftable to the second forward gear, which enables rocking free.

Specifically, in the third embodiment variant, the idler gear 8 is used for four forward gears G1, G2, G8, O2 as well as for one reverse gear R1 and the idler gear 12 is used for three forward gears G6, G8, O2 as well as for two reverse gears R2, R3 on the first gear plane 8-12 designed as a dual gear plane. On the second gear plane 9-13 designed as a dual gear plane, the idler gear 9 is used for three forward gears G1, G4, O1 as well as one reverse gear R3 and the idler gear 13 is used for one reverse gear R1. On the third gear plane 10-3 designed as a single gear plane, the idler gear 10 is used for four forward gears G1, G3, G8, O1 as well as for one reverse gear R2. On the fourth gear plane 4-14 designed as a single gear plane, the idler gear 14 is used for two forward gears G7, O1 as well as for one reverse gear R1. On the fifth gear plane 11-5 designed as a single gear plane, the idler gear 11 is used for two forward gears G5, O2 as well as for one reverse gear R3.

In summary, for the fourth embodiment variant according to FIGS. 7 and 8 with two dual gear planes and four single gear planes there are three alternative reverse gears.

Specifically, in the fourth embodiment variant, the idler gear 8 is used for three reverse gears R1, R2, R3 and the idler gear 12 is used for three forward gears G1, G2, O2 on the first gear plane 8-12 designed as a dual gear plane. On the second gear plane 9-13 designed as a dual gear plane, the idler gear 9 is used for three forward gears G6, G8, O2 and the idler gear 13 is used for four forward gears G1, G4, G8, O1. On the third gear plane 10-3 designed as a single gear plane, the idler gear 10 is used for one forward gear G8 as well as for two reverse gears R1, R2. On the fourth gear plane 4-14 designed as a single gear plane, the idler gear 14 is used for three forward gears G1, G3, O3 as well as for two reverse gears R1, R3. On the fifth gear plane 11-5 designed as a single gear plane, the idler gear 11 is used for two forward gears G7, O1 as well as for one reverse gear R3. On the sixth gear plane 6-15 designed as a single gear plane, the idler gear 15 is used for two forward gears G5, O2 as well as for one reverse gear R2.

In summary, in the fifth embodiment variant according to FIGS. 9 and 10 there is a first forward gear as winding path gear via the gear stages i_5, i_6 and i_2. With the three dual gear planes and the one single gear plane, there are two additional overdrive gears O1, O2 power-shiftable to the seventh forward gear as alternative power-shiftable eighth forward gears, which saves fuel.

Specifically, in the 5^{th} embodiment variant, the idler gear 8 is used for three forward gears G1, G2, G8 as well as for two reverse gears R1, R2 and the idler gear 12 is used for four forward gears G4, G8, C1, O3 on the first gear plane 8-12 designed as a dual gear plane. On the second gear plane 9-13 designed as a dual gear plane, the idler gear 9 is used for five forward gears G1, G6, O1, O2, O3 and the idler gear 13 is used for two reverse gears R1, R2. On the third gear plane 10-14 designed as a dual gear plane, the idler gear 10 is used for four forward gears G1, G5, G8, O1 and the idler gear 14 is used for five forward gears G7, C1, O1, O2, O3 as well as for one reverse gear R1. On the third gear plane 11-4 designed as a single gear plane, the idler gear 11 is used for three forward gears G3, C1, O2.

In summary, in the 6^{th}, 7^{th}, 8^{th} and 9^{th} embodiment variants according to the FIGS. 11-18, there is a winding path gear coupling device S_ab1 and a winding path gear shift element I as well as three dual gear planes and two single gear planes.

In the 6^{th} embodiment variant, there is a reverse gear R1 power-shiftable to the first forward gear, which enables rocking free. In addition, there can be an additional overdrive gear O1 power-shiftable to the seventh forward gear as an alternative power-shiftable eighth forward gear, to save fuel.

Specifically, in the 6^{th} embodiment variant, the idler gear 8 is used for seven forward gears G2, G8, C2, C4, C5, O2, O3 and the idler gear 12 is used for four forward gears G4, G8, C3, C4 on the first gear plane 8-12 designed as a dual gear plane. In the second gear plane 9-13 designed as a dual gear plane, the idler gear 9 is used for three reverse gears R1, R2, R3 and the idler gear 13 is used for five forward gears G6, C1, C5, O2, O3 as well as for one reverse gear R3. In the third gear plane 10-3 designed as a single gear plane, the idler gear 10 is used for five forward gear G5, G8, C2, O2, O3 as well as for two reverse gears R1, R2. In the fourth gear plane 4-14 designed as a single gear plane, the idler gear 14 is used for four forward gears G7, C1, C3, O1 as well as for two reverse gears R2, R3. In the fifth gear plane 11-15 designed as a dual gear plane, the idler gear 11 is used for four forward gears G1, C1, C3, O1 as well as for one reverse gear R1 and the idler gear 15 is used for five forward gears G3, C2, C4, C5, O2 as well as for two reverse gears R2, R3.

In the 7^{th} embodiment variant, there is an eighth forward gear that is not wound and not power-shiftable, whereas there can be a power-shiftable, additional overdrive gear O1, O3 to the eighth forward gear as alternative power-shiftable ninth forward gear, with which fuel savings can be realized.

Specifically, in the 7^{th} embodiment variant, the idler gear 8 is used for three reverse gears R1, R2, R3 and the idler gear 12 is used for four forward gears G6, O3, O5, O6 as well as one reverse gear R1 on the first gear plane 8-12 designed as a dual gear plane. In the second gear plane 9-13 designed as a dual gear plane, the idler gear 9 is used for six forward gears G1, G4, O1, O2, O4, O6 and the idler gear 13 is used for seven forward gears G1, G2, C1, C2, C3, O4, O5 as well as for two reverse gears R2, R3. In the third gear plane 10-3 designed as a single gear plane, the idler gear 10 is used for six forward gears G1, G3, C1, C3, O1, O2 as well as for two reverse gears R1, R2. In the fourth gear plane 4-14 designed as a single gear plane, the idler gear 14 is used for six forward gears G7, C1, C2, O2, O4, O5. In the fifth gear plane 11-15 designed as a dual gear plane, the idler gear 11 is used for four forward gears G8, O1, O3, O6 as well as for one reverse gear R3 and the idler gear 15 is used for four forward gears G5, C2, C3, O3.

In the 8^{th} embodiment variant not only is the first gear a winding path gear but also the eighth gear, and the eighth gear can also be executed as power-shiftable. In addition, there can be two additional overdrive gears O1, O2 power-shiftable to the seventh gear as alternative power-shiftable eighth gears, which can save fuel.

Specifically, in the 8^{th} embodiment variant, the idler gear 8 is used for two forward gears G1, G8 and the idler gear 12 is used for four reverse gears R1, R2, R3, R4 on the first gear plane 8-12 designed as a dual gear plane. In the second gear plane 9-13 designed as a dual gear plane, the idler gear 9 is used for three forward gears G1, G4, O1 as well as for one reverse gear R4 and the idler gear 13 is used for two forward gears G6, O2. In the third gear plane 10-14 designed as a dual gear plane, the idler gear 10 is used for three forward gears G1, G3, O1 as well as for one reverse gear R2 and the idler gear 14 is used for two forward gears G5, O2 as well as for one reverse gear R1. In the third gear plane 11-4 designed as a single gear plane, the idler gear 11 is used for one forward gear G8 as well as for three reverse gears R1, R3, R4. In the fourth gear plane 5-15 designed as a single gear plane, the idler gear 15 is used for four forward gears G7, G8, O1, O2 as well as for two reverse gears R2, R3.

In the 9^{th} embodiment variant, the first forward gear and the eighth forward gear are winding path gears, and the eighth forward gear is not power-shiftable. In addition, there is a reverse gear R2 that is power-shiftable to the second forward gear, which enables rocking free.

Specifically, in the 9^{th} embodiment variant, the idler gear 8 is used for one forward gear G8 as well as for one reverse gear R2 and the idler gear 12 is used for two forward gears G6, O3 on the first gear plane 8-12 designed as a dual gear plane. In the second gear plane 9-13 designed as a dual gear plane, the idler gear 9 is used for five forward gears G1, G4, G8, O1, O2 as well as for one reverse gear R1 and the idler gear 13 is used for seven forward gears G1, G2, C1, C2, C3, O2, O3 as well as for one reverse gear R2. In the third gear plane 10-3 designed as a single gear plane, the idler gear 10 is used for six forward gears G1, G3, G8, C1, C3, O1. In the fourth gear plane 4-14 designed as a single gear plane, the idler gear 14 is used for six forward gears G7, C1, C2, O1, O2, O3. In the fifth gear plane 11-15 designed as a dual gear plane, the idler gear 11 is used for a two reverse gears R1, R2 and the idler gear 15 is used for three forward gears G5, C2, C3 as well as for one reverse gear R1.

In summary, in the 10^{th}, 11^{th}, 12^{th} and 13^{th} embodiment variants according to the FIGS. 19 to 26, there is only a winding path gear coupling device S_ab1 without an additional winding path gear shift element, whereas three dual gear planes and two single wheel planes are realized.

In the 10^{th} embodiment variant, there is an unwound first forward gear. In addition, there are two additional overdrive gears O2, O3 power-shiftable to the seventh forward gear as alternative eighth forward gears to save fuel.

Specifically, in the 10^{th} embodiment variant, the idler gear 8 is used for seven forward gears G2, G8, C1, C4, C5, O3, O4 as well as one reverse gear R2 and the idler gear 12 is used for four forward gears G4, G8, C2, C5 in the first gear plane 8-12 designed as a dual gear plane. In the second gear plane 9-13 designed as a dual gear plane, the idler gear 9 is used for three reverse gears R1, R2, R3 and the idler gear 13 is used for six forward gears G6, C3, C4, O1, O3, O4 as well as one reverse gear R3. In the third gear plane 10-14 designed as a dual gear plane, the idler gear 10 is used for four forward gears G1, C2, C3, O3 as well as for one reverse gear R2 and the idler gear 14 is used for six forward gears G3, C1, C4, C5, O1, O2 as well as for two reverse gears R1, R3. In the fourth gear plane 11-4 designed as a single gear plane, the idler gear 11 is used for four forward gears G5, C1, O1, O4 as well as for one reverse gear R1. In the fifth gear plane 5-15 designed as a single gear plane, the idler gear 15 is used for five forward gears G7, C2, C3, O2, O3.

In the 11^{th} embodiment variant there is a non-winding first forward gear and a power-shiftable eighth forward gear as winding path gear. In addition, there is an additional overdrive gear O1 power-shiftable to the seventh forward gear as an alternative power-shiftable eighth forward gear to save fuel.

Specifically, in the 11^{th} embodiment variant according to FIG. 21, the idler gear 8 is used for three forward gears G4, C4, O1 as well as for one reverse gear R4 and the idler gear 12 is used for six forward gears G6, C3, C4, C5, O2, O3 in the first gear plane 8-12 designed as a dual gear plane. In the second gear plane 9-13 designed as a dual gear plane, the idler gear 9 is used for six forward gears G2, G8, C1, C2, C5, O3 as well as for one reverse gear R5 and the idler gear 13 is used for five reverse gears R1, R2, R3, R4, R5. In the third gear plane 10-3 designed as a single gear plane, the idler gear 10 is used for five forward gears G5, C1, C2, O2, O3. In the fourth gear plane 4-14 designed as a single gear plane, the idler gear 14 is used for four forward gears G7, G8, C3, O1 as well as for two reverse gears R1, R2. In the fifth gear plane 11-15 designed as a dual gear plane, the idler gear 11 is used for five forward gears G1, G8, C1, C3, O1 as well as for three reverse gears R1, R3, R4 and the idler gear 15 is used for five forward gears G3, C2, C4, C5, O2 as well as for three reverse gears R2, R3, R5.

In the 12^{th} embodiment variant according to FIG. 23, there are a first power-shiftable winding path gear as first forward gear and two reverse gears R1, R3 power-shiftable to the second forward gear, which enables rocking free.

Specifically, in the 12^{th} embodiment variant, the idler gear 8 is used for three reverse gears R1, R2, R3 and the idler gear 12 is used for four forward gears G6, O2, O3, O4 as well as for one reverse gear R2 in the first gear plane 8-12 designed as a dual gear plane. In the second gear plane 9-13 designed as a dual gear plane, the idler gear 9 is used for six forward gears G1, G4, C1, O1, O3, O5 and the idler gear 13 is used for six forward gears G1, G2, C2, C3, O4, O5 as well as for two reverse gears R1, R3. In the third gear plane 10-14 designed as a dual gear plane, the idler gear 10 is used for four forward gears G8, C1, O2, O3 as well as for one reverse gear R1 and the idler gear 14 is used for four forward gears G5, C2, O2, O4. In the fourth gear plane 11-4 designed as a single gear plane, the idler gear 11 is used for six forward gears G1, G3, C1, C2, C3, O1 as well as for two reverse gears R2, R3. In the fifth gear plane 5-15 designed as a single gear plane, the idler gear 15 is used for four forward gears G7, C3, O1, O5.

In the 13^{th} embodiment variant there are four dual gear planes, with the first forward gear and the eighth forward gear being executable as winding path gears. In addition, there can be an additional overdrive gear O1 power-shiftable to the seventh forward gear as an alternative power-shiftable eighth forward gear to save fuel. Also, two reverse gears R1, R2 can be shifted.

Specifically, in the 13^{th} embodiment variant, the idler gear 8 is used for six forward gears G1, G6, G8, O1, O2, O3 and the idler gear 12 is used for three forward gears G4, G8, O2 at the first gear plane 8-12 designed as a dual gear plane. In the second gear plane 9-13 designed as a dual gear plane, the idler gear 9 is used for a two reverse gears R1, R2 and the idler gear 13 is used for four forward gears G1, G2, C1, O3. In the third gear plane 10-14 designed as a dual gear plane, the idler gear 10 is used for four forward gears G1, G5, C1, O1 and the idler gear 14 is used for one forward gears G3 as well as for one reverse gear R1. In the fourth gear plane 11-15 designed as a dual gear plane, the idler gear 11 is used for one forward gear G8 as well as for two reverse gears R1, R2 and the idler gear 15 is used for five forward gears G7, C1, O1, O2, O3 as well as for one reverse gear R2.

In summary, in the 14^{th}, 15^{th}, 16^{th}, 17^{th} and 18^{th} embodiment variants according to FIGS. 27 to 36, there is a winding path gear coupling device S_ab1 with a winding path gear shift element K.

In the 14^{th} embodiment variant according to FIG. 27, there are also three dual gear planes and one single gear plane, the first forward gear and the eighth forward gear each are executable as winding path gears. In addition, there is an additional overdrive gear O1 power-shiftable to the seventh forward gear as an alternative power-shiftable eighth forward gear to save fuel. In addition, the gear set can be manufactured with very minimal construction costs due to its simple design.

Specifically, in the 14^{th} embodiment variant, the idler gear 8 is used for six forward gears G1, G6, G8, O1, O2, O3 as well as for one reverse gear R1 in the first gear plane 8-1 designed as a single gear plane. In the second gear plane 9-13 designed as a dual gear plane, the idler gear 9 is used for a three forward gears G4, O2, O4 as well as for two reverse gears R2, R3 and the idler gear 13 is used for six forward gears G1, G2, G8, C1, O3, O4. In the third gear plane 10-14 designed as a dual gear plane, the idler gear 10 is used for five forward gears G1, G5, C1, O1, O2 and the idler gear 14 is used for two forward gears G3, G8 as well as for two reverse gears R1, R2. In the fourth gear plane 11-15 designed as a dual gear plane, the idler gear 11 is used for three reverse gears R1, R2, R3 and the idler gear 15 is used for five forward gears G7, C1, O1, O3, O4 as well as for one reverse gear R3.

In the 15^{th} embodiment variant according to FIG. 29, there is a dual gear plane and six single gear planes, whereas a winding path gear is the first forward gear. In addition, an additional overdrive O1 power-shiftable to the eighth forward gear as an alternative power-shiftable ninth gear and two additional overdrive gears O2, O3 power-shiftable to the seventh forward gear as alternative power-shiftable eighth forward gears are enabled for fuel savings.

Specifically, in the 15^{th} embodiment variant, the idler gear 8 is used for one reverse gear R1 and the idler gear 12 is used for four forward gears G1, G2, C1, O4 in the first gear plane 8-12 designed as a dual gear plane. In the second gear plane 9-2 designed as a single gear plane, the idler gear 9 is used for four forward gears G6, O3, O4, O5. In the third gear plane 3-13 designed as a single gear plane, the idler gear 13 is used for five forward gears G1, G4, O1, O2, O5. In the fourth gear plane 10-4 designed as a single gear plane, the idler gear 10 is used for two forward gears G8, O1 as well as for one reverse gear R1. In the fifth gear plane 5-14 designed as a single gear plane, the idler gear 14 is used for four forward gears G1, G3, O1, O2 as well as for one reverse gear R1. In the sixth gear plane 11-6 designed as a single gear plane, the idler gear 11 is used for three forward gears G5, C1, O3. In the seventh gear plane 7-15 designed as a single gear plane, the idler gear 15 is used for six forward gears G7, C1, O2, O3, O4, O5.

The 16^{th} embodiment variant according to FIG. 31 has two dual gear planes and three single gear planes. The first and the eighth forward gears are executable as winding path gears. In addition, there is a reverse gear R2 that is power-shiftable to the second forward gear, which enables rocking free. There is an additional overdrive gear O1 power-shiftable to the seventh forward gear as an alternative power-shiftable eighth forward gear, to save fuel.

Specifically, in the 16^{th} embodiment variant, the idler gear 8 is used for two reverse gears R1, R2 and the idler gear 12 is used for three forward gears G6, O2, O3 as well as for one reverse gear R1 in the first gear plane 8-12 designed as a dual gear plane. In the second gear plane 9-13 designed as a dual gear plane, the idler gear 9 is used for five forward gears G1, G4, G8, O1, O3 as well as for three reverse gears R3, R4, R5 and the idler gear 13 is used for six forward gears G1, C2, G2, G8, C1, C2, O2 as well as for one reverse gear R2. In the third gear plane 4-14 designed as a single gear plane, the idler gear 14 is used for four forward gears G5, G8, C1, O2 as well as for one reverse gear R4. In the fourth gear plane 11-5 designed as a single gear plane, the idler gear 11 is used for five forward gears G1, G3, C1, C2, O1 as well as for three reverse gears R1, R2, R3. In the fifth gear plane 6-15 designed as a single gear plane, the idler gear 15 is used for four forward gears G7, C2, O1, O3 as well as for one reverse gear R5.

In the 17^{th} embodiment variant according to FIG. 33, there are two dual gear planes and four single gear planes, the first forward gear and the eighth forward gear are each executable as winding path gears. In addition, there are two overdrive gears O1, O2 power-shiftable to the seventh forward gear as alternative power-shiftable eighth forward gears to save fuel. Also, there is a crawler gear power-shiftable to the second forward gear C3 as an alternative first forward gear for improved off-road driving characteristics.

Specifically, in the 17^{th} embodiment variant, the idler gear 8 is used for four forward gears G1, G4, O1, O4 as well as for two reverse gears R3, R4 and the idler gear 12 is used for eight forward gears G1, G2, C1, C2, C3, O4, O5, O6 in the first gear plane 8-12 designed as a dual gear plane. In the second gear plane 9-2 designed as a single gear plane, the idler gear 9 is used for seven forward gears G6, G8, C3, O2, O3, O5, O6 as well as for two reverse gears R1, R2. In the third gear plane 3-13 designed as a single gear plane, the idler gear 13 is used for one forward gear G8. In the fourth gear plane 10-14 designed as a dual gear plane, the idler gear 10 is used for four reverse gears R1, R2, R3, R4 and the idler gear 14 is used for seven forward gears G7, G8, C1, O1, O2, O4, O5 as well as one reverse gear R3. In the fifth gear plane 11-5 designed as a single gear plane, the idler gear 11 is used for eight forward gears G1, G3, C1, C2, C3, O1, O2, O3 as well as for one reverse gear R1. In the sixth gear plane 6-15 designed as a single gear plane, the idler gear 15 is used for four forward gears G5, C2, O3, O6 as well as for two reverse gears R2, R4.

In the 18^{th} embodiment variant according to FIG. 35, there are three dual gear planes and two single gear planes as well as a power-shiftable eighth forward gear designed as winding path gear. In addition, there is a reverse gear R1 that is power-shiftable to the second forward gear, which enables rocking free.

Specifically, in the 18^{th} embodiment variant, the idler gear 8 is used for four forward gears G2, G8, C2, C3 as well as for two reverse gears R1, R4 and the idler gear 12 is used for three forward gears G6, C1, C3 as well as for a reverse gear R3 in the first gear plane 8-12 designed as a dual gear plane. It the second gear plane 9-13 designed as a dual gear plane, the idler gear 9 is used for five forward gears G4, C2, O1, O2, O3 as well as for two reverse gears R2, R5 and the idler gear 13 is used for five reverse gears R1, R2, R3, R4, R5. In the third gear plane 10-14 designed as a dual gear plane, the idler gear 10 is used for six forward gears G1, G8, C1, C2, O1, O2 and the idler gear 14 is used for three forward gears G5, C3, O1 as well as for three reverse gears R1, R2, R3. In the fourth gear plane 11-4 as single gear plane, the idler gear 11 is used for two forward gears G3, O3. In the fifth gear plane 5-15 as single gear plane, the idler gear 15 is used for five forward gears G7, G8, C1, O2, O3 as well as for two reverse gears R4, R5.

It is possible that at least one additional gear stage ZW_x (e.g. ZW_8) is used for winding path gears in one or several embodiment variants that is not used in a direct forward gear. The use of an additional gear stage can be found in the respective figures of the embodiment variants.

Gears x1, x2, . . . x7, x8 can also be used for additional winding path gears that can be added to a single gear plane, whereas the numbering of the gears x1, x2, . . . x7, x8 proceeds as follows. The numbering begins with the first gear x1 of the first countershaft w_v1 based on the allocated output stage i_ab_1 continuing up to the fourth gear x4, whereas the first gear on the second countershaft w_v2 based on the allocated output stage i_ab_2 is labeled x5 and the other gears continue to x8. If the additional gear x1, x2, . . . x7, x8 is used in the scope of a reverse gear, a reversal of rotation must take place, for example through the use of an intermediate gear ZR on an intermediate shaft w_zw or similar.

In all embodiment variants of the double clutch transmission, fewer gear planes and therefore fewer components are required for the same number of gears due to the multiple use of individual idler gears so that there is a beneficial savings in design space and costs.

Independent of the respective embodiment variant, the number “1” in a field of the respective shift diagram according to FIGS. 2, 4, 6, 8, 10, 12, 14, 16, 18, 20, 22, 24, 26, 28, 30, 32, 34, 36 means that the associated clutch K1, K2, the associated coupling device A, B, C, D, E, F, G, H or the associated shift element I, K is engaged or activated. In contrast, an empty field in the respective shfit diagram according to FIGS. 2, 4, 6, 8, 10, 12, 14, 16, 18, 20, 22, 24, 26, 28, 30, 32, 34, and 36 means that the associated clutch K1, K2 or the associated coupling device A, B, C, D, E, F, G, H or the associated shift element I, K is opened.

For the coupling device S_ab1 or S_ab2 allocated to an output gear 17 or 18, the following applies, deviating from the previously stated rules: with an empty field in the respective shift diagram according to FIGS. 2, 4, 6, 8, 10, 12, 14, 16, 18, 20, 22, 24, 26, 28, 30, 32, 34, and 36, the coupling device S_ab1 or S_ab2 must be opened and with a field with a number “1” in the respective shift diagram according to FIGS. 2, 4, 6, 8, 10, 12, 14, 16, 18, 20, 22, 24, 26, 28, 30, 32, 34, and 36, the coupling device S_ab1 or S_ab2 should be engaged. Depending on the gear, the coupling element S_ab1 or S_ab2 must be engaged even with a group of gears when the field has a number “1”; in contrast, the coupling element S_ab1 or S_ab2 can be either disengaged or engaged with a different group of gears when the field has a number “1”.

In addition, in many cases it is possible to insert additional coupling or shift elements without influencing the power flow. This can enable a gear pre-selection.

### REFERENCE SIGNS

1 Fixed gear of the second transmission input shaft
2 Fixed gear of the second transmission input shaft
3 Fixed gear of the first or second transmission input shaft
4 Fixed gear of the first transmission input shaft
5 Fixed gear of the first transmission input shaft
6 Fixed gear of the first transmission input shaft
7 Fixed gear of the first transmission input shaft
8 Idler gear of the first countershaft
9 Idler gear of the first countershaft
10 Idler gear of the first countershaft
11 Idler gear of the first countershaft
12 Idler gear of the first countershaft
13 Idler gear of the second countershaft
14 Idler gear of the second countershaft
15 Idler gear of the second countershaft
16 Fixed gear of the output shaft
17 Output gear of the first countershaft
18 Output gear of the second countershaft
19 Torsion vibration damper
K1 First clutch
K2 Second clutch
w_an Drive shaft
w_ab Output shaft
w_v1 First countershaft
w_v2 Second countershaft
w_k1 First transmission input shaft
w_k2 Second transmission input shaft
A Coupling device
B Coupling device
C Coupling device
D Coupling device
E Coupling device
F Coupling device
G Coupling device
H Coupling device
i_1 Gear stage of the first forward gear
i_2 Gear stage of the second forward gear
i_3 Gear stage of the third forward gear
i_4 Gear stage of the fourth forward gear
i_5 Gear stage of the fifth forward gear
i_6 Gear stage of the sixth forward gear
i_7 Gear stage of the seventh forward gear
i_8 Gear stage of the eighth forward gear
ZW_8 Additional gear stage for winding path gears
x3 Gear for additional winding path gears
x8 Gear for additional winding path gears
i_ab_1 Output stage of the first countershaft
i_ab_2 Output stage of the second countershaft
G1 First forward gear
G2 Second forward gear
G3 Third forward gear
G4 Fourth forward gear
G5 Fifth forward gear
G6 Sixth forward gear
G7 Seventh forward gear
G8 Eighth forward gear
   C1 Crawler gear (crawler)
C2 Crawler gear (crawler)
C3 Crawler gear (crawler)
C4 Crawler gear (crawler)
C5 Crawler gear (crawler)
O1 Overdrive gear (overdrive)
O2 Overdrive gear (overdrive)
O3 Overdrive gear (overdrive)
O4 Overdrive gear (overdrive)
O5 Overdrive gear (overdrive)
O6 Overdrive gear (overdrive)
R1 Reverse gear
R2 Reverse gear
R3 Reverse gear
R4 Reverse gear
R5 Reverse gear
R6 Reverse gear
w_zw Intermediate shaft
ZR Intermediate shaft for reversal of rotation
ZS Gear stage used
I Shift element
K Shift element
S_ab1 Optional coupling device on the output stage
S_ab2 Coupling device on the output stage
n. Isb. Not power-shiftable
Isb. Power-shiftable

1-23. (canceled)

24. A double clutch transmission comprising:
first and second clutches (K1, K2) each having an input side connected to a drive shaft (w_an) and an output side connected to one of first and second transmission input shafts (w_k1, w_k2) arranged coaxially with respect to one another;
at least first and second countershafts (w_v1, w_v2) rotatably supporting toothed idler gearwheels (8, 9, 10, 11, 12, 13, 14, 15);
toothed fixed gearwheels (1, 2, 3, 4, 5, 6, 7) being supported on the first and the second transmission input shafts (w_k1, w_k2) in a rotationally fixed manner and engaging at least some of the idler gearwheels (8, 9, 10, 11, 12, 13, 14, 15);
a plurality of coupling devices (A, B, C, D, E, F, G, H) for coupling one of the idler gearwheels (8, 9, 10, 11, 12, 13, 14, 15) to one of the first and the second countershafts (w_v1, w_v2)
a power take-off gearwheel (17, 18) being supported on each of the first and the second countershafts (w_v1, w_v2), and each of the power-take-off gearwheels (17, 18) engaging a gear of an output shaft (w_ab) such that several power-shift forward gears (1, 2, 3, 4, 5, 6, 7) and at least one reverse gear (R1, R2, R3, R4, R5, R6) are shiftable;
a maximum of seven gear planes (8-1, 8-12, 9-2, 9-13, 3-13, 10-3, 4-14, 10-4, 10-14, 11-4, 5-14, 11-5, 11-6, 5-15, 6-15, 11-15) comprising at least one dual gear plane (8-12, 9-13, 10-14, 11-15);
the at least one dual gear plane (8-12, 9-13, 10-14, 11-15) comprising one idler gearwheel (8, 9, 10, 11, 12, 13, 14, 15) of each of the first and the second countershafts (w_v1, w_v2) and one fixed gearwheel (1, 2, 3, 4, 5) of one of the first and the second transmission input shafts (w_k1, w_k2);
at least one of the idler gearwheels (8, 9, 10, 11, 12, 13, 14, 15) in each of the at least one dual gear planes (8-12, 9-13, 10-14, 11-15) being utilized for at least two of the several power-shiftable forward gears (1, 2, 3, 4, 5, 6, 7) and the at least one reverse gear (R1, R2, R3, R4, R5, R6) such that at least one winding path gear is shiftable via a disengaged output coupling device (S_ab1) allocated to the power take-off gear (17) supported on the first countershaft (w_v1).

25. The double clutch transmission according to claim 24, wherein at least one of a first forward gear (G1) and an eighth forward gear (G8) and at least one reverse gear (R1, R2, R3, R4) and one first crawler gear (C1) and at least one overdrive gear (O1, O3, O4) is shifted as a winding path gear by disengagement of the output coupling device (S_ab1) on the first countershaft (w_v1).

26. The double clutch transmission according to claim 24, wherein the first countershaft (w_v1) supports at least one shift element (I), an idler gearwheel (9) of a second subtransmission is connectable to an idler gearwheel (10) of a first subtransmission, via activation of the at least one shift element (I), such that at least one of a first forward gear (G1) and an eighth forward gear (G8) and at least one reverse gear (R1, R2) and at least one overdrive gear (O1, O2) is shiftable as a winding path gear, upon activation of the at least one shift element (I).

27. The double clutch transmission according to claim 24, wherein the second countershaft (w_v2) supports a second shift element (K), an idler gearwheel (13) of a second subtransmission is connectable to an idler gearwheel (14) of a first subtransmission via activation of the second shift element (K) such that either at least one of a first forward gear (G1) and an eighth forward gear (G8) and at least one reverse gear (R1, R2, R3), one first crawler gear (C1) and at least one overdrive gear (O1, O2) are shiftable as a winding path gears, upon activation of the second shift element (K).

28. The double clutch transmission according to claim 24, wherein the first countershaft (w_v1) supports the output coupling device (S_ab1), associated with the power take-off gear (17) on the first countershaft (w_v1), and the at least one shift element (I), and the second countershaft (w_v2) supports a second shift element (K).

29. The double clutch transmission according to claim 28, wherein a first forward gear (G1) is shiftable as a winding path gear via the first clutch (K1) and via activation of a fifth coupling device (E) as well as activation of the second shift element (K);
a second forward gear (G2) is shiftable via activation of a second clutch (K2) and the fifth coupling device (E);
a third forward gear (G3) is shiftable via activation of the first clutch (K1) and an seventh coupling device (G);
a fourth forward gear (G4) is shiftable via activation of the second clutch (K2) and a sixth coupling device (F);
a fifth forward gear (G5) is shiftable via activation of the first clutch (K1) and an activated eighth coupling device (H);
a sixth forward gear (G6) is shiftable via activation of the second clutch (K2) and a first coupling device (A);
a seventh forward gear (G7) is shiftable via activation of the first clutch (K1) and a third coupling device (C); and
an eighth forward gear (G8) is shiftable as a winding path gear via activation of the second clutch (K2) and the activated eighth coupling device (H) as well as activation of the at least one shift element (I); and
a first reverse gear (R1) is shiftable as a winding path gear via activation of the second clutch (K2), the first coupling device (A), the fourth coupling device (D) and the seventh coupling device (G) as well as disengagement of the first output coupling device (S_ab1);
a second reverse gear (R2) is shiftable as a winding path gear via activation of the second clutch (K2), the first coupling device (A), the fourth coupling device (D) and the eighth coupling device (H) as well as disengagement of the first output coupling device (S_ab1); and
a first overdrive gear (O1) is shiftable as a winding path gear via activation of the second clutch (K2) and the third coupling device (C) as well as activation of the second shift element (K);
a second overdrive gear (O2) is shiftable as a winding path gear via activation of the first clutch (K1), the first activated coupling device (A), the fifth coupling device (E) and the eighth coupling device (H) as well as disengagement of a second output coupling device (S_ab2).

30. The double clutch transmission according to claim 24, wherein a first forward gear (G1) is shiftable as a winding path gear via activation of the first clutch (K1) and the second coupling device (B) as well as the second shift element (K);
a second forward gear (G2) is shiftable via activation of the second clutch (K2) and the second coupling device (B);
a third forward gear (G3) is shiftable via activation of the first clutch (K1) and the activated seventh coupling device (G);
a fourth forward gear (G4) is shiftable via activation of the second clutch (K2) and the sixth coupling device (F);
a fifth forward gear (G5) is shiftable via activation of the first clutch (K1) and the third coupling device (C);
a sixth forward gear (G6) is shiftable via activation of the second clutch (K2) and the activated fifth coupling device (E);
a seventh forward gear (G7) is shiftable via activation of the first clutch (K1) and the fourth coupling device (D);
an eighth forward gear (G8) is shiftable as a winding path gear via activation of the first clutch (K1) and the sixth coupling device (F) as well as the at least one first shift element (I);
a first reverse gear (R1) is shiftable via activation of the second clutch (K2), the first coupling device (A), the fourth coupling device (D) and the seventh coupling device (G) as well as disengagement of the first output coupling device (S_ab1);
a second reverse gear (R2) is shiftable as a winding path gear via activation of the first clutch (K1), the first coupling device (A), the fifth coupling device (E) and the seventh coupling device (G) as well as disengagement of a second output coupling device (S_ab2);
a third reverse gear (R3) is shiftable via activation of the first clutch (K1) and the eighth coupling device (H);
a first crawler gear (C1) is shiftable as a winding path gear via activation of the second clutch (K2) and the seventh coupling device (G) as well as the at least one shift element (I);
a second crawler gear (C2) is shiftable as a winding path gear via activation of the second clutch (K2), the second coupling device (B), the fourth coupling device (D) and the seventh coupling device (G) as well as disengagement of the first output coupling device (S_ab1);
a third crawler gear (C3) is shiftable as a winding path gear via activation of the first clutch (K1), the second coupling device (B), the fifth coupling device (E) and the seventh coupling device (G) as well as disengagement of the second output coupling device (S_ab2);
a first overdrive gear (O1) is shiftable as a winding path gear via activation of the second clutch (K2) and the fourth coupling device (D) as well as the second shift element (K);
a second overdrive gear (O2) is shiftable as a winding path gear via activation of the second clutch (K2), the third coupling device (C), the fifth coupling device (E) and the seventh coupling device (G) as well as disengagement of the second output coupling device (S_ab2);
a third overdrive gear (O3) is shiftable as a winding path gear via activation of the second clutch (K2), the fourth coupling device (D), the fifth coupling device (E) and the seventh coupling device (G) as well as disengagement of the second output coupling device (S_ab2);
a fourth overdrive gear (O4) is shiftable as a winding path gear via activation of the first clutch (K1) and the fifth coupling device (E) as well as the at least one shift element (I);
a fifth overdrive gear (O5) is shiftable as a winding path gear via activation of the first clutch (K1), the second coupling device (B), the fourth coupling device (D) and the fifth coupling device (E) as well as disengagement of the first output coupling device (S_ab1); and
a sixth overdrive gear (O6) is shiftable as a winding path gear via activation of the first clutch (K1), the second coupling device (B), the fourth coupling device (D) and the sixth coupling device (F) as well as disengagement of the first output coupling device (S_ab1).

31. The double clutch transmission according to claim 24, wherein a first forward gear (G1) is shiftable as a winding path gear via activation of the first clutch (K1) and the first coupling device (A) as well as the at least one shift element (I);
a second forward gear (G2) is shiftable via activation of the second clutch (K2) and the first coupling device (A);
a third forward gear (G3) is shiftable via activation of the first clutch (K1) and the third coupling device (C);
a fourth forward gear (G4) is shiftable via activation of the second clutch (K2) and the second coupling device (B);
a fifth forward gear (G5) is shiftable via activation of the first clutch (K1) and the fourth coupling device (D);
a sixth forward gear (G6) is shiftable via activation of the second clutch (K2) and the fifth coupling device (E); and
a seventh forward gear (G7) is shiftable via activation of the first clutch (K1) and the seventh coupling device (G);
an eighth forward gear (G8) is shiftable as a winding path gear via activation of the first clutch (K1), the first coupling device (A), the third coupling device (C) and the fifth coupling device (E) as well as with disengagement of the first output coupling device (S_ab1);
a first reverse gear (R1) is shiftable as a winding path gear via activation of the first clutch (K1) and the first coupling device (A) as well as the second shift element (K);
a second reverse gear (R2) is shiftable as a winding path gear via activation of the second clutch (K2), the third coupling device (C), the fifth coupling device (E) and the eighth coupling device (H) as well as disengagement of the second output coupling device (S_ab2);
a third reverse gear (R3) is shiftable as a winding path gear via activation of the second clutch (K2), the fourth coupling device (D), the fifth coupling device (E) and the eighth coupling device (H) as well as disengagement of the second output coupling device (S_ab2);
a first overdrive gear (O1) is shiftable as a winding path gear via activation of the second clutch (K2) and the seventh coupling device (G) as well as the at least one shift element (I);
an overdrive (O2) is shiftable as a winding path gear via activation of the first clutch (K1), the first coupling device (A), the fourth coupling device (D) and the fifth coupling device (E) as well as disengagement of the first output coupling device (S_ab1).

32. The double clutch transmission according to claim 24, wherein a first forward gear (G1) is shiftable as a winding path gear via activation of the first clutch (K1) and the fifth coupling device (E) as well as the second shift element (K);
a second forward gear (G2) is shiftable via activation of the second clutch (K2) and the fifth coupling device (E);
a third forward gear (G3) is shiftable via activation of the first clutch (K1) and the seventh coupling device (G);
a fourth forward gear (G4) is shiftable via activation of the second clutch (K2) and the sixth coupling device (F);
a fifth forward gear (G5) is shiftable via activation of the first clutch (K1) and the eighth coupling device (H);
a sixth forward gear (G6) is shiftable via activation of the second clutch (K2) and the second coupling device (B);
a seventh forward gear (G7) is shiftable via activation of the first clutch (K1) and the fourth coupling device (D);
an eighth forward gear (G8) is shiftable as a winding path gear via activation of the first clutch (K1) and the sixth coupling device (F) as well as the at least one first shift element (I);
a first reverse gear (R1) is shiftable as a winding path gear via activation of the second clutch (K2), the first coupling device (A), the third coupling device (C) and the seventh coupling device (G) as well as disengagement of the first output coupling device (S_ab1);
a second reverse gear (R2) is shiftable as a winding path gear via activation of the second clutch (K2), the first coupling device (A), the third coupling device (C) and the eighth coupling device (H) as well as disengagement of the first output coupling device (S_ab1);
a third reverse gear (R3) is shiftable as a winding path gear via activation of the second clutch (K2), the first coupling device (A), the fourth coupling device (D) and the seventh coupling device (G) as well as disengagement of the first output coupling device (S_ab1);
a first overdrive gear (O1) is shiftable as a winding path gear via activation of the second clutch (K2) and the fourth coupling device (D) as well as the second shift element (K);
a second overdrive gear (O2) is shiftable as a winding path gear via activation of the first clutch (K1), the second coupling device (B), the fifth coupling device (E) and the eighth coupling device (H) as well as disengagement of a second output coupling device (S_ab2).

33. The double clutch transmission according to claim 24, wherein a first forward gear (G1) is shiftable as a winding path gear via activation of the first clutch (K1) and the first coupling device (A) as well as the at least one shift element (I);
a second forward gear (G2) is shiftable via activation of the second clutch (K2) and the first coupling device (A);
a third forward gear (G3) is shiftable via activation of the first clutch (K1) and the fourth coupling device (D);
a fourth forward gear (G4) is shiftable via activation of the second clutch (K2) and the fifth coupling device (E);
a fifth forward gear (G5) is shiftable via activation of the first clutch (K1) and the third coupling device (C);
a sixth forward gear (G6) is shiftable via activation of the second clutch (K2) and the second coupling device (B);
a seventh forward gear (G7) is shiftable via activation of the first clutch (K1) and the seventh coupling device (G);
an eighth forward gear (G8) is shiftable as a winding path gear via activation of the first clutch (K1), the first coupling device (A), the third coupling device (C) and the fifth coupling device (E) as well as disengagement of the first output coupling device (S_ab1);
a first reverse gear (R1) is shiftable as a winding path gear via activation of the first clutch (K1) and the first coupling device (A) as well as the second shift element (K);
a second reverse gear (R2) is shiftable as a winding path gear via activation of the first clutch (K1), the first coupling device (A), the sixth coupling device (F) and the eighth coupling device (H) as well as disengagement of the second output coupling device (S_ab2);
a first crawler gear (C1) is shiftable as a winding path gear via activation of the second clutch (K2), the fourth coupling device (D), the fifth coupling device (E) and the seventh coupling device (G) as well as disengagement of second output coupling device (S_ab2);
a first overdrive gear (O1) is shiftable as a winding path gear via activation of the second clutch (K2) and the seventh coupling device (G) as well as the at least one shift element (I);
a second overdrive gear (O2) is shiftable as a winding path gear via activation of the second clutch (K2), the second coupling device (B), the fourth coupling device (D) and the seventh coupling device (G) as well as disengagement of the first output coupling device (S_ab1);
a third overdrive gear (O3) is shiftable as a winding path gear via activation of the first clutch (K1), the second coupling device (B), the fifth coupling device (E) and the seventh coupling device (G) as well as disengagement of the second output coupling device (S_ab2).

34. The double clutch transmission according to claim 24, wherein a first forward gear (G1) is shiftable via activation of the first clutch (K1) and the fourth coupling device (D);
a second forward gear (G2) is shiftable via activation of the second clutch (K2) and the first coupling device (A);
a third forward gear (G3) is shiftable via activation of the first clutch (K1) and the eighth coupling device (H);
a fourth forward gear (G4) is shiftable via activation of the second clutch (K2) and the fifth coupling device (E);
a fifth forward gear (G5) is shiftable via activation of the first clutch (K1) and the third coupling device (C);
a sixth forward gear (G6) is shiftable via activation of the second clutch (K2) and the sixth coupling device (F);
a seventh forward gear (G7) is shiftable via activation of the first clutch (K1) and the seventh coupling device (G);
an eighth forward gear (G8) is shiftable as a winding path gear via activation of the first clutch (K1) and the first coupling device (A), the third coupling device (C), and the fifth coupling device (E) as well as disengagement of the first output coupling device (S_ab1);
a first reverse gear (R1) is shiftable as a winding path gear via activation of the second clutch (K2), the fourth coupling device (D), as well as the at least one shift element (I);
a second reverse gear (R2) is shiftable as a winding path gear via activation of the second clutch (K2) and the eighth coupling device (H) as well as via the at least one shift element (I);
a third reverse gear (R3) is shiftable as a winding path gear via activation of the first clutch (K1), the second coupling device (B), the sixth coupling device (F) and the eighth coupling device (H) as well as disengagement of the second output coupling device (S_ab2);
a first crawler gear (C1) is shiftable as a winding path gear via activation of the second clutch (K2) and the fourth coupling device (D) as well as the second shift element (K);
a second crawler gear (C2) is shiftable as a winding path gear via activation of the second clutch (K2), the first coupling device (A), the third coupling device (C) and the eighth coupling device (H) as well as disengagement of first output coupling device (S_ab1);
a third crawler gear (C3) is shiftable as a winding path gear via activation of the second clutch (K2), the fourth coupling device (D), the fifth coupling device (E) and the seventh coupling device (G) as well as disengagement of the second output coupling device (S_ab2);
a fourth crawler gear (C4) is shiftable as a winding path gear via activation of the first clutch (K1), the first coupling device (A), the fifth coupling device (E) and the eighth coupling device (H) as well as disengagement of the second output coupling device (S_ab2);
a fifth crawler gear (C5) is shiftable as a winding path gear via activation of the first clutch (K1), the first coupling device (A), the sixth coupling device (F) and the eighth coupling device (H) as well as disengagement of the second output coupling device (S_ab2);
a first overdrive (O1) is shiftable as a winding path gear via activation of the second clutch (K2), the first coupling device (A), the fourth coupling device (D) and the seventh coupling device (G) as well as disengagement of the first output coupling device (S_ab1);
a second overdrive gear (O2) is shiftable as a winding path gear via activation of the second clutch (K2), the third coupling device (C), the sixth coupling device (F) and the eighth coupling device (H) as well as disengagement of the second output coupling device (S_ab2);
a third overdrive gear (O3) is shiftable as a winding path gear via activation of the first clutch (K1), the first coupling device (A), the third coupling device (C) and the sixth coupling device (F) as well as disengagement of the first output coupling device (S_ab1).

35. The double clutch transmission according to claim 24, wherein a first forward gear (G1) is shiftable as a winding path gear via activation of the first clutch (K1) and the sixth coupling device (F) as well as the at least one shift element (I);
a second forward gear (G2) is shiftable via activation of the second clutch (K2) and the sixth coupling device (F);
a third forward gear (G3) is shiftable via activation of the first clutch (K1) and the third coupling device (C);
a fourth forward gear (G4) is shiftable via activation of the second clutch (K2) and the second coupling device (B);
a fifth forward gear (G5) is shiftable via activation of the first clutch (K1) and the eighth coupling device (H);
a sixth forward gear (G6) is shiftable via activation of the second clutch (K2) and the fifth coupling device (E);
a seventh forward gear (G7) is shiftable via activation of the first clutch (K1) and the seventh coupling device (G);
an eighth forward gear (G8) is shiftable as a winding path gear via activation of the first clutch (K1) and the fourth coupling device (D);
a first reverse gear (R1) is shiftable as a winding path gear via activation of the first clutch (K1) and the first coupling device (A), the third coupling device (C) and the fifth coupling device (E) as well as disengagement of the first output coupling device (S_ab1);
a second reverse gear (R2) is shiftable as a winding path gear via activation of the first clutch (K1), the first coupling device (A), the third coupling device (C) and the sixth coupling device (F) as well as disengagement of the first output coupling device (S_ab1);
a third reverse gear (R3) is shiftable as a winding path gear via activation of the first clutch (K1), the first coupling device (A), the fourth coupling device (D) and the sixth coupling device (F) as well as disengagement of the first output coupling device (S_ab1);
a first crawler gear (C1) is shiftable as a winding path gear via activation of the second clutch (K2) and the third coupling device (C) as well as the second shift element (K);
a second crawler gear (C2) is shiftable as a winding path gear via activation of the second clutch (K2) and the eighth coupling device (H) as well as the second shift element (K);
a third crawler gear (C3) is shiftable as a winding path gear via activation of the second clutch (K2), the third coupling device (C), the sixth coupling device (F) and the eighth coupling device (H) as well as disengagement of the second output coupling device (S_ab2);
a first overdrive gear (O1) is shiftable as a winding path gear via activation of the second clutch (K2) and the fourth coupling device (D) as well as the at least one shift element (I);
a second overdrive gear (O2) is shiftable as a winding path gear via activation of the second clutch (K2) and the seventh coupling device (G) as well as the first shift element (I);
a third overdrive gear (O3) is shiftable as a winding path gear via activation of the second clutch (K2), the fourth coupling device (D), the fifth coupling device (E) and the eighth coupling device (H) as well as disengagement of the second output coupling device (S_ab2);
a fourth overdrive gear (O4) is shiftable as a winding path gear via activation of the first clutch (K1) and the second coupling device (B) as well as the second shift element (K);
a fifth overdrive gear (O5) is shiftable as a winding path gear via activation of the first clutch (K1) and the fifth coupling device (E) as well as the second shift element (K);
a sixth overdrive gear (O6) is shiftable as a winding path gear via actuation of the first clutch (K1), the second coupling device (B), the fourth coupling device (D) and the fifth coupling device (E) as well as disengagement of the first output coupling device (S_ab1).

36. The double clutch transmission according to claim 24, wherein a first forward gear (G1) is shiftable via actuation of the first clutch (K1) and the first coupling device (A) as well as the at least one shift element (I);
a second forward gear (G2) is shiftable via actuation of the second clutch (K2) and the first coupling device (A);
a third forward gear (G3) is shiftable via actuation of the first clutch (K1) and the third coupling device (C);
a fourth forward gear (G4) is shiftable via actuation of the second clutch (K2) and the second coupling device (B);
a fifth forward gear (G5) is shiftable via actuation of the first clutch (K1) and the seventh coupling device (G);
a sixth forward gear (G6) is shiftable via actuation of the second clutch (K2) and the sixth coupling device (F);
a seventh forward gear (G7) is shiftable via actuation of the first clutch (K1) and the eighth coupling device (H);
an eighth forward gear (G8) is shiftable as a winding path gear via actuation of the second clutch (K2), the first coupling device (A), the fourth coupling device (D) and the eighth coupling device (H) as well as disengagement of the first output coupling device (S_ab1);
a first reverse gear (R1) is shiftable as a winding path gear via actuation of the second clutch (K2), the fourth coupling (D), the fifth coupling device (E) and the seventh coupling device (G) as well as disengagement of the second coupling device (S_ab2);
a second reverse gear (R2) is shiftable as a winding path gear via actuation of the second clutch (K2), the third coupling device (C), the fifth coupling device (E) and the eighth coupling device (H) as well as disengagement of the second output coupling device (S_ab2);
a third reverse gear (R3) is shiftable as a winding path gear via actuation of the second clutch (K2), the fourth coupling device (D), the fifth coupling device (E) and the eighth coupling device (H) as well as disengagement of the second output coupling device (S_ab2);
a fourth reverse gear (R4) is shiftable as a winding path gear via actuation of the first clutch (K1), the second coupling device (B), the fourth coupling device (D) and the fifth coupling device (E) as well as disengagement of the first output coupling device (S_ab1);
a first overdrive gear (O1) is shiftable as a winding path gear via actuation of the second clutch (K2), the eighth coupling device (H) as well as the at least one shift element (I);
a second overdrive gear (O2) is shiftable as a winding path gear via actuation of the second clutch (K2) and the eighth coupling device (H) as well as the second shift element (K).

37. The double clutch transmission according to claim 24, wherein a first forward gear (G1) is shiftable as a winding path gear via actuation of the first clutch (K1) and the sixth coupling device (F) as well as the at least one shift element (I);
a second forward gear (G2) is shiftable via actuation of the second clutch (K2) and the sixth coupling device (F);
a third forward gear (G3) is shiftable via actuation of the first clutch (K1) and the third coupling device (C);
a fourth forward gear (G4) is shiftable via actuation of the second clutch (K2) and the second coupling device (B);
a fifth forward gear (G5) is shiftable via actuation of the first clutch (K1) and the eighth coupling device (H);
a sixth forward gear (G6) is shiftable via actuation of the second clutch (K2) and the fifth coupling device (E);
a seventh forward gear (G7) is shiftable via actuation of the first clutch (K1) and the seventh coupling device (G);
an eighth forward gear (G8) is shiftable as a winding path gear via actuation of the first clutch (K1) and the first coupling device (A) as well as the at least one shift element (I);
a first reverse gear (R1) is shiftable as a winding path gear via actuation of the second clutch (K2), the second coupling device (B), the fourth coupling device (D) and the eight coupling device (H) as well as disengagement of the first output coupling device (S_ab1);
a second reverse gear (R2) is shiftable as a winding path gear via actuation of the first clutch (K1), the first coupling device (A), the fourth coupling device (D) and the sixth coupling device (F) as well as disengagement of the first output coupling device (S_ab1);
a first crawler gear (C1) is shiftable as a winding path gear via actuation of the second clutch (K2) and the third coupling device (C) as well as the second shift element (K);
a second crawler gear (C2) is shiftable as a winding path gear via actuation of the second clutch (K2) and the eighth coupling device (H) as well as the second shift element (K);
a third crawler gear (C3) is shiftable as a winding path gear via actuation of the second clutch (K2), the third coupling device (C), the sixth coupling device (F) and the eighth coupling device (H) as well as disengagement of the second output coupling device (S_ab2);
a first overdrive gear (O1) is shiftable as a winding path gear via actuation of the second clutch (K2) and the seventh coupling device (G) as well as the at least one shift element (I);
a second overdrive gear (O2) is shiftable as a winding path gear via actuation of the first clutch (K1) and the second coupling device (B) as well as the second shift element (K);
a third overdrive gear (O3) is shiftable as a winding path gear via actuation of the first clutch (K1) and the fifth coupling device (E) as well as the second shift element (K).

38. The double clutch transmission according to claim 24, wherein a first forward gear (G1) is shiftable via actuation of the first clutch (K1) and the third coupling device (C);
a second forward gear (G2) is shiftable via actuation of the second clutch (K2) and the first coupling device (A);
a third forward gear (G3) is shiftable via actuation of the first clutch (K1) and the seventh coupling device (G);
a fourth forward gear (G4) is shiftable via actuation of the second clutch (K2) and the fifth coupling device (E);
a fifth forward gear (G5) is shiftable via actuation of the first clutch (K1) and the fourth coupling device (D);
a sixth forward gear (G6) is shiftable via actuation of the second clutch (K2) and the sixth coupling device (F);
a seventh forward gear (G7) is shiftable via actuation of the first clutch (K1) and the eighth coupling device (H);
an eighth forward gear (G8) is shiftable as a winding path gear via actuation of the first clutch (K1), the first coupling device (A), the fourth coupling device (D) and the fifth coupling device (E) as well as disengagement of the first output coupling device (S_ab1);
a first reverse gear (R1) is shiftable as a winding path gear via actuation of the second clutch (K2), the second coupling device (B), the fourth coupling device (D) and the seventh coupling device (G) as well as disengagement of the first output coupling device (S_ab1);
a second reverse gear (R2) is shiftable as a winding path gear via actuation of the first clutch (K1) and the first coupling device (A) as well as the at least one shift element (I);
a third reverse gear (R3) is shiftable as a winding path gear via actuation of the first clutch (K1) and the second coupling device (B) as well as the second shift element (K);
a first crawler gear (C1) is shiftable as a winding path gear via actuation of the second clutch (K2), the first coupling device (A), the fourth coupling device (D) and the seventh coupling device (G) as well as disengagement of the first output coupling device (S_ab1);
a second crawler gear (C2) is shiftable as a winding path gear via actuation of the second clutch (K2), the third coupling device (C), the fifth coupling device (E) and the eighth coupling device (H) as well as disengagement of the second output coupling device (S_ab2);
a third crawler gear (C3) is shiftable as a winding path gear via actuation of the second clutch (K2), the third coupling device (C), the sixth coupling device (F) and the eighth coupling device (H) as well as disengagement of the second output coupling device (S_ab2);
a fourth crawler gear (C4) is shiftable as a winding path gear via actuation of the first clutch (K1) and the first coupling device (A) as well as the second shift element (K);
a fifth crawler gear (C5) is shiftable as a winding path gear via actuation of the first clutch (K1), the first coupling device (A), the fifth coupling device (E) and the seventh coupling device (G) as well as disengagement of the second output coupling device (S_ab2);
a first overdrive gear (O1) is shiftable as a winding path gear via actuation of the second clutch (K2) and the fourth coupling device (D) as well as the second shift element (K);
a second overdrive gear (O2) is shiftable as a winding path gear via actuation of the second clutch (K2) and the eighth coupling device (H) as well as the second shift element (K);
a third overdrive gear (O3) is shiftable as a winding path gear via actuation of the second clutch (K2), the first coupling device (A), the third coupling device (C) and the eighth coupling device (H) as well as disengagement of the first output coupling device (S_ab1);
a fourth overdrive gear (O4) is shiftable as a winding path gear via actuation of the first clutch (K1), the first coupling device (A), the fourth coupling device (D) and the sixth coupling device (F) as well as disengagement of the first output coupling device (S_ab1).

39. The double clutch transmission according to claim 24, wherein a first forward gear (G1) is shiftable via actuation of the first clutch (K1) and the fourth coupling device (D);
a second forward gear (G2) is shiftable via actuation of the second clutch (K2) and the second coupling device (B);
a third forward gear (G3) is shiftable via actuation of the first clutch (K1) and the eighth coupling device (H);
a fourth forward gear (G4) is shiftable via actuation of the second clutch (K2) and the first coupling device (A);
a fifth forward gear (G5) is shiftable via actuation of the first clutch (K1) and the third coupling device (C);
a sixth forward gear (G6) is shiftable via actuation of the second clutch (K2) and the fifth coupling device (E);
a seventh forward gear (G7) is shiftable via actuation of the first clutch (K1) and the seventh coupling device (G);
an eighth forward gear (G8) is shiftable as a winding path gear via actuation of the second clutch (K2), the second coupling device (B), the fourth coupling device (D) and the seventh coupling device (G) as well as with disengagement of the first output coupling device (S_ab1);
a first reverse gear (R1) is shiftable as a winding path gear via actuation of the second clutch (K2) and the fourth coupling device (D) as well as the second shift element (K);
a second reverse gear (R2) is shiftable as a winding path gear via actuation of the second clutch (K2) and the eighth coupling device (H) as well as the second shift element (K);
a third reverse gear (R3) is shiftable as a winding path gear via actuation of the second clutch (K2), the fourth coupling device (D), the fifth coupling device (E) and the eighth coupling device (H) as well as disengagement of the second output coupling device (S_ab2);
a fourth reverse gear (R4) is shiftable as a winding path gear via actuation of the first clutch (K1), the first coupling device (A), the fourth coupling device (D) and the sixth coupling device (F) as well as disengagement of the first output coupling device (S_ab1);
a fifth reverse gear (R5) is shiftable as a winding path gear via actuation of the first clutch (K1), the second coupling device (B), the sixth coupling device (F) and the eighth coupling device (H) as well as disengagement of the second output coupling device (S_ab2);
a first crawler gear (C1) is shiftable as a winding path gear via actuation of the second clutch (K2) and the fourth coupling device (D) as well as the at least one shift element (I);
a second crawler gear (C2) is shiftable as a winding path gear via actuation of the second clutch (K2) and the eighth coupling device (H) as well as the at least one shift element (I);
a third crawler gear (C3) is shiftable as a winding path gear via actuation of the second clutch (K2), the fourth coupling device (D), the fifth coupling device (E) and the seventh coupling device (G) as well as disengagement of the second output coupling device (S_ab2);
a fourth crawler gear (C4) is shiftable as a winding path gear via actuation of the first clutch (K1), the first coupling device (A), the fifth coupling device (E) and the eighth coupling device (H) as well as disengagement of the second output coupling device (S_ab2);
a fifth crawler gear (C5) is shiftable as a winding path gear via actuation of the first clutch (K1), the second coupling device (B), the fifth coupling device (E) and the eighth coupling device (H) as well as disengagement of the second output coupling device (S_ab2);
a first overdrive gear (O1) is shiftable as a winding path gear via actuation of the second clutch (K2), the first coupling device (A), the fourth coupling device (D) and the seventh coupling device (G) as well as disengagement of the first output coupling device (S_ab1);
a second overdrive gear (O2) is shiftable as a winding path gear via actuation of the second clutch (K2), the third coupling device (C), the fifth coupling device (E) and the eighth coupling device (H) as well as disengagement of the second output coupling device (S_ab2);
a third overdrive gear (O3) is shiftable as a winding path gear via actuation of the first clutch (K1) and the fifth coupling device (E) as well as the at least one shift element (I).

40. The double clutch transmission according to claim 24, wherein a first forward gear (G1) is shiftable as a winding path gear via actuation of the first clutch (K1), the second coupling device (B), the fourth coupling device (D) and the sixth coupling device (F) as well as disengagement of the first output coupling device (S_ab1);
a second forward gear (G2) is shiftable via actuation of the second clutch (K2) and the sixth coupling device (F);
a third forward gear (G3) is shiftable via actuation of the first clutch (K1) and the fourth coupling device (D);
a fourth forward gear (G4) is shiftable via actuation of the second clutch (K2) and the second coupling device (B);
a fifth forward gear (G5) is shiftable via actuation of the first clutch (K1) and the seventh coupling device (G);
a sixth forward gear (G6) is shiftable via actuation of the second clutch (K2) and the fifth coupling device (E);
a seventh forward gear (G7) is shiftable via actuation of the first clutch (K1) and the eighth coupling device (H);
an eighth forward gear (G8) is shiftable via actuation of the first clutch (K1) and the third coupling device (C);
a first reverse gear (R1) is shiftable as a winding path gear via actuation of the first clutch (K1), the first coupling device (A), the third coupling device (C) and the sixth coupling device (F) as well as disengagement of the first output coupling device (S_ab1);
a second reverse gear (R2) is shiftable as a winding path gear via actuation of the first clutch (K1), the first coupling device (A), the fourth coupling device (D) and the fifth coupling device (E) as well as disengagement of the first output coupling device (S_ab1);
a third reverse gear (R3) is shiftable as a winding path gear via actuation of the first clutch (K1), the first coupling device (A), the fourth coupling device (D) and the sixth coupling device (F) as well as disengagement of the first output coupling device (S_ab1);
a first crawler gear (C1) is shiftable as a winding path gear via actuation of the second clutch (K2) and the fourth coupling device (D) as well as the at least one shift element (I);
a second crawler gear (C2) is shiftable as a winding path gear via actuation of the second clutch (K2) and the fourth coupling device (D) as well as the second shift element (K);
a third crawler gear (C3) is shiftable as a winding path gear via actuation of the second clutch (K2), the fourth coupling device (D), the sixth coupling device (F) and the eighth coupling device (H) as well as disengagement of the second output coupling device (S_ab2);
a first overdrive gear (O1) is shiftable as a winding path gear via actuation of the second clutch (K2), the second coupling device (B), the fourth coupling device (D) and the eighth coupling device (H) as well as disengagement of the first output coupling device (S_ab1);
a second overdrive gear (O2) is shiftable as a winding path gear via actuation of the second clutch (K2), the third coupling device (C), the fifth coupling device (E) and the seventh coupling device (G) as well as disengagement of the second output coupling device (S_ab2);
a third overdrive gear (O3) is shiftable as a winding path gear via actuation of the first clutch (K1) and the fifth coupling device (E) as well as the at least one shift element (I);
a fourth overdrive gear (O4) is shiftable as a winding path gear via actuation of the first clutch (K1) and the fifth coupling device (E) as well as the second shift element (K);
a fifth overdrive gear (O5) is shiftable as a winding path gear via actuation of the first clutch (K1), the second coupling device (B), the sixth coupling device (F) and the eighth coupling device (H) as well as disengagement of the second output coupling device (S_ab2).

41. The double clutch transmission according to claim 24, wherein a first forward gear (G1) is shiftable as a winding path gear via actuation of the first clutch (K1), the first coupling device (A), the third coupling device (C) and the sixth coupling device (F) as well as disengagement of the first output coupling device (S_ab1);
a second forward gear (G2) is shiftable via actuation of the second clutch (K2) and the sixth coupling device (F);
a third forward gear (G3) is shiftable via actuation of the first clutch (K1) and the seventh coupling device (G);
a fourth forward gear (G4) is shiftable via actuation of the second clutch (K2) and the fifth coupling device (E);
a fifth forward gear (G5) is shiftable via actuation of the first clutch (K1) and the third coupling device (C);
a sixth forward gear (G6) is shiftable via actuation of the second clutch (K2) and the first coupling device (A);
a seventh forward gear (G7) is shiftable via actuation of the first clutch (K1) and the eighth coupling device (H);
an eighth forward gear (G8) is shiftable as a winding path gear via actuation of the first clutch (K1), the first coupling device (A), the fourth coupling device (D) and the fifth coupling device (E) as well as with disengagement of the first output coupling device (S_ab1);
a first reverse gear (R1) is shiftable as a winding path gear via actuation of the second clutch (K2), the second coupling device (B), the fourth coupling device (D) and the seventh coupling device (G) as well as disengagement of the first output coupling device (S_ab1);
a second reverse gear (R2) is shiftable as a winding path gear via actuation of the second clutch (K2), the second coupling device (B), the fourth coupling device (D) and the eighth coupling device (H) as well as disengagement of the first output coupling device (S_ab1);
a first crawler gear (C1) is shiftable as a winding path gear via actuation of the second clutch (K2), the third coupling device (C), the sixth coupling device (F) and the eighth coupling device (H) as well as disengagement of the second output coupling device (S_ab2);
a first overdrive gear (O1) is shiftable as a winding path gear via actuation of the second clutch (K2), the first coupling device (A), the third coupling device (C) and the eighth coupling device (H) as well as disengagement of the first output coupling device (S_ab1);
a second overdrive gear (O2) is shiftable as a winding path gear via actuation of the first clutch (K1), the first coupling device (A), the fifth coupling device (E) and the eighth coupling device (H) as well as disengagement of the second output coupling device (S_ab2);
a third overdrive gear (O3) is shiftable as a winding path gear via actuation of the first clutch (K1), the first coupling device (A), the sixth coupling device (F) and the eighth coupling device (H) as well as disengagement of the second output coupling device (S_ab2).

42. The double clutch transmission according to claim 24, wherein a first forward gear (G1) is shiftable as a winding path gear via actuation of the first clutch (K1), the first coupling device (A), the third coupling device (C) and the sixth coupling device (F) as well as disengagement of the first output coupling device (S_ab1);
a second forward gear (G2) is shiftable via actuation of the second clutch (K2) and the sixth coupling device (F);
a third forward gear (G3) is shiftable via actuation of the first clutch (K1) and the seventh coupling device (G);
a fourth forward gear (G4) is shiftable via actuation of the second clutch (K2) and the second coupling device (B);
a fifth forward gear (G5) is shiftable via actuation of the first clutch (K1) and the third coupling device (C);
a sixth forward gear (G6) is shiftable via actuation of the second clutch (K2) and the first coupling device (A);
a seventh forward gear (G7) is shiftable via actuation of the first clutch (K1) and the eighth coupling device (H);
an eighth forward gear (G8) is shiftable as a winding path gear via actuation of the first clutch (K1) and the first coupling device (A) as well as the second shift element (K);
a first reverse gear (R1) is shiftable as a winding path gear via actuation of the second clutch (K2), the first coupling device (A), the fourth coupling device (D) and the seventh coupling device (G) as well as disengagement of the first output coupling device (S_ab1);
a second reverse gear (R2) is shiftable as a winding path gear via actuation of the second clutch (K2), the second coupling device (B), the fourth coupling device (D) and the seventh coupling device (G) as well as disengagement of the first output coupling device (S_ab1);
a third reverse gear (R3) is shiftable as a winding path gear via actuation of the second clutch (K2), the second coupling device (B), the fourth coupling device
(D) and the eighth coupling device (H) as well as disengagement of the first output coupling device (S_ab1);
a first crawler gear (C1) is shiftable as a winding path gear via actuation of the second clutch (K2), the third coupling device (C), the sixth coupling device (F) and the eighth coupling device (H) as well as disengagement of the second output coupling device (S_ab2);
a first overdrive gear (O1) is shiftable as a winding path gear via actuation of the second clutch (K2), the first coupling device (A), the third coupling device (C) and the eighth coupling device (H) as well as disengagement of the first output coupling device (S_ab1);
a second overdrive gear (O2) is shiftable as a winding path gear via actuation of the first clutch (K1) and the first coupling device (A) as well as the at least one shift element (I);
a third overdrive gear (O3) is shiftable as a winding path gear via actuation of the first clutch (K1), the first coupling device (A), the sixth coupling device (F) and the eighth coupling device (H) as well as disengagement of the second output coupling device (S_ab2);
a fourth overdrive gear (O4) is shiftable as a winding path gear via actuation of the first clutch (K1), the second coupling device (B), the sixth coupling device (F) and the eighth coupling device (H) as well as disengagement of the second output coupling device (S_ab2).

43. The double clutch transmission according to claim 24, wherein a first forward gear (G1) is shiftable as a winding path gear via actuation of the first clutch (K1) and the fifth coupling device (E) as well as the second shift element (K);
a second forward gear (G2) is shiftable via actuation of the second clutch (K2) and the fifth coupling device (E);
a third forward gear (G3) is shiftable via actuation of the first clutch (K1) and the seventh coupling device (G);
a fourth forward gear (G4) is shiftable via actuation of the second clutch (K2) and the sixth coupling device (F);
a fifth forward gear (G5) is shiftable via actuation of the first clutch (K1) and the fourth coupling device (D);
a sixth forward gear (G6) is shiftable via actuation of the second clutch (K2) and the second coupling device (B);
a seventh forward gear (G7) is shiftable via actuation of the first clutch (K1) and the eighth coupling device (H);
an eighth forward gear (G8) is shiftable via actuation of the first clutch (K1) and the third coupling device (C);
a first reverse gear (R1) is shiftable as a winding path gear via actuation of the second clutch (K2), the first coupling device (A), the third coupling device (C) and the seventh coupling device (G) as well as disengagement of the first output coupling device (S_ab1);
a first crawler gear (C1) is shiftable as a winding path gear via actuation of the second clutch (K2), the fourth coupling device (D), the fifth coupling device (E) and the eighth coupling device (H) as well as disengagement of the second output coupling device (S_ab2);
a first overdrive gear (O1) is shiftable as a winding path gear via actuation of the second clutch (K2) and the third coupling device (C) as well as the second shift element (K);
a second overdrive gear (O2) is shiftable as a winding path gear via actuation of the second clutch (K2) and the eighth coupling device (H) as well as the second shift element (K);
a third overdrive gear (O3) is shiftable as a winding path gear via actuation of the second clutch (K2), the second coupling device (B), the fourth coupling device (D) and the eighth coupling device (H) as well as disengagement of the first output coupling device (S_ab1);
a fourth overdrive gear (O4) is shiftable as a winding path gear via actuation of the first clutch (K1), the second coupling device (B), the fifth coupling device (E) and the eighth coupling device (H) as well as disengagement of the second output coupling device (S_ab2);
a fifth overdrive gear (O5) is shiftable as a winding path gear via actuation of the first clutch (K1), the second coupling device (B), the sixth coupling device (F) and the eighth coupling device (H) as well as disengagement of the second output coupling device (S_ab2).

44. The double clutch transmission according to claim 24, wherein a first forward gear (G1) is shiftable as a winding path gear via actuation of the first clutch (K1), the second coupling device (B), the fourth coupling device (D) and the sixth coupling device (F) as well as disengagement of the first output coupling device (S_ab1);
a second forward gear (G2) is shiftable via actuation of the second clutch (K2) and the sixth coupling device (F);
a third forward gear (G3) is shiftable via actuation of the first clutch (K1) and the fourth coupling device (D);
a fourth forward gear (G4) is shiftable via actuation of the second clutch (K2) and the second coupling device (B);
a fifth forward gear (G5) is shiftable via actuation of the first clutch (K1) and the seventh coupling device (G);
a sixth forward gear (G6) is shiftable via actuation of the second clutch (K2) and the fifth coupling device (E);
a seventh forward gear (G7) is shiftable via actuation of the first clutch (K1) and the eighth coupling device (H);
an eighth forward gear (G8) is shiftable as a winding path gear via actuation of the first clutch (K1) and the second coupling device (B) as well as the second shift element (K);
a first reverse gear (R1) is shiftable as a winding path gear via actuation of the first clutch (K1), the first coupling device (A), the fourth coupling device (D) and the fifth coupling device (E) as well as disengagement of the first output coupling device (S_ab1);
a second reverse gear (R2) is shiftable as a winding path gear via actuation of the first clutch (K1), the first coupling device (A), the fourth coupling device
(D) and the sixth coupling device (F) as well as disengagement of the first output coupling device (S_ab1);
a third reverse gear (R3) is shiftable as a winding path gear via actuation of the second clutch (K2) and the fourth coupling device (D) as well as the at least one shift element (I);
a fourth reverse gear (R4) is shiftable as a winding path gear via actuation of the second clutch (K2) and the seventh coupling device (G) as well as the at least one shift element (I);
a fifth reverse gear (R5) is shiftable as a winding path gear via actuation of the second clutch (K2) and the eighth coupling device (H) as well as the at least one shift element (I);
a sixth reverse gear (R6) is shiftable via actuation of the first clutch (K1) and the third coupling device (C);
a first crawler gear (C1) is shiftable as a winding path gear via actuation of the second clutch (K2) and the fourth coupling device (D) as well as the second shift element (K);
a second crawler gear (C2) is shiftable as a winding path gear via actuation of the second clutch (K2), the fourth coupling device (D), the sixth coupling device (F) and the eighth coupling device (H) as well disengagement of the second output coupling device (S_ab2);
a first overdrive gear (O1) is shiftable as a winding path gear via actuation of the second clutch (K2), the second coupling device (B), the fourth coupling device (D) and the eighth coupling device (H) as well as disengagement of the first output coupling device (S_ab1);
a second overdrive gear (O2) is shiftable as a winding path gear via actuation of the first clutch (K1) and the fifth coupling device (E) as well as the second shift element (K);
a third overdrive gear (O3) is shiftable as a winding path gear via actuation of the first clutch (K1), the second coupling device (B), the sixth coupling device (F) and the eighth coupling device (H) as well as disengagement of the second output coupling device (S_ab2).

45. The double clutch transmission according to claim 24, wherein a first forward gear (G1) is shiftable as a winding path gear via actuation of the first clutch (K1), the first coupling device (A), the fourth coupling device (D) and the fifth coupling device (E) as well as disengagement of the first output coupling device (S_ab1);
a second forward gear (G2) is shiftable via actuation of the second clutch (K2) and the fifth coupling device (E);
a third forward gear (G3) is shiftable via actuation of the first clutch (K1) and the fourth coupling device (D);
a fourth forward gear (G4) is shiftable via actuation of the second clutch (K2) and the first coupling device (A);
a fifth forward gear (G5) is shiftable via actuation of the first clutch (K1) and the eighth coupling device (H);
a sixth forward gear (G6) is shiftable via actuation of the second clutch (K2) and the second coupling device (B);
a seventh forward gear (G7) is shiftable via actuation of the first clutch (K1) and the seventh coupling device (G);
an eighth forward gear (G8) is shiftable as a winding path gear via actuation of the first clutch (K1) and the second coupling device (B) as well as the second shift element (K);
a first reverse gear (R1) is shiftable as a winding path gear via actuation of the second clutch (K2) and the fourth coupling device (D) as well the at least one shift element (I);
a second reverse gear (R2) is shiftable as a winding path gear via actuation of the second clutch (K2) and the eighth coupling device (H) as well as the at least one coupling device (I);
a third reverse gear (R3) is shiftable as a winding path gear via actuation of the second clutch (K2), the first coupling device (A), the third coupling device (C) and the seventh coupling device (G) as well as disengagement of the first output coupling device (S_ab1);
a fourth reverse gear (R4) is shiftable as a winding path gear via actuation of the second clutch (K2), the first coupling device (A), the third coupling device (C) and the eighth coupling device (H) as well as disengagement of the first output coupling device (S_ab1);
a first crawler gear (C1) is shiftable as a winding path gear via actuation of the second clutch (K2), the fourth coupling device (D), the fifth coupling device (E) and the seventh coupling device (G) as well as disengagement of the second output coupling device (S_ab2);
a second crawler gear (C2) is shiftable as a winding path gear via actuation of the second clutch (K2), the fourth coupling device (D), the fifth coupling device (E) and the eighth coupling device (H) as well as disengagement of the second output coupling device (S_ab2);
a third crawler gear (C3) is shiftable as a winding path gear via actuation of the first clutch (K1), the second coupling device (B), the fourth coupling device (D) and via actuation of the fifth activated coupling (E) as well as disengagement of the first output coupling device (S_ab1);
a first overdrive gear (O1) is shiftable as a winding path gear via actuation of the second clutch (K2), the first coupling device (A), the fourth coupling device (D) and the seventh coupling device (G) as well as disengagement of the first output coupling device (S_ab1);
a second overdrive gear (O2) is shiftable as a winding path gear via actuation of the second clutch (K2), the second coupling device (B), the fourth coupling device (D) and the seventh coupling device (G) as well as disengagement of the first output coupling device (S_ab1);
a third overdrive gear (O3) is shiftable as a winding path gear via actuation of the second clutch (K2), the second coupling device (B), the fourth coupling device (D) and the eighth coupling device (H) as well as disengagement of the first output coupling device (S_ab1);
a fourth overdrive gear (O4) is shiftable as a winding path gear via actuation of the first clutch (K1), the first coupling device (A), the fifth coupling device (E) and the seventh coupling device (G) as well as disengagement of second output coupling device (S_ab2);
a fifth overdrive gear (O5) is shiftable as a winding path gear via actuation of the first clutch (K1), the second coupling device (B), the fifth coupling device (E) and the seventh coupling device (G) as well as disengagement of the second output coupling device (S_ab2);
a sixth overdrive gear (O6) is shiftable as a winding path gear via actuation of the first clutch (K1), the second coupling device (B), the fifth coupling device (E) and the eighth coupling device (H) as well as disengagement of the second output coupling device (S_ab2).

46. The double clutch transmission according to claim 24, wherein a first forward gear (G1) is shiftable via actuation of the first clutch (K1), and the third coupling device (C);
a second forward gear (G2) is shiftable via actuation of the second clutch (K2) and the first coupling device (A);
a third forward gear (G3) is shiftable via actuation of the first clutch (K1) and the fourth coupling device (D);
a fourth forward gear (G4) is shiftable via actuation of the second clutch (K2) and the second coupling device (B);
a fifth forward gear (G5) is shiftable via actuation of the first clutch (K1) and the seventh coupling device (G);
a sixth forward gear (G6) is shiftable via actuation of the second clutch (K2) and the fifth coupling device (E);
a seventh forward gear (G7) is shiftable via actuation of the first clutch (K1) and the eighth coupling device (H);
an eighth forward gear (G8) is shiftable as a winding path gear via actuation of the second clutch (K2), the first coupling device (A), the third coupling device (C) and the eighth coupling device (H) as well as disengagement of the first output coupling device (S_ab1);
a first reverse gear (R1) is shiftable as a winding path gear via actuation of the first clutch (K1) and the first coupling device (A) as well as the second shift element (K);
a second reverse gear (R2) is shiftable as a winding path gear via actuation of the first clutch (K1) and the second coupling device (B) as well as the second shift element (K);
a third reverse gear (R3) is shiftable as a winding path gear via actuation of the first clutch (K1) and the fifth coupling device (E) as well as the second shift element (K);
a fourth reverse gear (R4) is shiftable as a winding path gear via actuation of the first clutch (K1), the first coupling device (A), the sixth coupling device (F) and the eighth coupling device (H) as well as disengagement of the second output coupling device (S_ab2);
a fifth reverse gear (R5) is shiftable as a winding path gear via actuation of the first clutch (K1), the second coupling device (B), the sixth coupling device (F) and the eighth coupling device (H) as well as disengagement of the second output coupling device (S_ab2);
a first crawler gear (C1) is shiftable as a winding path gear via actuation of the second clutch (K2), the third coupling device (C), the fifth coupling device (E) and the eighth coupling device (H) as well as disengagement of the second output coupling device (S_ab2);
a second crawler gear (C2) is shiftable as a winding path gear via actuation of the first clutch (K1) and the first coupling device (A) as well as the first shift element (I);
a third crawler gear (C3) is shiftable as a winding path gear via actuation of the first clutch (K1), the first coupling device (A), the fifth coupling device (E) and the seventh coupling device (G) as well as disengagement of the second output coupling device (S_ab2);
a first overdrive gear (O1) is shiftable as a winding path gear via actuation of the second clutch (K2) and the seventh coupling device (G) as well as the at least one shift element (I);
a second overdrive gear (O2) is shiftable as a winding path gear via actuation of the second clutch (K2) and the eighth coupling device (H) as well as the at least one shift element (I);
a third overdrive gear (O3) is shiftable as a winding path gear via actuation of the second clutch (K2), the second coupling device (B), the fourth coupling device (D) and the eighth coupling device (H) as well as disengagement of the first output coupling device (S_ab1).
